(19) United States
(12) Patent Application Publication
(10) Pub. No.: US 2025/0072433 A1
(43) Pub. Date: Mar. 6, 2025

(54) ORGANIC CONCENTRATED VITAMINE-PHYTOHORMONE WITH NATURAL BIO-STIMULANT PROPERTIES AS FERTILIZER CONCENTRATED EXTRACT OF DUCKWEED ARACEA FAMILY OF PLANTS FORMALY KNOWN AS LEMNACEAE SINGLE OR COMBINED SPECIES THAT CAN INCLUDE ALSO COMPOUNDED MULTIPLE FORMULATED AQUATIC PLANTS EXTRACTS TO NATURALY INCREASE PLANT GROWTH AND CROP YIELDS

(71) Applicant: Edward Greenberg Cordero, Melbourne, FL (US)

(72) Inventor: Edward Paul Greenberg Cordero, Melbourne, FL (US)

(21) Appl. No.: 17/958,747

(22) Filed: Oct. 3, 2022

Related U.S. Application Data
(60) Provisional application No. 63/251,864, filed on Oct. 4, 2021.
(60) Provisional application No. 63/409,507, filed on Sep. 23, 2022.

(51) Int. Cl. A01N 65/40; A01N 43/38; A01N 43/90; A01P 21/00; C05F 11/10; C05G 5/23

(52) U.S. Cl. CPC A01N 65/40; A01N 43/38; A01N 43/90; A01P 21/00; C05F 11/10; C05G 5/23

(57) ABSTRACT

A method is provided for biologically stimulating growth of and/or regulate enhancing performance plant for agricultural and non-agricultural purposes crop plants and non-crop plants like ornamental plants, industrial material plants, energy biomass production plants, pharmaceutical interest plants, spices, algae, kelp, etc. And beneficial productivity use in aquaculture as hydroponic systems, etc. comprising applying to the plants a DuckWeed.Bio Concentrated Products depending on the target crop customized formulation product and products having an a Auxin IAA or IBA or a combination comprised of Auxins to Cytokinins by biological activity measurement approximate concentration ratio of at least 10:1 to 30:1 and up to 100:1 to 500:1 but not limited to as synergistically can reach much higher levels of ration beyond 1000:1 depending on the compounding formulation mixes of Aquatic Plants and or its extracts.

### CROSS REFERENCE TO RELATED APPLICATIONS

The present non-provisional patent application is related to U.S. Provisional Patent Application 63/251,864 filed Oct. 4, 2021 and is related to U.S. Provisional Patent Application 63/409,507 filed Sep. 23, 2022, the contents of both of which are incorporated herein in their entireties.

### FIELD OF THE DISCLOSURE

The present disclosure is in the field of organic bio-stimulant fertilizers. More particularly, the present disclosure provides systems and method to organically increase plant growth and crop yields and improve growth and natural health of plants by applying organic bio-stimulant fertilizer rich in naturally occurring chelated minerals, nutrients, phytochemicals, vitamin-phytohormones, amino acids, vitamins, polyphenols, terpenoids and other plant beneficial natural components, these components produced by using unique hydroponic systems including extraction, formulation, and optimal compounding of vascular aquatic plants, both freshwater and saltwater, and hydrophytes or macrophytes.

### BACKGROUND

Demand for food including agriculture products is increasing based at least on global population growth. At the same time the supply of arable land is decreasing. Use of chemical-based fertilizers causes pollution, contaminates soil, water, and air, and damages the environment. A shift towards more organic products is taking place, a development that has increased demand for organic bio-stimulant fertilizers beyond traditionally available supply.

Organic farming is an agricultural system that uses fertilizers of organic origin such as compost manure, green manure, and bone meal and places emphasis on techniques such as crop rotation and companion planting.

Previous implementations of the prior art are not entirely organic. Even in fully organic sources the concentration and bioavailability of the plant nutrients are limited or damaged as most use methods that partially extract or partial cell rupture. These aspects of the prior art limit availability. Some prior art limitations use chemical solvent or chemical digestion or enzymatic solutions as fermentation systems. These damage the activity of the natural plant phytochemicals and other valuable plant components and nutrients that promote and enhance plant growth and productivity of yields. In addition, production systems of the prior art do not guaranty minimum concentrations of key nutrients or its activity.

Low or unstable concentrations of the composition of the raw materials as provided in the prior art are not optimal as most are collected and not farmed. Some provided by the prior art even take natural resources that damage the environment. Inefficient extraction as in the prior art damages bioavailability and bioactivity of the phytochemical compounds and plant nutrients.

### BRIEF DESCRIPTION OF THE DRAWINGS

FIG. 1 through FIG. 56 are images including graphs, charts, and photographic images supporting embodiments of the present disclosure.

### DETAILED DESCRIPTION

Systems and methods provided herein promote improved crop performance and yields by organically enhancing plant growth and photosynthesis and by stimulating natural potential and productivity of crops. Size and quantity of roots is improved. The use of water is reduced as is the use of traditional fertilizers, positively impacting the environment by reducing pollution or contamination of soils, water, and air. Most importantly, systems and methods provided herein address food security and safety challenges by increasing agriculture yield without increasing the need for arable land.

The production of concentrated organic bio-stimulant fertilizer is based on a highly efficient organic physical process that extracts controllable quantity and quality of specialty natural plant phytochemicals, phytohormones, amino acids and other beneficial natural plant components without damaging its natural biological activity maximizing its positive effect on plants. These substances promote chlorophyll content improving photosynthesis, plant growth, root size, and number of roots. This increases nutrient absorption capacity and potentially minimizes the overall impact of traditional fertilizers resulting in a reduction of environmental contamination of the soil and water. It will also address food security and safety challenges by increasing agriculture yield, without increasing the need of more arable land and water resources.

Systems and methods provided herein produce concentrated organic bio-stimulant fertilizer by first growing the individual or multiple aquatic plants species that will be used as raw material. This is done in an enhanced engineered open system photobioreactor raceway. Non-GMO vascular aquatic plants are used under control conditions to generate high production of specialty organic natural bio-stimulant and yields. The bio-stimulant is extracted using a continuous process to maximize the activity as concentration of ingredient and their formulation to target soil and soilless crop production. Among the ingredient and formulation are the phytochemicals, chelated minerals, vitamins, polyphenols, naturally occurring phytohormones, amino acids, terpenoids, polyphenols, carbohydrates, peptides and other beneficial natural plant components.

The plants are harvested by a self-calibrating automated system that includes proprietary software. The harvest will be tested by NIRS, Eliza, Microbiology, and quick wet chemistry to address its quality and concentration of phytochemicals as base raw material. The plants are subjected to an extraction process using advance ultrasonic cavitation high volume flow technology. This process maximizes cell burst extraction of key components and improves the quality, blending stabilization and packing or sterile bottling.

The production method provided herein also improves the hydroponic growth and composition value of the plants as the extraction, bioavailability and activity of the plant components increase application absorption by the target plants and crops. This benefits from the organic biological stimulator improving the commercial value of the plants or crops growth, tolerance to abiotic stress, productivity, yields, and quality compared with traditional systems of plant growth. The agriculture system is CO2 negative technology with a high carbon absorption directly. The system also indirectly increases the CO2 capture of the crops that utilize the concentrated bio-stimulant organic fertilizer. This rate of increased CO2 capture will vary depending on the target crop or plant of interest and the conditions where it grows.

The present disclosure provides a controlled hydroponic open photobioreactor raceway system that produces sustainable low-cost raw hydrophyte macrophyte aquatic plant material. The system produces large volumes of standardized material of high quality and bioavailability. The material is generated by a manufacturing extraction method comprised by but not limited to a organic mechanical continuous hi flow ultrasound cavitation cold process that extracts the valuable plant components comprised of nutrients, chelated minerals, phytochemicals, phytohormones, polyphenols, terpenoids, vitamins, proteins, amino acids, carbohydrates, and other valuable natural plant components. The process is non-chemical, non-caustic, non-heated, non-hydrolysis, and does not use fermentation. It does not use extreme cold, extreme heat, microwave, or any other method that damages the molecule structure of the plant phytochemicals or renders them not absorbable or bioavailable. Making the natural valuable phytochemicals and phytohormones and all wherein described biochemical components of the plant highly bioavailable and organically extracted.

Steps or elements of systems and methods provided herein are as follows:

Aquatic vascular plants referred as hydrophytes and macrophytes that grow in freshwater, brackish water, or saltwater. The plants may be of a single species or a compounded formulated mix.
Hydroponic growth system
Hydroponic novel nutrition system
Growth monitoring and control system
Harvesting self-calibrating system
Processing system: conditioning hydro dilution unit.
Processing system: Mechanical organic high flow continuous shering-cavittion cold cell-burst extraction and organic sterilization cold unit.
Processing: Separation unit
Processing: Inline quality sensors and control unit
Processing: Formulation compounding software
Processing: Blending and organic stabilization unit
Processing: Temperature and quality control verification unit
Processing: Sterile packing and temporization unit
Water management and recycling system yielding minimal waste
Method of application to the targeted plants of economic value or crops.

The functionality provided herein may begin with selection of proper variety or species of aquatic plant hydrophytes/macrophytes and potentially also algae. The selection may be a combination of species or a single one. The main base may be the species and varieties in the Araceae family of plants formally known as Lemanaceae family of plants composed of the genres Lemna sp., Landoltia sp., Wolffia sp., Wolffiella sp., Spirodella sp.

Based on this the growth and nutrition may be nearly maximized. This may be evidenced by maximizing the phytochemical composition and quantitative content of the single or mixed crop of aquatic plants. This content may be harvested each day proportionally by performing calculations to maintain the population at the ideal point density. This may render a maximum utilization of nutrients and light resources and thereby promote nearly ideal composition and quantity of nutrients and phytochemicals of interest. The results may be analyzed to define dilution factor to desired product concentration of key plant nutrient components in the organic fertilizer.

The results may be processed to maximize cell rupture and reduce damage to key phytochemicals and nutrients that may maximize bioavailability and its activity. This may take place in an organic enhanced oxygen O3 ozone sterilization cold mediated ultrasound cavitation continuous high flow system that monitored inline to ensure its compliant with regulatory microbiological standards for such organic products and that is within desired standards for such content. It is then blended and stabilized with organic approved products to ensure shelf-life stability and effectiveness over time. It is then packed in an enclosed air/oxygen displacement by nitrogen packing system. This may prevent oxygen-mediated reduction of shelf life and any contamination of the product or products. It is then stored at room temperature.

The products are shipped to the users where the users will use a method described in a guide, based on the target crop or plants of economic interest where the product will be applied. The guide indicates a general dilution recommendation by crop type, stage of the crop and method of application. This guide is recommended to be used for an initial field demonstration test in a small portion of the farm to define a specific dilution factor. This factor may produce better results as this can vary according to crop type variety, soil type, microclimate, weather conditions, location, seasonality, and particular crop management system.

The present disclosure recommends selection of the best available non-GMO hydrophytes or vascular macrophytes aquatic plants. The vascular macrophytes (Pteridophyte and Spermatophyte), which are represented by 33 orders and 88 families with about 2,614 species includes 412 genera. These includes 2,614 aquatic species of Pteridophyta and Spermatophyta evolved from land plants and represent only a small fraction (*1%) of the total number of vascular plants. This selection will be based on single or combination of Araceae Family (formally known as Lemanaceae family of plants) composed of 5 genera Lemna sp., Spirodella sp., Landoltia sp., Wolffia sp. Wolffiella sp. That contains over 38 species and variant clones or varieties. Depending on the required product formulation, other species of different families of aquatic plants can be defined for compounding them in the selection of plants that will be grown in an advanced hydroponic system with focused organic or semi-organic closed circle. A no-waste environmentally safe proprietary nutrition system is provided to obtain high yield production with the highest content of natural occurring organic plant phytochemicals. Such phytochemicals may include chelated and highly bioavailable, mineral nutrients, amino acids, natural phytohormones, polyphenols, terpenoids, vitamins, lipids, and beneficial carbohydrates.

Aquatic plants will be grown and harvested at a high growth rate on a daily basis to maintain the population of plants in homeostasis with the resources of space, nutrients, CO2 and sunlight. An objective is to maximize natural genetic potential so the plants will thrive and have the highest yields possible. Depending on the location and conditions as seasonality in some locations that the environmental conditions are not so favorable, in those situations the plants will be grown indoors of protected greenhouse systems.

The plants then will be harvested by a self-calibrating automated system using equipment that will combined with a software-managed proprietary system. The harvest will be tested for NIRS, Eliza, Microbiology, and quick wet chemistry to address its quality and concentration of phytochemicals as base raw material. The harvest will be subjected to an organic mechanical extraction cold mediated ozone sterilization enhanced high volume flow ultrasound cavitation process, blending stabilization, and packing sterile organic nitrogen air displacement bottling. The harvest is quality tested and then used in the targeted plants of interest or crops based on application guide focusing on plant growth regulation.

The initial formulation and compounding of the non-GMO aquatic plants based on their valuable composition can be shuffled and customized to the needs of the targeted plant of economic interest. The process may be adapted to the location. Growth methods and base nutrition used in these targeted plants. This can be interchanged and or complemented with the final blending after extraction to polish and perfect the final blended product. This will be more significant based on the size and type of aquatic plants combined as its composition in relation to the targeted end products composition.

Farmers may use the non-GMO concentrated organic bio-stimulant fertilizer provided as either liquid foliar application, deeping seedling application, or dry pelleted soil mending application. Farmers will use a base application guide with recommended dilution and amount to be used by acre or hectare. Farmers will initially field test in a small number of plants or area with slight dilution variations of 5% to 10% increments variation to determine the best performance results range. Farmers will customize the application adapting the application to specific growth systems, farm management systems, specific plant varieties, seasonality, location, soil type and characteristics microclimate, variable environmental condition, base plant nutrition system and water quality as composition and watering systems. The product and its use will be customized to each individual farm crop. This will improve yields and reduce unnecessary waste and environmental contamination.

Other uses of systems and methods provided herein may include aquaculture of fin fish, crustaceans, and mollusks. Further, systems and methods may be used in plankton, algae and microalgae production such as kelp that may be used to organically fertilize the ponds, growth systems, open reactors, closed reactors, vertical farms, micropropagation, and plant tissue culture. Looking into the future, in space travel food production may rely on systems and methods provided herein for crop based on aquaculture in a no gravity environment.

Systems and methods provided herein may be used to produce bio-agriculture phytochemicals concentrated based on the composition of the aquatic plants. Systems and methods provided herein may be used to selectively separate and concentrate the phytochemicals based on their molecular weight to create other fertilizer specialties like Amino acid fertilizer, organic natural phytohormones, natural plant pigments (for natural coloring in food, beverage and pharma), carotenoids, chlorophylls, xanthine, as taxanthins of derived terpenoids, and beneficial natural occurring polyphenols that may potentially be beneficial to animals and humans. Products yielded based on systems and methods provided herein may also be potentially used as sources of natural biodegradable polymers for industrial purposes and sources of energy and can be use n production of pharmaceuticals, natural medicine, homeopathic medicine and cosmetics.

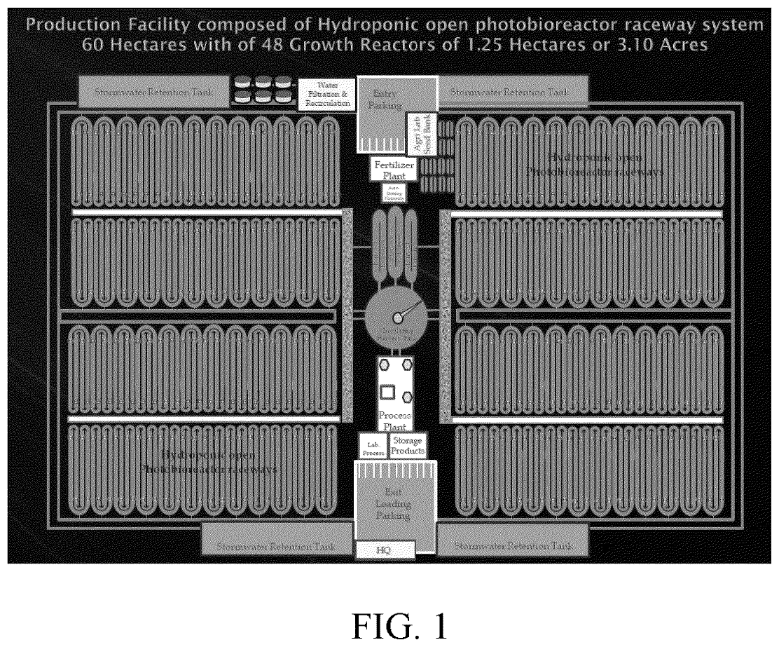

FIG. 1 is a diagram of a sample production facility for the products provided herein. The facility depicted in FIG. 1 is composed of hydroponic open photobioreactor raceway system. The sample facility shown is comprised of 60 hectares (but can be much smaller or larger according to the topography and requirements) in size and consists of 48 growth reactors of 1.25 hectares or 3.10 acres. Also shown in FIG. 1 are stormwater retention tanks, water filtration and recirculation, an agri-lab seed bank, a fertilizer plant, a circulating harvest tank, numerous hydroponic photobioreactor raceways, several harvest retention devices, storage products, and a lab process.

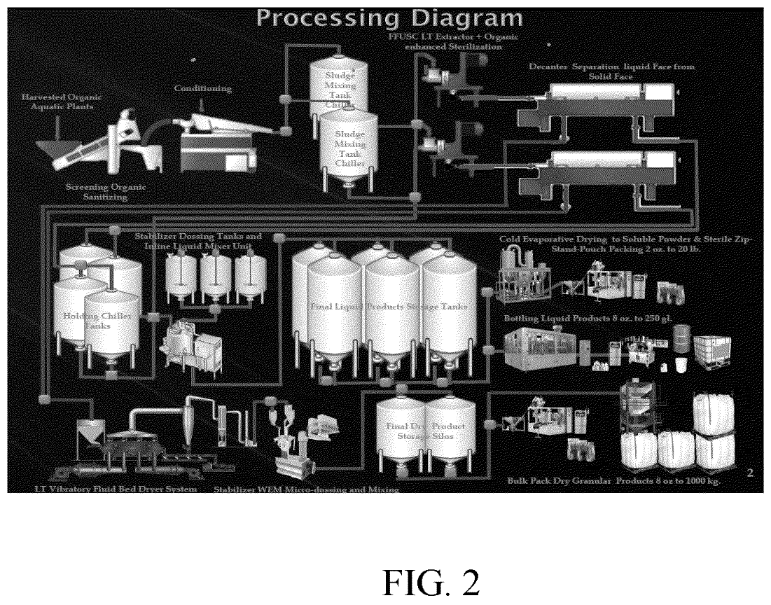

FIG. 2 is a processing diagram of systems and methods provided herein. Systems include the feeding of harvested organic aquatic plants into the system, conditioning, a sludge mixing tank chiller, and FFUSC LT extractor and organic enhanced sterilization. Thereafter, a decanter separation liquid face from solid face component is used, followed by holding chiller tanks, stabilizer dossing tanks and inline liquid mixer unit, and final liquid products storage tanks. Thereafter are LT vibratory fluid bed drying system and stabilizer WEM micro-dossing and mixing. Following these processes is preparation and packaging of the final product including cold evaporative drying to soluble powder and sterile zip-stand-pouch packing (2 oz to 20 lb.), bottling of liquid products (8 oz to 250 gallon), and bulk pack dry granular products (8 oz to 1,000 kg).

The present invention resides in the discovery that plant growth enhancers promoters “vitamin Hormones” exhibit an improved plant growth effect when applied by having an auxin to cytokinin ratio of at least 20:1 and up to but not limited to 500:1 plus a wide array of combination of individual organic naturally occurring “vitamin Hormones” that give a bio-stimulant analog effect

Surprisingly the present invention results in excellent growth promotion and even more interesting the positive effect of low levels of lodging (permanent displacement of aboveground portions of crops from their vertical stance due to stem buckling (stem lodging) or failure of the root-soil anchorage system “root lodging”). Unexpectedly, the level of lodging is so low that the Aquatic plant extract appear act synergistically on their organic natural composition that combines synergic effect. The invention is of great benefit to farmers in improving the growth of crop plants and improved yields, but with a low risk of loss of the crop due to lodging. It is of particular benefit to cereal crops such as wheat, barley and rye as other grains and pulses sensitive to lodging.

The present invention also results in unexpected improvements in crop enhancement, in particular with a larger root system as number of roots increases the total root surface area and total mass increasing significantly the absorption of water and nutrients; preventing lixiviation and runoffs of traditional fertilizer as the amount required that will very deepening on the crop type, conditions of growth, fertilization regime and management practices thus protecting the environment and a positive secondary effect is reducing the negative effects of abiotic stress like draught.

The previously described increase in mass of the root system also increase permanent retention of carbon absorbed from the air in the atmosphere thus having a CO2 permanent capture that is significant and will depend on the target crop or plant that uses the DuckWeed.Bio product as previously described.

Accordingly DuckWeed.Bio Product is an Aquatic Plant Concentrate Extract “product name” obtained from a mixture of Duckweed plants of the Family Araceae originally known as Lemnaceae and others Aquatic plant combinations to compound customized products to Agricultural needs; the DuckWeed.Bio concentrate is manufactured via a unique organic mechanical process sheering/cell-burst process that does not use fermentation, heat, chemical digestion, blanching or dehydration, and results in an extract with a high auxins to cytokinins ratio because the extraction process does not damage the natural growth stimulants, nutrients, vitamins and other valuable molecules and also provides other chelated mineral nutrients, vitamins and multiple organic natural plants functional molecules described in the prior embodiment that improve plant growth and productivity as yields. “DuckWeed.Bio” will and is sold as an Organic Concentrated Bio-Active Vitamin-Phytohormone Fertilizer product that enhances plant growth, productivity, reduction of abiotic tress and improves yields. The typical composition of “Product Name” (per liter) is shown in Table 1 below. Duckweed Bio Products are applied by growers to encourage vigorous root growth improving the uptake of nutrients, improving productivity, increasing yields, and resisting stress.

TABLE 1
According to the present invention, there is provided a method for
regulation of the enhancing of the growth of crop plants, comprising
applying to the plants, plant parts, plant seeds, plant propagation
material, or a plant growing locus, a plant growth promoter vitamin
hormone made of a concentrated Aquatic Plant “Duckweed
Duckweed Biotech Product Base aproximate Composition per liter:

| | | |
|---|---|---|
| Natural Phytohormones | Auxins BioChemical | 4,000,000 ng/lt. |
| | Concentration | |
| | Auxins Activity | 428 mg./lt. |
| | comparative Concentration | |
| | Citokins concentration | 1,200,000 ng/lt. |

| | | gr./lt. of Product |
|---|---|---|
| Mineral Composition | Carbon | 7.92 |
| | Nitrogen (chelated) | 1.43 |
| | Protein | 8.91 |
| | Phophorus | 0.42 |
| | Potassium | 1.64 |
| | Calcium | 0.59 |
| | Magnesium | 0.09 |
| | carbohidrates soluble | 3.17 |
| | | — |

| | | mg./lt. of Product |
|---|---|---|
| Trace elements | Copper mg/lt. | 0.04 |
| Micronutrients | Iron mg/lt. | 7.92 |
| | Iodine mg/lt. | 0.01 |
| | Manganese mg/lt. | 6.53 |
| | Selenium mg/lt. | 0.00 |
| | Zinc mg/lt. | 3.31 |
| | Cadmium mg/lt. | 0.00 |
| | Sulfur mg/lt. | 0.06 |
| | Sodium mg./It | 5.94 |
| Amino Acids | Lysine | 618 |
| | Methionine | 188 |
| | Alanine | 485 |
| | Arginine | 541 |
| | Threonine | 392 |
| | Tryptophan | 204 |
| | Aspartic Acid | 790 |
| | Cystine | 79 |
| | Glutamic Acid | 927 |
| | Glycine | 463 |
| | Histidine | 194 |
| | Isoleucine | 416 |
| | Leucine | 772 |
| | Phenylalanine | 487 |
| | Proline | 390 |
| | Serine | 402 |
| | Tyrosine | 303 |
| | Valine | 521 |

Aracea family of Plants and other aquatic plants combinations or individually” extract having a total known analyzable concentration of auxins to cytokinins ratio of at least 10:1-20:1-30:1 even 100:1-500:1 and even higher depending on the formulation customization compounding, in a synergistically activity concentration effective amount.

The term ‘plants’ refers to all physical parts of a plant, including seeds, seedlings, pollen, saplings, roots, tubers, stems, stalks, foliage and fruits, tissue for micropropagation, cells, etc.

The term ‘plant propagation material’ implies generative parts of the plant, such as seeds, which can be used for the multiplication of the latter, and vegetative material, such as cuttings or tubers, for example potatoes. It includes seeds (in the strict sense), roots, fruits, tubers, bulbs, rhizomes, and parts of plants like branches or buds or crafting cuts; Germinated plants and young plants which are to be transplanted after germination or after emergence from the soil, may also be mentioned—these young plants may be protected before transplantation by a total or partial treatment by immersion. Suitably “plant propagation material” is understood to denote seeds and other plant parts or tissues or cells.

The term ‘plant growing locus’ is intended to embrace the place on which the plants are growing, where the plant propagation materials of the plants are sown or where the plant propagation materials of the useful plants will be placed into the soil. An example for such a locus is a field, on which crop plants are growing, stone wool or any natural or synthetic substrate with or without nutrients content that serves as a base or material for the plant to support by its root system. This can also be just the support system in the case of hydroponic and aquaponic systems where water is the main media that caries the nutrients.

The term ‘synergistically effective amount or activity amount or functional molecular concentrations’ indicates the quantity of such compounds which is capable of positively modifying improving the effect on the growth of plants and its yield or productivity, where said effect is greater than the sum of the effects obtained by applying each of the compounds individually.

The range of the present invention, there is provided a method of enhancing crop plants by applying a organic plant growth biological stimulation by a natural vitamin-hormone combination contained in DuckWeed.Bio product composed of a natural organic non-GMO concentrated extract mix of Duckweed “Araceae formally known family of plants Lemnaceae” and other aquatic family of plants extract having an activity concentration total auxins to cytokinin's concentration, activity ratio of at least 20:1-30:1 and as high but not limited to 100:1-500:1 even 1000:1 and higher to the plants, plant parts, plant propagation material, or a plant growing locus.

In an alternative aspect of the present invention, the composition used in the prevent invention does not comprise and content any insecticide, fungicide or herbicide compounds or synthetic plant growth regulators or synthetic plant hormones confirming the product is of organic nature and for organic natural applications.

According to the present invention, ‘crop enhancement’ means an improvement in plant vigor, an improvement in plant quality, improved tolerance to stress factors, and/or improved input use efficiency of water, carbon from the air, nutrient absorption from the soil and leaves depending on the crop type as conditions of growth; this will potentially reduce in variable degrees the amount of traditional fertilizer depending on the crop its management, conditions and fertilization practices resulting in a reduction in need of traditional fertilizers impacting positively the environment preventing lixiviation to water bed and run-offs contamination of surface water as soils with excessive nutrients.

According to the present invention, an ‘improvement in plant vigor’ strength improvements means that certain traits are improved qualitatively or quantitatively when compared with the same trait in a control plant which has been grown under the same conditions in the absence of the method of the invention. Such traits include, but are not limited to, early and/or improved germination, improved emergence, the ability to use less seeds, increased root growth in number and in length that sums as a significant increase in absorption surface area and a more developed root system, increased root nodulation, increased shoot growth, increased tillering, stronger tillers, more productive tillers, increased or improved plant stand, less plant verse (lodging), an increase and/or improvement in plant height, an increase in plant weight (fresh or dry), bigger leaf blades, greener leaf color, increased pigment content, increased chlorophyll content, increased photo synthetic activity, earlier flowering, increased flower number, longer panicles, early grain maturity, increased seed, fruit or pod size, increased pod or ear number, increased seed number per pod or ear, increased seed mass, enhanced seed filling, less dead basal leaves, delay of senescence, improved vitality of the plant, increased levels in plant tissue beneficial of nutrients for food and feed value and molecular composition that includes but is not limited to lipids, fatty acids, carbohydrates, vitamins, amino acids, etc. in storage tissues; and/or less inputs needed (e.g. less fertilizer, less water, less use of additives organic or chemical and/or less labor needed resulting in less costs). A plant with improved vigor may have an increase in any of the aforementioned traits or any combination or two or more of the aforementioned traits.

According to the present invention, an ‘improvement in plant quality’ means that certain traits are improved qualitatively or quantitatively when compared with the same trait in a control plant which has been grown under the same conditions in the absence of the method of the invention. Such traits include, but are not limited to, improved visual appearance of the plant, reduced ethylene (reduced production and/or inhibition of reception), improved quality of harvested material, e.g. seeds, fruits, leaves, vegetables (such improved quality may manifest as improved visual appearance of the harvested material), improved nutritional composition and improved value as food for human and feed for animals and as an ingredient in other applications like pharma and beauty products or industrial applications. Improve composition of carbohydrate content (e.g. increased quantities of sugar and/or starch, improved sugar acid ratio, reduction of reducing sugars, increased rate of development of sugar), improved protein content, improved oil content and composition, improved nutritional value, reduction in anti-nutritional compounds, improved organoleptic properties (e.g. improved taste, smell/aroma an visual appeal) and/or improved consumer health benefits (e.g. increased levels of vitamins and anti-oxidants)), improved post-harvest characteristics (e.g. enhanced shelf-life and/or storage stability, easier processability, easier extraction of compounds), more homogenous crop development (e.g. synchronized germination, flowering and/or fruiting of plants), and/or improved seed quality (e.g. for use in following seasons). A plant with improved quality may have an increase in any of the aforementioned traits or any combination or two or more of the aforementioned traits.

According to the present invention, an ‘improved tolerance to stress factors’ means that certain traits are improved qualitatively or quantitatively when compared with the same trait in a control plant which has been grown under the same conditions in the absence of the method of the invention. Such traits include, but are not limited to, an increased tolerance and/or resistance to abiotic stress factors which cause sub-optimal growing conditions such as drought (e.g. any stress which leads to a lack of water content in plants, a lack of water uptake potential or a reduction in the water supply to plants), cold exposure, heat exposure, osmotic stress, UV stress, flooding, increased salinity (e.g. in the soil), increased mineral exposure, ozone exposure, high light exposure and/or limited availability of nutrients or it's imbalance (e.g. nitrogen and/or phosphorus nutrients and/or potassium nutrients and/or micro-nutrients). A plant with improved tolerance to stress factors may have an increase in any of the aforementioned traits or any combination or two or more of the aforementioned traits. In the case of drought and nutrient stress, such improved tolerances may be due to, for example, more efficient uptake, use or retention of water and nutrients. This possibly increases the strength or vigor of the plants and/or crops also potentially reducing the impact of secondary Biotic Stress (e.g., pathogens examples as virus, bacteria, fungi, yeasts, etc. and parasites insects, aracnides, slugs, worms, etc.). A plant with improved quality may have an increase in any of the aforementioned traits or any combination or two or more of the aforementioned traits.

According to the present invention, an ‘improved input use efficiency’ means that the plants are able to grow more effectively using given levels of inputs compared to the grown of control plants which are grown under the same conditions in the absence of the method of the invention. In particular, the inputs include, but are not limited to fertilizer (such as nitrogen, phosphorous, potassium, micronutrients, etc.), light and water. A plant with improved input use efficiency may have an improved use of any of the aforementioned inputs or any combination of two or more of the aforementioned inputs.

A particular benefit of the present invention is an unexpected improvement in nitrogen use efficiency. One way to measure improvements in nitrogen use efficiency is via the Nitrogen Balance Index (NBI), which is derived from the ratio of chlorophyll to flavonoid levels in the plant. NBI can be measured using a device such as Multiplex® or Dualex® from Force-A.

Other crop enhancements in grasses and grain crops of the present invention include a reduction in tillering, which are beneficial features in this type of crops or conditions where it is desirable to maximize grain production yields.

In other crops like produce, fruit trees, beans, pulses, berries and many other dicotyledons the effect observed in the examples below indicate an increase in all the plant morphological and physiological activity having longer and more roots increasing the absorption surface for nutrients and retention of water also resulting in taller more froundous plants with heavier biomass, better flowering as fertilization, healthier more tolerant to stress and larger crop yields as quality of them.

Any or all of the above crop enhancements may lead to an improved yield by improving e.g., plant physiology, plant growth and development and/or plant architecture. In the context of the present invention ‘yield’ includes, but is not limited to, (i) an increase in biomass production, grain yield, starch content, lipids/fats/oil content and/or protein content, which may result from (a) an increase in the amount produced by the plant per se, or (b) an improved ability to harvest plant matter, (ii) an improvement in the composition of the harvested material (e.g. improved sugar acid ratios, improved oil composition, increased nutritional value, reduction of anti-nutritional compounds, increased consumer health benefits) and/or (iii) an

increased/facilitated ability to harvest the crop, improved processability of the crop and/or better storage stability/shelf life. Increased yield of an agricultural plant means that, where it is possible to take a quantitative measurement, the yield of a product of the respective plant is increased by a measurable amount over the yield of the same product of the plant produced under the same conditions, but without application of the present invention. According to the present invention, it is preferred that the yield be increased by at least 0.5%, more preferred at least 1%, even more preferred at least 2%, still more preferred at least 4%, preferably 5% or even more.

Any or all of the above crop enhancements may also lead to an improved utilization of land, i.e., land which was previously unavailable or sub-optimal for cultivation may become available. For example, plants which show an increased ability to survive in drought conditions, may be able to be cultivated in areas of sub-optimal rainfall, e.g., perhaps on the fringe of a desert or even the desert itself. For example, also to recover agricultural land that was previously mismanaged resulted in accumulation of higher salt content in the soil making it sub-optimal for cultivation.

In one aspect of the present invention, crop enhancements are made in the substantial absence of pressure from pests and/or diseases and/or abiotic stress. In a further aspect of the present invention, improvements in plant vigor, stress tolerance, quality and/or yield are made in the substantial absence of pressure from pests and/or diseases. For example, pests and/or diseases may be controlled by a pesticidal treatment that is applied prior to, or at the same time as, the method of the present invention. In a still further aspect of the present invention, improvements in plant vigor, stress tolerance, quality and/or yield are made in the absence of pest and/or disease pressure. In a further embodiment, improvements in plant vigor, quality and/or yield are made in the absence, or substantial absence, of abiotic stress.

Improvements presented in this invention described in vigor as reduction of Abiotic stress of plants and crops also have the potential to reduce the appearance and impact of Biotic Stress (pests) but cant stop a Biotic stress that sets causing pathological effect on plants and crops as morbidity and mortality of the living plants; in this case can only be stopped or counteracted by a Pesticide/regulator-growth control/pest-control of organic or inorganic origin of plant used alone or in combination with other management practices like biosecurity.

Any plant pesticide/growth-regulator may be used in accordance with the present invention. A complete list of all commercially available plant growth regulators may be obtained from public listed Government approved compound for safe and regulated use organic and non-organic chemical products that also have the guides for safe use in different crops, withdrawal periods as the human and environmental safety guides SDS and technical TDS. If desired, it is possible to use more than one pest control method fallowing approved government agencies in order to safeguard human health, animal health and protect biodiversity and the environment for future generations.

The rate of application of the product and customizable variants of the present invention may vary within wide limits and depends upon the nature of the soil, the method of application, the target crop or plant as plant variety, management practices, the prevailing climatic conditions, and other factors governed by the method of application and the time of application. The compounds “Product Name” of the present invention are generally applied in the liquid original product platform format but can also be applied in dry format platform. In both cases with variants on the different customizable concentrations and compounding formulations of Duckweed species and of other aquatic plants. Preferably the product “Product Name” will be applied in liquid form or reconstituted to a liquid solution from a dry soluble form but can also be applied in dry form as a concentrated soil mender. In the different formats at a rate of:

In liquid form depending on the product concentrated customized product version can be applied at a rate from about 0.001 lt. (liter)/ha. (Hectare to about 5 lt./ha., preferably from about 0.1 lt./ha. to about 2 lt./ha. In one embodiment, the seaweed extract is applied at about 1 lt./ha.

In dry form of 0.001 to 5 kg. (kilogram)/ha. (hectare), especially from 0.005 to 1 kg./Ha., in particular of about 0.01 to about 2 kg./Ha. Preferably the product “Product Name” will be applied in liquid form or reconstituted to a liquid solution from a dry soluble form but can also be applied in dry form as a concentrated soil mender where dosing will be customized to plant/crop needs depending on plant species, needs, soil, conditions and agricultural management practiced to optimize the results.

In dry or wet forms can be applied for propagation of plants as seed organic treatments alone or in combination with other products. Alone in dry form as a coating can be applied in rates from about 0.0001 kg./Kg. of seeds to about 0.5 kg/kg. of seeds depending on the type of plants or crops, management, and conditions. Also, application form as pre-sowing immersion dissolved or liquid application at a rate of 0.000001 lt. up to about 1 lt. per kg of seeds depending on the immersion time, temperature, scoring or not scoring of seeds, also depending on the type of plant or crop seeds as the species and agricultural management practices and conditions.

For micropropagation of plants by tissue culture or cell culture the use of dissolved dry form but preferably liquid or gels like agar form of “Product Name” at a rate of about 0.000000001 lt./It of propagation media or substrate to about 0.1 lt./It of media or substrate for propagation.

The method of the present invention may be applied to any crop plants, in particular monocotyledons, dicotyledons, angiosperm, macroalgae, microalgae, yeasts, beneficial or edible fungi or mushrooms and also Polypodiophyta (Ferns and mosses) as any other useful or beneficial member of the plant kingdom.

The method of the present invention may be applied to any crop plants, in particular monocotyledons such as cereals (wheat, millet, sorghum, rye, triticale, oats, barley, teff, spelt, buckwheat, fonio and quinoa), rice, maize (corn), and/or sugar cane, grasses, coconuts, bananas, onions, garlic, in ornamentals orchids; or dicotyledon crops such as beet (such as sugar beet or fodder beet), potatoes, sweet potatoes, zucchini, pumpkins; fruits (such as pomes (passion fruit), stone fruits or soft fruits, for example apples, pears, plums, peaches, grapes, almonds, macadamia nuts, peanuts, hazelnuts, pecan nuts, cherries, strawberries, raspberries, blueberries, blackberries, berries, pomegranate, most tropical fruits like Mango or Papaya as examples, cactus fruits (dragon Fruit and nopal tunas); leguminous plants (such as beans, lentils, peas or soybeans); oil plants (such as rape, mustard, poppy, olives, sunflowers, castor oil plants, cocoa beans or groundnuts); cucumber plants (such as marrows, cucumbers or melons); fiber plants (such as cotton, flax, hemp or jute); citrus fruit (such as oranges, lemons, grapefruit or mandarins); vegetables (such as spinach, lettuce, cabbages, carrots, tomatoes, peppers, cucurbits as cucumber or paprika); lauraceous (such as avocados, cinnamon or camphor); tobacco; nuts; coffee; tea; vines; hops; durian; natural rubber plants; and ornamentals (such as flowers, roses, shrubs, broad-leaved trees like oak and willow tree, and algo Angiosperms evergreens for example conifers for example pine and cyprus for forestry, construction materials timber and paper, pine nuts and other applications like pharma; Polypodiophyta Ferns and mosses both terrestrial ornamental leather leaf and aquatic like azola as foder. This list does not represent any limitation.

Crops also includes plants that have been transformed using recombinant DNA techniques so that they are capable of synthesizing one or more selectively acting toxins, such as are known, for example, from toxin-producing bacteria, especially those of the genus Bacillus. Crops also includes plants which have been transformed using recombinant DNA techniques so that they are capable of synthesizing antipathogenic substances having a selective action, such as, for example, the so-called “pathogenesis-related proteins”. Examples of such antipathogenic substances and transgenic plants capable of synthesizing such antipathogenic substances. The methods of producing such transgenic plants are generally known to produce what is known as genetically enhanced plant varieties that are design not only to be immune to certain pathogens or parasites but adapt to different climate or conditions than the original species of plants and mostly are known to have enhanced productivity.

The product of this invention and customizable compounded formulations of different aquatic plants of the present invention may be used in unmodified form, but can be formulated into compositions using formulation adjuvants, such as carriers, solvents and surface-active substances and stabilizers all of organic nature and as needed based on the application physical form, dosing and methodology. The formulations can be in various physical forms, for example dusting powders, pellets, gels, wettable powders, water-dispersible granules, water-dispersible tablets, effervescent compressed tablets, emulsifiable concentrates, microemulsifiable concentrates, oil-in-water emulsions, oil flowable, aqueous dispersions, oil dispersions, suspoemulsions, capsule suspensions, agar, liquid media, enriched media, seed coatings and soaking solutions, mollifiable granules, soluble liquids, water-soluble concentrates (with water or a water-miscible organic solvent as carrier), or impregnated polymer films. Such formulations can either be used directly or are diluted prior to use. Diluted formulations can be prepared, for example, with water, liquid fertilizers, micro-nutrients, amino acids, vitamins, other aquatic plants, macro-algae and microalgae, ferns, medicinal plants and herbs, biological organisms, beneficial microorganisms, soil microbiota, oil or organic solvents. These formulations may contain as little as about 0.1% to as much as about 95% or more by weight of active ingredient. The optimum amount for any given compound will depend on formulation, application equipment and nature of the plant's species, climate conditions and agricultural management practices as growth and yield targets.

Wettable powders are in the form of finely divided particles which disperse readily in water or other liquid carriers. The particles contain the active ingredient retained in a solid matrix. Typical solid matrices include fuller's earth, kaolin clays, silicas and other readily wet organic or inorganic solids. Wettable powders normally contain about 0.1% to about 95% of the active ingredient plus a small amount of wetting, dispersing or emulsifying agent.

Emulsifiable concentrates are homogeneous liquid compositions dispersible in water or other liquid and may consist entirely of the active compound with a liquid or solid emulsifying agent, soaps, surfactants of any type or origin organic or inorganic or may also contain absorption adjuvants a liquid carrier, such as xylene, heavy aromatic naphtha's, isophorone and other non-volatile organic solvents. In use, these concentrates are dispersed in water or other liquid and normally applied as a spray to the area to be treated. The amount of active ingredient may range from about 0.1% to about 95% of the concentrate.

Granular formulations include both extrudates and relatively coarse particles and are usually applied without dilution to the area in which suppression of vegetation is desired. Typical carriers for granular formulations include fertilizer, sand, fuller's earth, attapulgite clay, bentonite clays, montmorillonite clay, vermiculite, perlite, calcium carbonate, brick, pumice, pyrophyllite, kaolin, dolomite, plaster, wood flour, ground corn cobs, ground peanut hulls, sugars, sodium chloride, sodium sulphate, sodium silicate, sodium borate, magnesia, mica, iron oxide, zinc oxide, titanium oxide, antimony oxide, cryolite, gypsum, diatomaceous earth, calcium sulphate and other organic or inorganic materials which absorb or which can be coated with the active compound. Particularly suitable is a fertilizer granule carrier.

Granular formulations normally contain about 0.01% to about 25% active ingredients which may include Inorganic/synthetic or Organic. Being Inorganic surface-active agents such as heavy aromatic naphtha's, kerosene and other petroleum fractions, or Organic vegetable oils; and/or stickers such as dextrins, plant glue or Inorganic synthetic resins. The granular substrate material can be one of the typical carriers mentioned above and/or can be an Inorganic synthetic fertilizer material e.g., urea/formaldehyde fertilizers, ammonium, liquid nitrogen, urea, potassium chloride, ammonium compounds, phosphorus compounds, Sulphur, similar Organic plant fertilizers, nutrients and micronutrients, amino acids, chelated minerals, vitamins, and mixtures or combinations thereof. The Duckweed “Araceae” concentrated extract and other aquatic plant concentrated extract may be homogeneously distributed throughout the granule or may be spray impregnated or absorbed onto the granule substrate after the granules are formed.

Encapsulated granules are generally porous granules with porous membranes sealing the granule pore openings, retaining the active species in liquid form inside the granule pores. Granules typically range from 1 millimeter to 1 centimeter, preferably 1 to 2 millimeters in diameter. Granules are formed by extrusion, agglomeration or prilling, or are naturally occurring Inorganic/synthetic or Organic/Natural in nature. Examples of such materials are mineral/inorganic/synthetic vermiculite, sintered clay, kaolin, attapulgite clay, mineral carbon; Organic Natural sawdust and natural char granular carbon, fibers, starches sugars and plant gums. Shell or membrane materials include Organic/Natural and Inorganic/synthetic rubbers, cellulosic materials, styrene-butadiene copolymers, polyacrylonitriles, polyacrylates, polyesters, polyamides, polyureas, polyurethanes and starch xanthates. These encapsulated granules can be designed for different release times from fast release to slow release or timed release.

Dusts are free-flowing admixtures of the active ingredient with finely divided solids such as talc, clays, flours, sugars, starches and other Organic/natural and Inorganic/synthetic solids which act as dispersants and carriers.

Microcapsules are typically droplets or granules of the active material enclosed in an inert porous shell which allows escape of the enclosed material to the surroundings at controlled rates and timeframes. Encapsulated droplets are typically about 1 to 50 microns in diameter. The enclosed liquid typically constitutes about 500 to 95% of the weight of the capsule and may include solvent in addition to the active compound or just the active compound that will be dissolved by the water permeability of the membrane and then permeate/dose in a controlled release timed mechanism. Can also be dissolved in solution or diluted inside the microcapsule that once in contact with a wet substrate will permeate and release the active compound in solution.

Other useful formulations for plant organic Duckweed fertilizer vitamin hormone or crop enhancement applications include simple solutions of the active ingredients in a water solvent into solution which it is completely soluble at the desired concentration, such as other organic solvents and in some specific application's inorganic solvents or adjuvants. Pressurized sprayers, wherein the active ingredient is dispersed in finely divided form as a result of vaporization into fine droplets by pressure and or sonification in organic carrier or water, may also be used. For specialized applications in combination with pesticides formulations can include wetting, dispersing or emulsifying agents or Organic or inorganic synthetic origin. Examples are alkyl and alkylaryl sulphonates and sulphates and their salts, polyhydric alcohols; polyethoxylated alcohols, esters, and fatty amines. These agents, when used, normally comprise from 0.1% to 15% by weight of the formulation.

Suitable Inorganic synthetic and Organic natural agricultural adjuvants and carriers, either formulated together and/or added separately, that are useful in formulating the compositions of the invention in the formulation types described above are well known to those skilled in the art. Suitable examples of the different classes are found in the non-limiting list below.

Liquid carriers besides water or in combination with water that can be employed include water, toluene, xylene, petroleum naphtha, crop oils, vegetable oils, alginic compounds, agar gum, Arabic gum, other vegetable gums, organic glycerin oil, emulsifying organic agents, AMS; acetone, methyl ethyl ketone, cyclohexanone, acetic anhydride, acetonitrile, acetophenone, amyl acetate, 2-butanone, chlorobenzene, cyclohexane, cyclohexanol, alkyl acetates, diacetonalcohol, 1,2-dichloropropane, diethanolamine, p-dimethylbenzene, diethylene glycol, diethylene glycol abietate, diethylene glycol butyl ether, diethylene glycol ethyl ether, diethylene glycol methyl ether, N, N-dimethyl formamide, dimethyl sulfoxide, 1,4-dioxane, dipropylene glycol, dipropylene glycol methyl ether, dipropylene glycol dibenzoate, diproxitol, alkyl pyrrolidinone, ethyl acetate, 2-ethyl hexanol, ethylene carbonate, 1,1,1-trichloroethane, 2-heptanone, alpha pinene, d-limonene, ethylene glycol, ethylene glycol butyl ether, ethylene glycol methyl ether, gamma-butyrolactone, glycerol, glycerol diacetate, glycerol monoacetate, glycerol triacetate, hexadecane, hexylene glycol, isoamyl acetate, isobornyl acetate, isooctane, isophorone, isopropyl benzene, isopropyl myristate, lactic acid, laurylamine, mesityl oxide, methoxy-propanol, methyl isoamyl ketone, methyl isobutyl ketone, methyl laurate, methyl octanoate, methyl oleate, methylene chloride, m-xylene, n-hexane, n-octylamine, octadecanoic acid, octyl amine acetate, oleic acid, oleylamine, o-xylene, phenol, polyethylene glycol (PEG400), propionic acid, propylene glycol, propylene glycol monomethyl ether, p-xylene, toluene, triethyl phosphate, triethylene glycol, xylene sulfonic acid, paraffin, mineral oil, trichloroethylene, perchloroethylene, ethyl acetate, amyl acetate, butyl acetate, methanol, ethanol, isopropanol, and higher molecular weight alcohols such as amyl alcohol, tetrahydro fur fury 1 alcohol, hexanol, octanol, etc. ethylene glycol, propylene glycol, glycerin, N-methyl-2-pyrrolidinone, and the like. Water is generally the carrier of choice for the dilution of concentrates. Suitable solid carriers include talc, titanium dioxide, pyrophyllite clay, silica, attapulgite clay, kieselguhr, chalk, diatomaceous earth, lime, calcium carbonate, bentonite clay, fuller's earth, fertilizer, Organic or Natural origin cotton seed hulls, wheat flour, flour, starch, sugars, Casaba honey, soybean flour, pumice, wood flour, walnut shell flour, plant and algae-based polymers, lignin, and the like.

A broad range of surface-active agents Organic and Synthetic are advantageously employed in both said liquid and solid compositions, especially those designed to be diluted with carrier before application. The surface-active agents can be anionic, cationic, non-ionic or polymeric in character and can be employed as emulsifying agents, wetting agents, suspending agents or for other purposes. Typical surface-active agents also include adjuvants for the penetration of was or oil waxed or lipid mixed naturally on the surface on plant leaves and other plant parts aiding penetration of the product without harming the plant. Surfactants can include but not limited to diethanolammonium lauryl sulphate; alkylarylsulfonate salts, such as calcium dodecylbenzene sulfonate; alkylphenol-alkylene oxide addition products, such as nonylphenol-C.sub. 18 ethoxylate; alcohol-alkylene oxide addition products, such as tridecyl alcohol-C.sub. 16 ethoxylate; soaps, such as sodium stearate; alkylnaphthalenesulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; glycolipids natural and synthetic, such as rhamnolipids and sophorolipids, lipopeptides such as surfactin, polymeric biosurfactants such as emulsan and alasan, fatty acids as 3-(3-hydroxyalkanoyloxy, such as alkanoic acids (HAAs)), and phospholipids, such as phosphatidylethanolamine; block copolymers of ethylene oxide and propylene oxide; and salts of mono and dialkyl phosphate esters.

Other adjuvants commonly utilized in agricultural compositions include crystallization inhibitors, viscosity modifiers, suspending agents, spray droplet modifiers, pigments, antioxidants, foaming agents, light-blocking agents, compatibilizing agents, antifoam agents, sequestering agents, neutralizing agents and buffers, corrosion inhibitors, dyes, odorants, spreading agents, penetration aids, micronutrients, emollients, lubricants, sticking agents, and the like. The compositions can also be formulated with liquid fertilizers or solid, particulate fertilizer carriers such as ammonium nitrate, urea and the like.

Also, the present invention may optionally include for special products or product lines formulation some Organic/Natural and/or Inorganic/synthetic and/or Semi-synthetics organic derived molecules for special formulation one or more pesticides such as insecticides, nematicides, fungicides or herbicides or additional synthetic plant growth regulators. Co-application of pesticides with the present invention has the added benefit of minimizing farmer time spent applying products to crops, since only a single application may be required to both provide organic fertilizer growth enhancer, growth regulation and control pests. According to the present invention, there is provided the use of a composition comprising a synergistically effective amount of a plant growth regulator and Duckweed “Araceae” and/or other aquatic plant extract having an Organic Natural Vitamin-Hormones auxins to cytokinins ratio approximately of at least 20:1 to 30:1 based on chemical concentration for enhancing the growth of and/or enhancing crop plants productivity and yields in a natural way, as described above.

According to the present invention, there is provided a plant growth enhancing and improved productivity and yield composition, comprising an Organic Aquatic Plant or plants extract having an natural organic total approximate auxins to approximately total cytokinins ratio of at least 20:1 to 35:1 based on chemical concertation measured by HPLC and higher but not limited to 100:1-500:1 based on a more accurate method of activity in plants that shows a synergistic effect and even higher due to its synergistic effects observed in the examples embodied and compared with standards and other commercial products further described in the embodiment, the Duckweed's.Bio Product combination of species extract has an auxin to cytokinin's increased activity ratio of at least 50:1 and even higher depending on the formulation 100:1-500:1 and not limited can be even higher. In a further embodiment, the Combined compounded Duckweed's extract has an auxin to cytokinin ratio of approximately 30:1 on measurable chemical concentration of auxins that can be tested individually and their sum but not all auxins have a method or analysis yet to determine to total combined concentration so the most accurate method that measures by activity effect on the mug been standard methods using standard reference pure IBA and IAA the ratio is 45 fold times higher based on Auxins effect and compared to other commercial products common in the market (PRODUCT (1) “K”) that indicate ratios approximately of 100:1 to 300:1 and preferably 350:1 and up to 400:1 based on the same activity concertation method to determine phytochrome activity by its effect on Mug been roots.

A composition comparative study further embodiment described in detail in Example 6. to determine the concertation of Auxins in relation to Standard indole-3-Butiric acid (IBA) and indole-3-acetic (IAA) embodied in the examples Duckweed Biotech product is a combination of three aquatic plants of the Aracea family, which is compared with commercial seaweed products: Product (1) “K” and Product (2) “M”. The dilutions were made from the liquid concentrated products and the Duckweed Biotech from a natural concentrate extraction of three duckweed species. The equivalent phytohormone activity of IAA and IBA was established by the number of roots to the corresponding treatment dilution and interpolating the number of roots to the corresponding hormone concentration to obtain the total activity in mg/L of the commercial product. The comparative results are shown in Table 2 below. Duckweed Biotech shows comparative activity levels over 1,200 mg/L of IAA and 428 mg/L of IBA demonstrating a 22 times higher effect than Product (1) “K” on IAA and over 45 times higher in IBA when compared to Product (2) “M”. The Duckweed Biotech product shows 20 times higher activity in IAA and 10 times higher in IBA. Product (1) “K” shows activity levels of 9.38 mg/L of IBA which is slightly lower than the product information content of 11 mg/L of auxin equivalent activity as used in other literature where IBA was utilized as standard for evaluation of Product (1) “K” and Kelp auxin comparable activity effect on rooting.

TABLE 2
Comparative results and equivalence to root response and its effect over standards of IAA and IBA
then converted into activity in original product reverting the % of dilution in the equation.

| | | Activity | Activity | | | |
|---|---|---|---|---|---|---|
| | | Equivalente to | Equivalente to | | | |
| | Total | Standard Rooting | Standard Rooting | % Dilution of Product | Activity | Activity |
| | Root/Bud Max | effect of IAAmg./ | effect of IBA mg./ | for Max Root | IAA mg./lt. | IBA mg./lt. |
| | Number | lt. | lt. | development response | of Product | of Product |
| Duckweed.Bio “D” | 0 | 24.29 | 8.57 | 2% | 1,214.29 | 428.57 |
| Product (1) “K” | 0 | 10.63 | 1.88 | 20% | 53.13 | 9.38 |
| Product (2) “M” | 0 | 1.20 | 0.79 | 2% | 60.00 | 39.39 |
| | | | Difference in | Duckweed.Bio “D”/Product (2) “K” | 22.86 | 45.71 |
| | | | Activity in Fold | Duckweed.Bio “D”/Product (2) “M” | 20.24 | 10.88 |

Compositions of the present invention may contain from about 0.0000001% to about 99% by weight active ingredients. Suitably, the composition contains from about 0.0001% to about 50% by weight active ingredients. More suitably, the composition contains from about 0.001% to about 25%> by weight active ingredients. More suitably, the composition contains from about 0.001% to about 10% by weight active ingredients. If the formulation is in the form of a concentrate, requiring dilution with water before use, it will contain a higher amount of active ingredients than a composition that is ready to use without dilution.

The following examples further exemplify the present invention. Although the invention has been described with reference to preferred embodiments and examples thereof, the scope of the present invention is not limited only to those described embodiments. As will be apparent to persons skilled in the art, modifications and adaptations to the above-described invention can be made without departing from the spirit and scope of the invention, which is defined and circumscribed by the attached claims.

### EXAMPLES

### Example 1

1^{st}. Mugbeen Bioasya Organic Vitamin-Phytohormone Bioactivity Plant Growth Enhancement Study.

### Introduction

This research project evaluates a DuckWeed.Bio Concentrated Product with a mung bean bioassay to determine plant growth and rooting activity. The rooting stimulation of the extraction was evaluated at different concentrations and a dose curve response was determined in a period of 8 days. The mung bean plants were placed in a controlled environment for all study treatments under the same light, water, and temperature. Research is needed to identify the beneficial effects of duckweeds and its use as a biostimulant for agricultural production, plant health and environmentally sustainable solutions.

### 2.0 Materials and Methods

TABLE 3
List of Materials, Equipment and Reagents

| Materials | Equipment |
|---|---|
| Organic mung beans | Cell Bursting/Hi-Sheering |
| | Blender (1500 watts) |
| Duckweed. Bio Product | Precision balance (Max 600 g) |
| (Lemna & Wolffia) various | |
| blended species formulated | |
| | Cryogenic Tank |
| Green fruit netting bag | Digital Thermometer |
| 5 gal. bucket | Quantum Light meter- Lightscout |
| | (μmol photons m⁻² s⁻¹) |
| Plant labels and a12 (in) ruler | pH meter (Hanna pH Combo) |
| 70 plastic Conical vials (15 ml) | CO2/humidity/Temperature |
| | meter -IAQ50 (Supco) |
| 70 plastic Conical vials (50 ml) | |
| A clean container | Reagents |
| Distilled water (DI) and DI ice | Organic approved Stabilizer |
| Hydroponic finger micro snips | Organic approved PH Stabilizer |
| Camera and a cooler | |
| 1- & 5-ml micropipette | |
| 250 ml graduated cylinder | |
| 100 ml graduated cylinder | |
| Test tube rack | |

### 2.1 Preparation of the Dilutions

The DuckWeed.Bio Concentrated Product was diluted with DI water in a concentration range of 0 to 100% and the rooting ability of each percent of extraction was determined. The dilutions made from the stock solution (100%-Model Reactor) were prepared as shown in the table below:

TABLE 4
Dilutions

| | | | | | 30% | |
|---|---|---|---|---|---|---|
| | Percentage | | Dilution | | Dilution of | |
| | of | Treatment | DI | Duplicate | the 100% | |
| Vials | DuckWeed.Bio | Extract | Water | Treatment | Treatment | Duplicate |
| (15 ml) | Prod. | (ml) | (ml) | 1 & 2 | 3 | Treatment 3 |
| 1 | 100% | 15 | 0 | 2 | 30% | 1 |
| 2 | 90% | 13.5 | 1.5 | 2 | 27% | 1 |
| 3 | 80% | 12 | 3 | 2 | 24% | 1 |
| 4 | 70% | 10.5 | 4.5 | 2 | 21% | 1 |
| 5 | 60% | 9 | 6 | 2 | 18% | 1 |
| 6 | 50% | 7.5 | 7.5 | 2 | 15% | 1 |
| 7 | 40% | 6 | 9 | 2 | 12% | 1 |
| 8 | 30% | 4.5 | 10.5 | 2 | 9% | 1 |
| 9 | 25% | 3.75 | 11.25 | 2 | 7.5% | 1 |
| 10 | 20% | 3 | 12 | 2 | 6% | 1 |
| 11 | 15% | 2.25 | 12.75 | 2 | 4.5% | 1 |
| 12 | 10% | 1.5 | 13.5 | 2 | 3% | 1 |
| 13 | 5% | 0.75 | 14.25 | 2 | 1.5% | 1 |
| 14 | 0% | 0 | 15 | 2 | 0% | 1 |
| | Total: | 89.25 | 120.75 | | | |

### 3.0 Bioassay

Seeds of organic mung beans were germinated in microgreens trays for 9 days at 24° C. After the germination, seventy hypocotyl cuttings at 127 mm height (avg.) with 2 primary leaves and without cotyledon were transferred to 3 treatment vials at 14 vials per treatment:
Treatment 1: 14 vials with organic stabilizer (Green Treat.).
Treatment 2: 14 vials without organic stabilizer (Blue Treat.).
Treatment 3: 14 vials with 30% dilution of the extraction with organic stabilizer (Red Treat.)

The bioassay was performed as follows:

Five ml of the extraction solution from each vial was transferred to 15 ml vials.

The cuttings were placed into each vial and were soak for 8 hrs. at 25.2° C. and under lighting conditions of 125 μmol photons m⁻² s⁻¹.

Following the 8 hrs. treatment, the cuttings were removed and rinsed with distilled water (DI). Then, cuttings were transferred into 50 ml vials containing 20 ml of DI water for incubation of 8 days.

The number of roots, stem length, plant quality and plant biomass weight were recorded for all treatments. The data collected for all treatments was organized and analyzed using Microsoft Excel.

### 4.0 Results

### 4.1 Plant Growth

The average number of roots of each replicate was used to estimate root growth. The measurement of the stem height was collected using a 12-in ruler at beginning and end of the experiment. The overall health of the plants was also examined. The summary of the results are as follows:

Treatment 1. The Treatment with Stabilizer (Green)

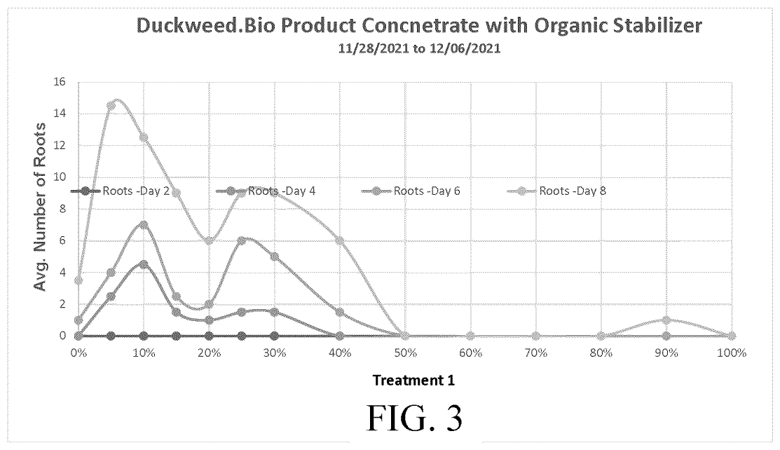

The plants with 5% and 10% of extraction had the higher average number of roots after one week of the experiment (FIG. 3).

FIG. 3 illustrates average number of Roots treatment 1. The controls plant had few roots at the end of the experiment.

A decline of root growth was observed in plants with 50 to 100% of extraction. The high concentration of the extract with a low pH under (4.5) Organic Stabilizer might be the primary factors of this result or to hi phytohormone effect beyond requirement can lead to opposite effect.

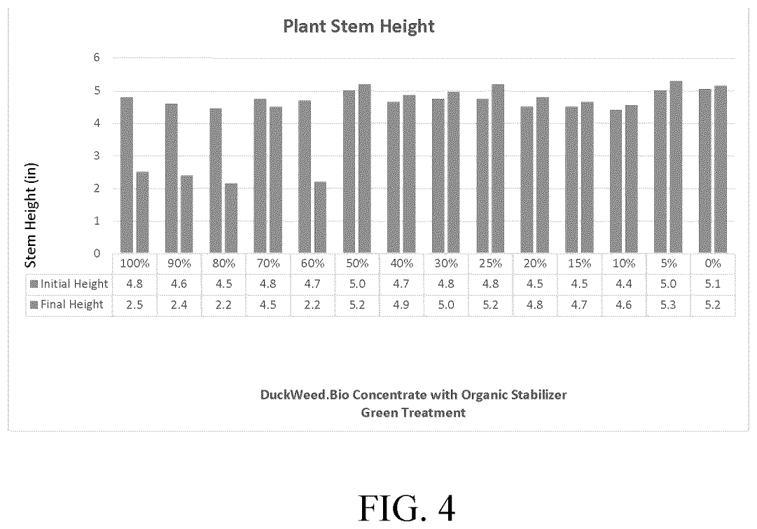

The Treatment 1 stimulated stem height and provided quality plants at lower concentrations range (FIG. 4). The stem of the control plants did not show a significant growth.

FIG. 4 illustrates stem height with organic stabilizer

Treatment 2. The Treatment without Organic Stabilizer (Blue)

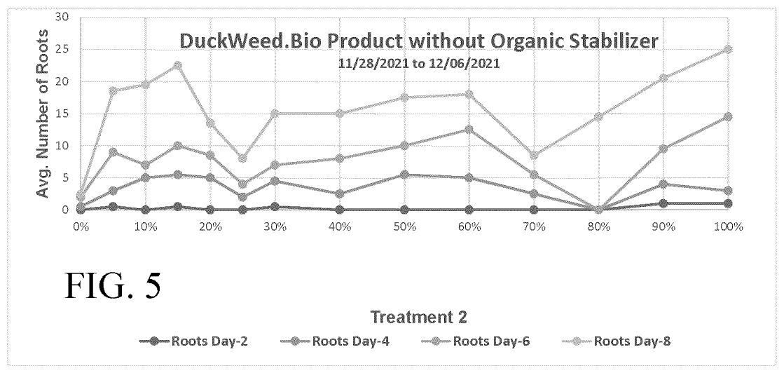

Plants with 15% and 100% of extraction had the higher number of roots. Both concentrations produced more than 24 roots (FIG. 5).

FIG. 5 illustrates average number of roots without organic Stabilizer

The control plants showed an average of 4 roots at the end of the experiment.

This treatment provided quality plants and enhanced stem height in all concentrations.

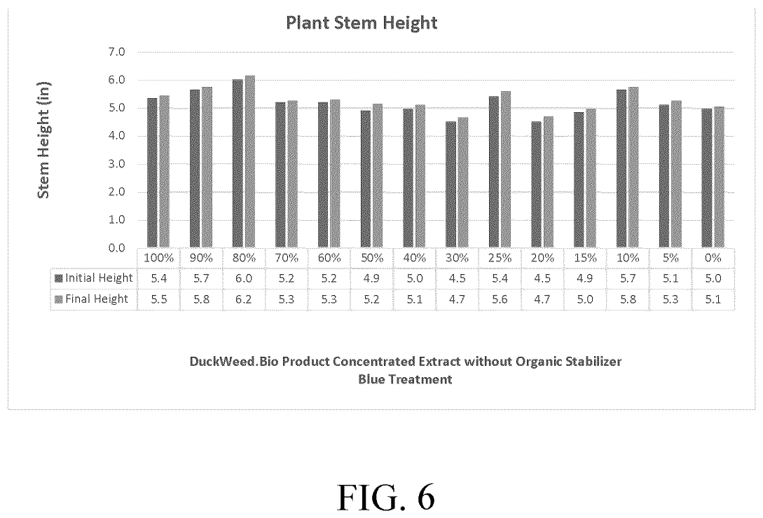

The stem of the control plants did not show a significant growth (FIG. 6).

FIG. 6 illustrates stem height blue treatment.

The range of the present invention, there is provided a method of enhancing crop plants by applying a organic plant growth biological stimulation by a natural vitamin-hormone combination contained in DuckWeed.Bio product composed of a natural organic

Treatment 3. The Treatment with 30% Dilution with Organic Stabilizer (Red)

Treatment three showed that DuckWeed.Bio Concentrated Product at 30% dilution stimulated root growth at lower concentrations better than treatment 1 and it had a similar plant growth as Treatment 2 which had no organic stabilizer.

The stimulated root production was higher at 15% and 30% of DuckWeed.Bio Product. Both concentrations had more than twenty-five roots whereas the control plant had 3 small roots at the end of the experiment.

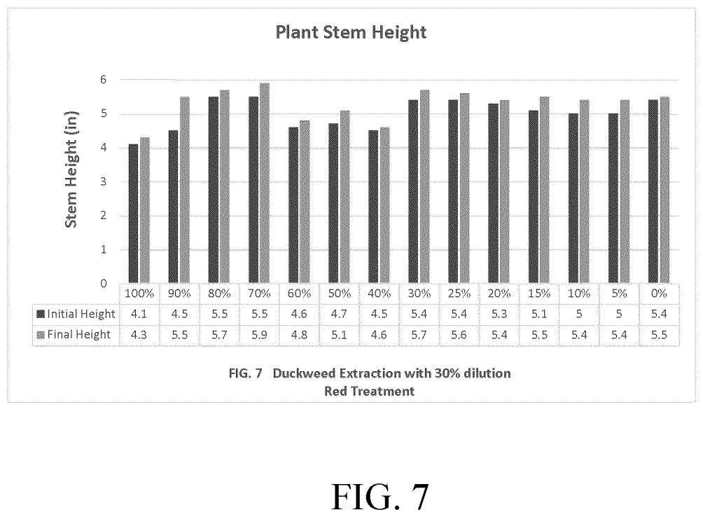

The Treatment 3 provided quality plants and stimulated stem height in all concentrations but the plant containing 90% of the diluted treatment had the higher stem. The control plant did not show a significant stem height (FIG. 7)

FIG. 7 which illustrates stem height red treatment.

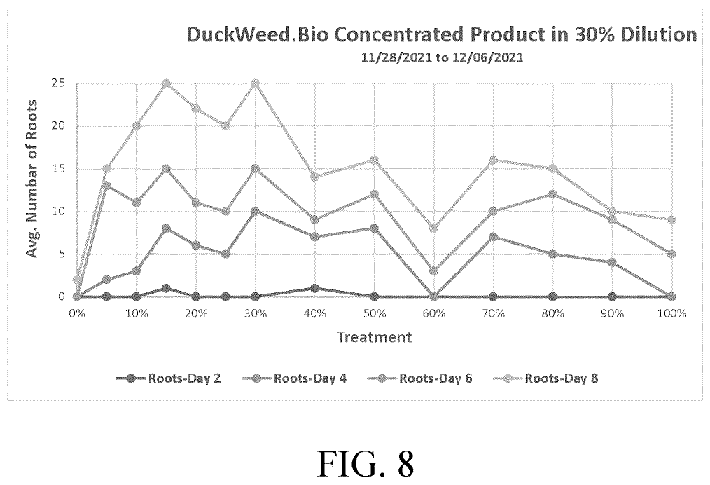

FIG. 8. Illustrates average number of roots associated with all treatments.

### 4.2 Biomass Weight Difference

The estimation of the plant biomass weight was performed to determine biomass gain or loss during the period of eight days. The initial and final weights of each mung bean plant were collected, and the data is show in the tables below. The equation used as follows: (Final PW−Initial PW)/Initial PW*100.

TABLE 5
Percent of Plant Weight (PW) Gain
DuckWeed. Bio Concentrated Product with Organic Stabilizer
Green Treatment

| | Initial | Final | |
|---|---|---|---|
| % | Plant | Plant | % |
| Extract | Weight | Weight | Gain |
| 100% | 0.57 | 0.29 | −49 |
| 90% | 0.49 | 0.39 | −20 |
| 80% | 0.52 | 0.18 | −65 |
| 70% | 0.7 | 0.78 | 11 |
| 60% | 0.54 | 0.3 | −44 |
| 50% | 0.55 | 0.54 | −2 |
| 40% | 0.51 | 0.43 | −16 |
| 30% | 0.59 | 0.62 | 5 |
| 25% | 0.61 | 0.73 | 20 |
| 20% | 0.52 | 0.55 | 6 |
| 15% | 0.57 | 0.65 | 14 |
| 10% | 0.47 | 0.63 | 34 |
| 5% | 0.75 | 0.97 | 29 |
| 0% | 0.66 | 0.69 | 5 |

DuckWeed. Bio Concentrated Product with 30% Dilution
Red Treatment

| | % | Initial | Final | % |
|---|---|---|---|---|
| Dilution | Extract | PW | PW | Gain |
| 30% | 100% | 0.24 | 0.31 | 29 |
| 27% | 90% | 0.28 | 0.42 | 50 |
| 24% | 80% | 0.28 | 0.41 | 46 |
| 21% | 70% | 0.34 | 0.4 | 18 |
| 18% | 60% | 0.2 | 0.3 | 50 |
| 15% | 50% | 0.24 | 0.4 | 67 |
| 12% | 40% | 0.22 | 0.36 | 64 |
| 9% | 30% | 0.26 | 0.44 | 69 |
| 7.5% | 25% | 0.33 | 0.45 | 36 |
| 6% | 20% | 0.28 | 0.44 | 57 |
| 4.5% | 15% | 0.3 | 0.41 | 37 |
| 3% | 10% | 0.22 | 0.35 | 59 |
| 1.5% | 5% | 0.3 | 0.44 | 47 |
| 0% | 0% | 0.27 | 0.34 | 26 |

TABLE 6
Percent of Plant Weight (PW) Gain
DuckWeed. Bio Concentrated Product without Organic Stabilizer
Blue Treatment

| % | Initial | Final | % |
|---|---|---|---|
| Extract | PW | PW | Gain |
| 100% | 0.58 | 0.95 | 64 |
| 90% | 0.6 | 0.92 | 53 |
| 80% | 0.63 | 0.89 | 41 |
| 70% | 0.56 | 0.62 | 11 |
| 60% | 0.56 | 0.85 | 52 |
| 50% | 0.61 | 0.82 | 34 |
| 40% | 0.54 | 0.82 | 52 |
| 30% | 0.52 | 0.73 | 40 |
| 25% | 0.45 | 0.69 | 53 |
| 20% | 0.49 | 0.73 | 49 |
| 15% | 0.57 | 0.86 | 51 |
| 10% | 0.69 | 0.95 | 38 |
| 5% | 0.6 | 0.73 | 22 |
| 0% | 0.58 | 0.68 | 17 |

### 4.2.1 Plant Biomass Results

Treatment 1. DuckWeed.Bio Concentrated Product with Organic Stabilizer (Green)

The plants with 5%, 10%, 15%, and 25% of extraction had a higher weight gain than the other concentrations. The plants with 5% showed significantly more biomass than the rest of the plants. The negative results are the loss in biomass. The presence of low pH in the Organic Stabilizer combined with a high concentration of extraction could be the influential factors for this result (Table 5).

Treatment 2. DuckWeed.Bio Concentrated Product without Organic Stabilizer (Blue)

A positive biomass gain was found in all plants. However, the maximum percent gain was found at 100% of the extraction with a percent gain of 64%. This result indicates a higher interaction of Cytokinins, gibberellins and auxins during the application. The hormonal site of action and the interaction between the hormones influence plant growth responds. (Table 6).

Treatment 3. DuckWeed.Bio Concentrated Product with 30% Dilution (Red).

A positive plant biomass gain was found in all concentrations. The maximum plant growth biomass was observed at 30%, 50% and 40% of extraction with a percent gain of 69%, 67% and 64% respectively (Table 7). This treatment had better results than Treatment 1 and 2.

### 5.0 Conclusion

The mung bean bioassay was used to evaluate plant growth and the rooting ability of the DuckWeed.Bio Concentrated Product. The results of the experiment showed that DuckWeed.Bio Concentrated Product enhanced plant growth and increased number of roots, and biomass. The highest percent of plant weight gain (Biomass) resulted on Treatment 3. This result indicates that the application of DuckWeed.Bio Concentrated Product at lower concentrations can enhance plant growth, stimulate root production, and produce biomass in greater quantities.

### Example 2

2^{nd}. Mugbeen Bioasay Organic Vitamin-Phytohormone Activity on Plant Growth Enhancement

### Introduction

A mung bean bioassay was performed to evaluate the effects of DuckWeed.Bio Concentrated Product as a biostimulant on plant growth and root production. The rooting stimulation of the extraction was observed at different concentrations and growth response was determined in a period of 8 days. The mung bean plants were placed in a controlled environment for all study treatments under the same light, water, and temperature. The application of bio-stimulants have been used in scientific research to reduce fertilization and provide environment-friendly plant production. More research is needed to identify the beneficial effects of duckweeds and its use as a biostimulant for agricultural production, plant health and environmentally sustainable solutions.

### 2.0 Materials and Methods

TABLE 8
List of Materials and Equipment

| Materials | Equipment |
|---|---|
| Organic mung beans | Cell Bursting/Hi-Sheer |
| | Blending (1500 watts) |
| Duckweed (Lemna spp.) various | Precision balance (Max 600 g) |
| blended species formulated | |
| Wolffia spp. Compounded | Cryogenic Tank |
| selected species and other | |
| aquatic plants | |
| Green fruit netting bag | Digital Thermometer |
| 5 gal. bucket | Quantum Light meter- Lightscout |
| | (μmol photons m⁻² s⁻) |
| Plant labels and a ruler | pH meter (Hanna pH Combo) |
| 70 plastic Conical vials (15 ml) | CO2/humidity/Temperature |
| | meter -IAQ50 (Supco) |
| 70 plastic Conical vials (50 ml) | Corning Mixer (PC-620D) |
| A clean container | |
| Distilled water (DI) | Reagents |
| Hydroponic finger micro snips | Organic Stabilizer |
| Camera and a cooler | Organic PH Stabilizer |
| 1- & 5-ml micropipette | Organic Emulsion Stabilizer |
| 250 ml graduated cylinder | |
| 100 ml graduated cylinder | |
| Test tube rack | |

### 2.2 Preparation of the Dilutions

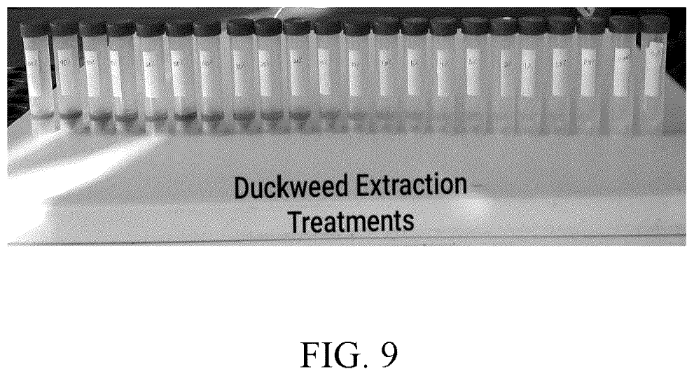

The Duckweed.Bio Concentrated extract product was diluted with DI water in a concentration range of 0 to 100% and the rooting ability of each percent of extraction was determined (FIG. 9). The dilutions made from the stock solution (100%-Model Reactor) were prepared as shown below:

TABLE 9
Dilutions

| Vials | Percentage | Treatment | Dilution | |
|---|---|---|---|---|
| (20 ml) | of Extraction | Extract (ml) | DI Water (ml) | Triplicate |
| 1 | 100% | 20 | 0 | 3 |
| 2 | 90% | 18 | 2 | 3 |
| 3 | 80% | 16 | 4 | 3 |
| 4 | 70% | 14 | 6 | 3 |
| 5 | 60% | 12 | 8 | 3 |
| 6 | 50% | 10 | 10 | 3 |
| 7 | 40% | 8 | 12 | 3 |
| 8 | 30% | 6 | 14 | 3 |
| 9 | 25% | 5 | 15 | 3 |
| 10 | 20% | 4 | 16 | 3 |
| 11 | 15% | 3 | 17 | 3 |
| 12 | 10% | 2 | 18 | 3 |
| 13 | 7.5% | 1.5 | 18.5 | 3 |
| 14 | 5% | 1 | 19 | 3 |
| 15 | 4% | 0.8 | 19.2 | 3 |
| 16 | 3% | 0.6 | 19.4 | 3 |
| 17 | 2% | 0.4 | 19.6 | 3 |
| 18 | 1.5% | 0.3 | 19.7 | 3 |
| 19 | 1% | 0.2 | 19.8 | 3 |
| 20 | 0.5% | 0.1 | 19.1 | 3 |
| 21 | 0.25% | .05 | 19.95 | 3 |
| 22 | 0% | 0 | 20 | 3 |
| Total: | | 122.95 | 317.05 | 66 |

FIG. 9 illustrates DuckWeed.Bio concentrated product treatments.

### 3.0 Bioassay

Seeds of organic mung beans were germinated in microgreens trays at 24° C. After 9 days, sixty-six hypocotyl cuttings at 127 mm avg. height with 2 primary leaves and without cotyledon were transferred to treatment vials at 3 vials per treatment. Three replicates were performed for each treatment. The treatments consisted of different concentrations of the DuckWeed.Bio Concentrated Product with preservatives. The extraction solution was diluted in a concentration range as described in Table 2. The bioassay was performed as follows:

Five ml of the extraction solution from each treatment was transferred to 20 ml vials.

The cuttings were placed into each vial and were soak for 8 hrs. at 25.2° C. and under lighting conditions of 125 μmol photons m⁻² s⁻¹.

Following the 8 hrs. treatment, the cuttings were removed and rinsed with distilled water (DI). Then, cuttings were transferred into new vials containing 20 ml of DI water for incubation of 8 days.

After 8 days, data was record and collected. The number of roots, stem length, and the fresh weight of each plant were recorded to see how much biomass is accumulated in each treatment. Also, the quality of the plant was record.

The data collected was organized and analyzed using Microsoft Excel.

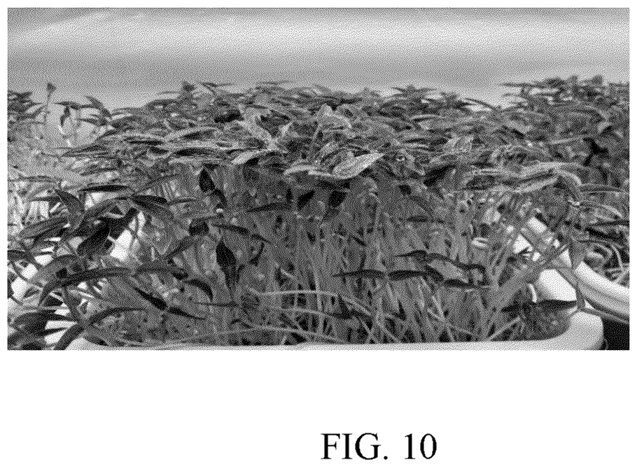

FIG. 10 illustrates mung beans germination and

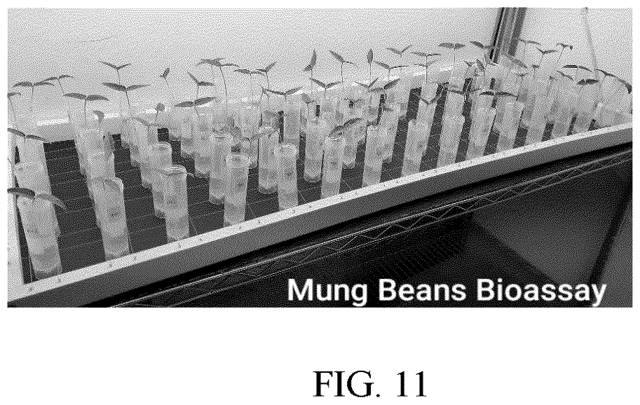

FIG. 11. Illustrates mung beans hypocotyl cuttings.

### 4.0 Results

### 4.1 Plant Growth

The average number of roots including root dots formation of each replicate were used to evaluate root growth. The measurement of the stem height was collected using a 12-in ruler at beginning and end of the experiment. The overall health of the plants was also examined. The summary of the results are as follows:

### Root Growth and Stem Height

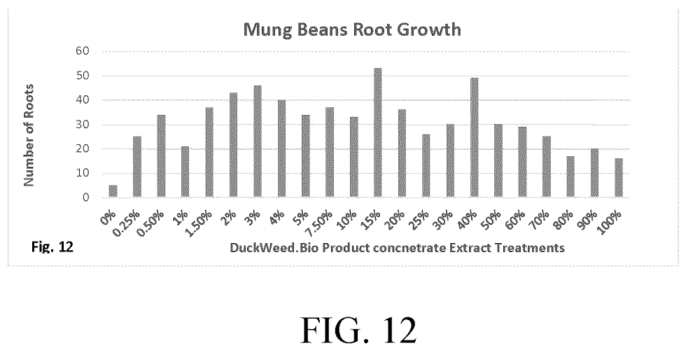

Root stimulation was enhanced more at lower concentrations. The plants with 15% dilution had the higher rooting activity (FIGS. 12 & 13).

FIG. 12 illustrates number of roots and

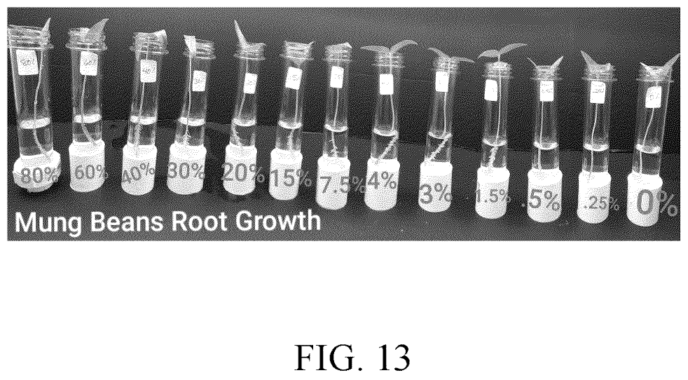

FIG. 13 illustrates comparison of root growth.

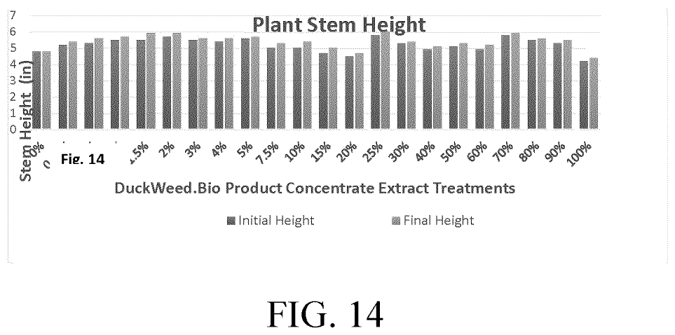

The treatments stimulated stem growth in all concentrations but the concentration of 1.5% had a higher stem average growth overall (FIG. 14).

FIG. 14 illustrates the stem of the control plants did not show a significant growth.

The DuckWeed.Bio Product Concentrated extract treatments provided good quality plants with green leaves, healthy stem, and roots

### 4.2 Biomass Weight Difference

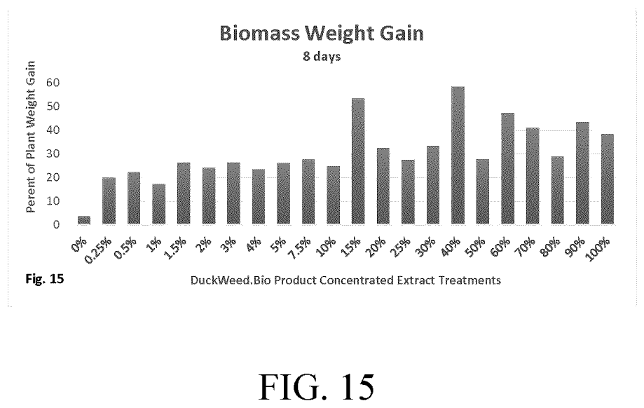

The estimation of the plant biomass weight was performed to determine biomass gain or loss during the period of eight days. The initial and final fresh weights of each mung bean plant were collected, and the data is illustrated in Table 10 and FIG. 15. The equation used as follows: (Final PW−Initial PW)/Initial PW*100.

### 4.2.1 Plant Biomass Results

A positive plant biomass weight gain was found in all the treatments. The maximum plant growth biomass was observed at 40% and 15% with a percent gain of 58% and 53% respectively (Table 10 and FIG. 15).

FIG. 15 illustrates biomass weight gain as fresh weight (FW)

TABLE 10
Percent of Plant Weight (PW) Gain

| | Initial | Final | % |
|---|---|---|---|
| % Extract | PW | PW | Gain |
| 100% | 0.81 | 1.12 | 38.3 |
| 90% | 0.92 | 1.32 | 43.5 |
| 80% | 0.77 | 0.99 | 28.6 |
| 70% | 0.83 | 1.17 | 41.0 |
| 60% | 0.87 | 1.28 | 47.1 |
| 50% | 0.87 | 1.11 | 27.6 |
| 40% | 0.96 | 1.52 | 58.3 |
| 30% | 0.78 | 1.04 | 33.3 |
| 25% | 0.77 | 0.98 | 27.3 |
| 20% | 0.83 | 1.1 | 32.5 |
| 15% | 0.9 | 1.38 | 53.3 |
| 10% | 0.81 | 1.01 | 24.7 |
| 7.5% | 0.83 | 1.06 | 27.7 |
| 5% | 0.92 | 1.16 | 26.1 |
| 4% | 0.94 | 1.16 | 23.4 |
| 3% | 0.8 | 1.01 | 26.3 |
| 2% | 0.96 | 1.19 | 24.0 |
| 1.5% | 0.99 | 1.25 | 26.3 |
| 1% | 0.87 | 1.02 | 17.2 |
| 0.5% | 0.94 | 1.15 | 22.3 |
| 0.25% | 0.81 | 0.97 | 19.8 |
| 0% | 0.84 | 0.87 | 3.6 |

### 5.0 Conclusion

The mung bean bioassay was used to evaluate plant growth and the effect of DuckWeed.Bio Concentrated Product on root production. Mung beans cuttings were made from 9-day old seedlings for all study treatments. Each treatment was replicated three times and the plants remained healthy throughout the experiment. The results of the experiment showed that DuckWeed.Bio Concentrated Product enhanced plant growth, and increased total number of roots, and plant biomass. The lateral root initiation and emergence were found higher in lower concentrations and the higher stem elongation was observed at 1.5%. A positive biomass gain was found in all treatments. Because fresh weight was used to measure plant weight gain, the moisture content of the plants can fluctuate the measurement of plant biomass.

### Example 3

3^{rd}. Mugbeen Bioasay Organic Vitamin-Phytohormone Activity on Plant Growth Enhancement.

### Introduction

A mung bean bioassay was performed to evaluate the effects of Duckweed. Bio Concentrated Production plant growth and root development. The Duckweed Biotech Product a Concentrated Biostimulant Fertilizer proprietary formula made mainly of the concentrated extract of a mix of Duckweed plants grown in the proprietary system was applied in different concentrations and the rooting growth response was determined in a period of 15 days. The mung bean plants were placed in a controlled environment for all study treatments under the same light, water, soil, humidity, and temperature. The application of plant extracts has been used as a biostimulant to enhance plant growth and soil biological activities. Reports from the scientific community has proven the beneficial effects of plant extracts that provides environment-friendly plant production.

### 2.0 Materials and Methods

TABLE 11
List of Materials and Equipment

| Materials | Equipment |
|---|---|
| Organic mung beans | Veritas Precision balance (Max 600 g) |
| Duckweed Mix. Proprietary | Digital Thermometer |
| Duckweed Biotech harvest | |
| Green fruit netting bag | Quantum Light meter- Lightscout |
| | (μmol photons m⁻² s⁻) |
| 5 gal. bucket | pH meter (Hanna pH Combo) |
| Plant labels and a ruler | CO2/humidity/Temperature |
| | meter -IAQ50 (Supco) |
| 70 plastic Conical vials (15 ml) | Corning Mixer (PC-620D) |
| 70 plastic Conical vials (50 ml) | |
| A clean container | |
| Distilled water (DI) | |
| Hydroponic finger micro snips | |
| Camera and a cooler | |
| 1- & 5-ml micropipette | |
| 250 ml graduated cylinder | |
| 100 ml graduated cylinder | |
| Test tube rack | |

### 2.1 Preparation of the Dilutions

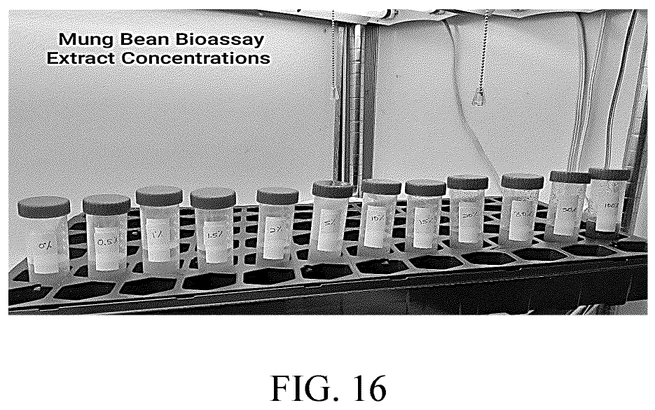

The DuckWeed.Bio Concentrated Product was diluted with DI water in a concentration range of 0 to 100% and the rooting ability of each percent of extraction was determined (FIG. 16).

FIG. 16. Illustrates DuckWeed.Bio concentrated product treatments. The dilutions made from the stock solution (100%-Model Reactor) were prepared as shown below:

TABLE 12
Dilutions:
Table 12. Dilutions

| | | Treatment | Dilution DI | |
|---|---|---|---|---|
| Vials | Percentage | Extract | Water | |
| (20 ml) | of Extraction | (ml) | (ml) | Triplicate |
| 1 | 100% | 20 | 0 | 3 |
| 2 | 50% | 10 | 10 | 3 |
| 3 | 30% | 6 | 14 | 3 |
| 4 | 20% | 4 | 16 | 3 |
| 5 | 15% | 3 | 17 | 3 |
| 6 | 10% | 2 | 18 | 3 |
| 7 | 5% | 1 | 19 | 3 |
| 8 | 2% | 0.4 | 19.6 | 3 |
| 9 | 1.5% | 0.3 | 19.7 | 3 |
| 10 | 1% | 0.2 | 19.8 | 3 |
| 11 | 0.5% | 0.1 | 19.1 | 3 |
| 12 | 0% | 0 | 20 | 3 |
| Total: | | 47 | 192.2 | 36 |

### 3.0 Bioassay

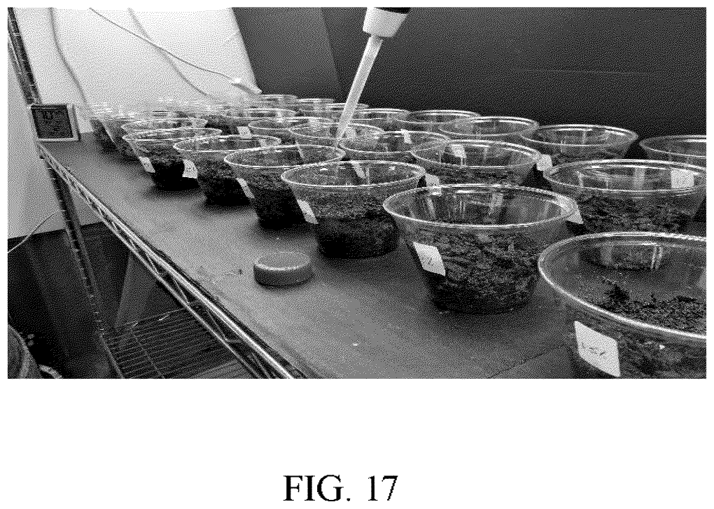

Seeds of organic mung beans Vigna radiata were rinsed thoroughly and then soaked in tap water for 24 hr. The seeds were transferred to a microgreen tray overnight at 24° C. and the sprouted seeds (4 mm of radicle) from a microgreen's tray were selected and planted individually into cups containing 90 g of organic soil (FIG. 17). Each cup had two holes for drainage and air flow. The seeds were planted 1.5 cm depth from soil level. The soil from each cup was saturated with 20 mL of distilled water (DI) prior to planting. Then 10 ml of DI water was added every day. The treatment solutions were applied on top of the seeds and soil the next day after planting. Three replicates were used for each treatment. The cups were placed 6 cm apart and were left at 24.4±3° C. ambient air temperature and under lighting at 125 μmol photons m² s⁻¹ in 12 hr. photoperiod. The pH of the soil was 7.0 and the humidity was maintained over 58%. Spraying DI water over the seedlings was performed as needed to maintained high humidity. The DuckWeed.Bio Concentrated Product was diluted in concentration range of 0, 0.5, 1.0, 1.5, 2, 5, 10, 15, 20, 30, 50 and 100% (FIG. 16 & Table 12). Five ml of the extraction solution was used from each treatment.

The plant weights, root length, and root structure were recorded after 15 days. The soil was removed from each cup and clean off any loose soil with a small brush. Many fine roots were formed and separate them to count were difficult. Plant dry weight was a better option. Then, seedlings were air dry for 6 hr. with a dry ambient temperature of 27° C.±3. Mung beans roots do dehydrate fast after 1 hr. of severance from water (Wilson, P. J et al, 1994). After the six hrs., the seedlings were individually weighted using the Veritas precision balance.

The root diameter was collected using the grid intersect technique. After the soil was removed and the roots were dried, the roots were placed over a grid pattern paper and the diameter of the root structure was measured. The number of times the roots intersect two grids represents 1 cm long. The same technique was also used to calculate root length. The stem height, initial open leaves, and leaves color were recorded as additional observation. The data collected was organized and analyzed using Microsoft Excel.

FIG. 17 illustrates application of the duckweed treatments in soil.

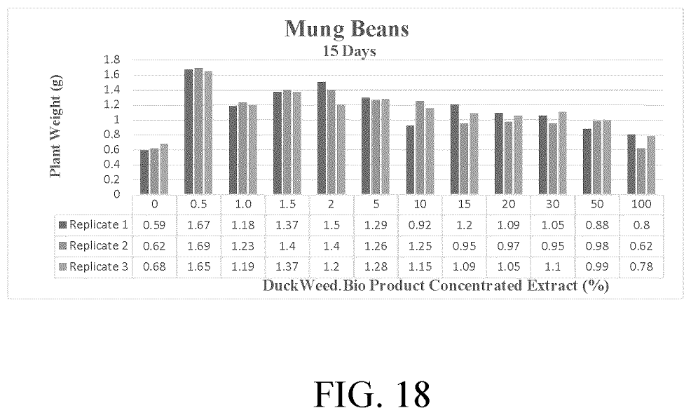

FIG. 18 illustrates application of the duckweed treatments effect on plant weight.

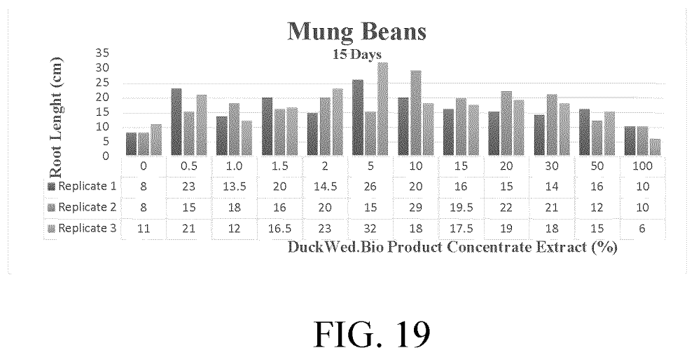

FIG. 19 illustrates application of the duckweed treatments effect on root length.

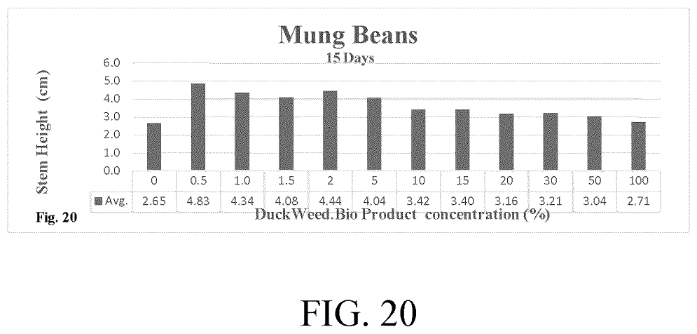

FIG. 20 illustrates application of the duckweed treatments effect on stem height.

### 4.0 Results

### 4.1 Plant Growth

The plant growth was recorded after 15 days of experiment. The rooting development was evaluated based on plant weights, root length and root diameter. Additional information such a leaves color and initial open leaves were also obtained. The optimum responses were observed in the lower concentrations from 0.5 to 5% dilution. The summary of the results is as follow:

The higher avg. plant weight was observed in 0.5% dilution with 1.67 g (FIG. 18).

The plant with the higher root length was found at 5% dilution with 32 cm long (FIG. 19).

The plants with 0.5% dilution reached an avg. stem height of 4.83 cm (FIG. 20)

The plants with first open leaves were at 1%, 2% and 20% dilution on Day 5.

The plants remained healthy throughout the experiment with green leaves.

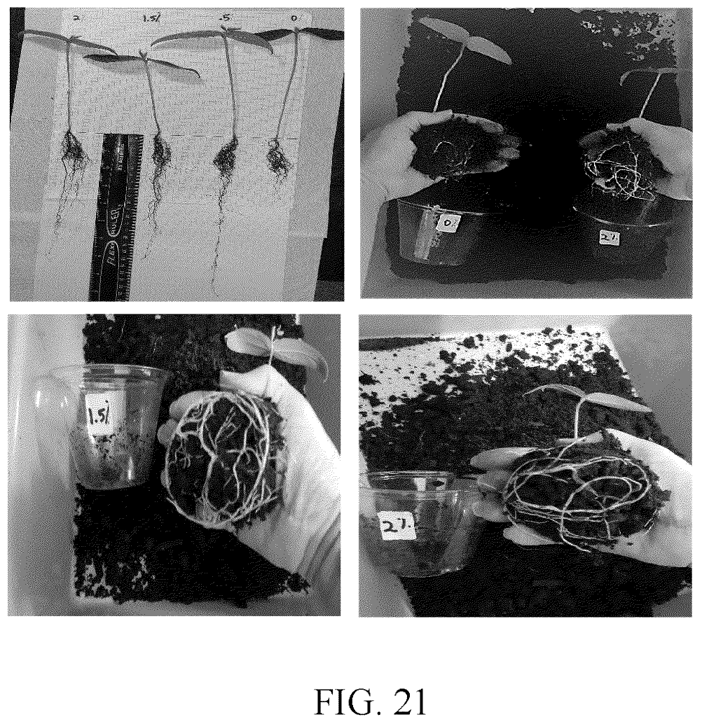

The plant with higher root diameter were observed at 0.5% dilution with 4 cm (FIG. 21).

FIG. 21 provides a comparison of root growth

### 5.0 Conclusion

The mung bean bioassay has been used intensively to evaluate the rooting promoting activity of plant extracts (Crouch I J et al. 1991). The results of the experiment showed that DuckWeed.Bio Concentrated Product can enhance plant growth, and root development. The degree of improved rooting with concentration range of 0.5 to 5% was observed on this experiment. Because many roots were formed and the roots' structure was very delicate after air drying, the plant weights, root diameter and length were used to evaluate the root development response.

### Example 4

### 4^{th} Mugbeen Bioasay Organic Vitamin-Phytohormone Activity

### Introduction

A mung bean bioassay was performed to evaluate the effects of DuckWeed.Bio Concentrated Product on plant growth and root development. The Duckweed Biotech Product a Concentrated Biostimulant Fertilizer proprietary formula made mainly of the concentrated extract of a mix of Duckweed plants grown in the proprietary system was applied in different concentrations on sprouts for 8 hr. at different concentrations and the rooting growth response was determined in a period of 15 days. The mung bean plants were placed in a controlled environment for all study treatments under the same light, water, soil, humidity, and temperature. The application of plant extracts has been used as a biostimulant to enhance plant growth and soil biological activities. Reports from the scientific community has proven the beneficial effects of plant extracts that provides environment-friendly plant production.

### 2.0 Materials and Methods

TABLE 13
List of Materials and Equipment

| Materials | Equipment |
|---|---|
| Organic mung beans | Veritas Precision |
| | balance (Max 600 g) |
| Duckweed Mix. Proprietary | Digital Thermometer |
| DuckWeed.Bio Product | |
| Concentrate from own harvest | |
| formulated aquatic plants. | |
| Quantum Light meter- | |
| Lightscout (μmol photons | |
| m⁻² s⁻) | |
| Green fruit netting bag | pH meter (Hanna pH Combo) |
| 5 gal. bucket | CO2/humidity/Temperature |
| | meter -IAQ50 (Supco) |
| Plant labels and a ruler | Corning Magnetic Mixer (PC-620D) |
| 70 plastic Conical vials (15 ml) | |
| 70 plastic Conical vials (50 ml) | |
| A clean container | |
| Distilled water (DI) | |
| Hydroponic finger micro snips | |
| Camera and a cooler | |
| 1- & 5-ml micropipette | |
| 250 ml graduated cylinder | |
| 100 ml graduated cylinder | |
| Test tube rack | |

### 2.1 Preparation of the Dilutions

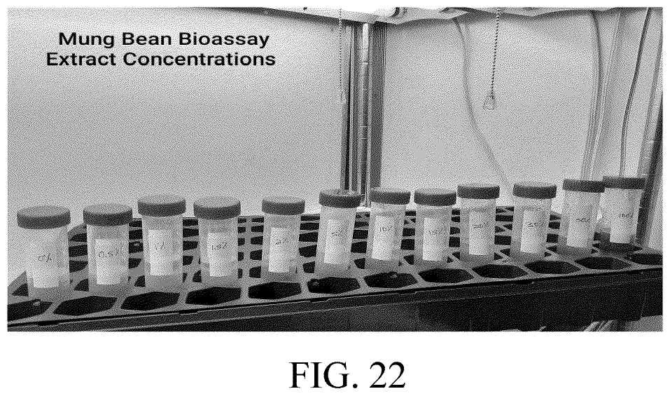

The DuckWeed.Bio Concentrated Product was diluted with DI water in a concentration range of 0 to 100% and the rooting ability of each percent of extraction was determined (FIG. 22). The dilutions made from the stock solution (100%-Model Reactor) were prepared as shown below:

TABLE 14
Dilutions

| | | Treatment | Dilution DI | |
|---|---|---|---|---|
| Vials | Percentage | Extract | Water | |
| (20 ml) | of Extraction | (ml) | (ml) | Seeds |
| 1 | 100% | 20 | 0 | 1 |
| 2 | 50% | 10 | 10 | 1 |
| 3 | 30% | 6 | 14 | 1 |
| 4 | 20% | 4 | 16 | 1 |
| 5 | 15% | 3 | 17 | 1 |
| 6 | 10% | 2 | 18 | 1 |
| 7 | 5% | 1 | 19 | 1 |
| 8 | 2% | 0.4 | 19.6 | 1 |
| 9 | 1.5% | 0.3 | 19.7 | 1 |
| 10 | 1% | 0.2 | 19.8 | 1 |
| 11 | 0.5% | 0.1 | 19.1 | 1 |
| 12 | 0% | 0 | 20 | 1 |
| Total: | | 47 | 192.2 | 12 |

FIG. 22 illustrates the extract concentrations to be tested.

### 3.0 Bioassay

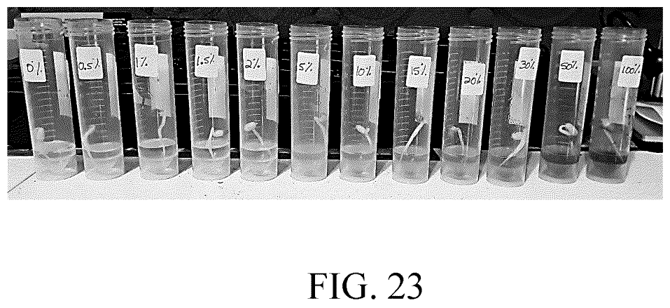

Seeds of organic mung beans Vigna radiata were rinsed thoroughly and then soaked in tap water for 24 hr. The seeds were transferred to a microgreen tray overnight at 24° C. and 5-cm sprouted seeds were selected and soaked in treatment solutions for 8 hrs. After the treatment the sprouts were planted individually into cups containing 90 g of organic soil (FIG. 23). Each cup had two holes for drainage and air flow. The sprouting seeds were planted 1.5 cm depth from soil level. The soil from each cup was saturated with 20 mL of distilled water (DI) prior to planting. Then 10 ml of DI water was added every day. One sprouted seed was used for each treatment. The cups were placed 6 cm apart and were left at 24.4±3° C. ambient air temperature and under lighting at 125 μmol photons m⁻² s⁻¹ in a 12-hr. photoperiod. The pH of the soil was 7.0 and the humidity was maintained over 58%. Spraying DI water over the seedlings was performed as needed to maintained high humidity. The DuckWeed.Bio Concentrated Product was diluted in concentration range of 0, 0.5, 1.0, 1.5, 2, 5, 10, 15, 20, 30, 50 and 100% (FIG. 22 & Table 14). Five ml of the extraction solution was used from each treatment.

The plant weights, root length, and root structure diameter were recorded after 15 days. The soil was removed from each cup and clean off any loose soil with a small brush. Many fine roots were formed and separate them to count were difficult. Plant dry weight was a better option. Then, seedlings were air dry for 3 hr. with a dry ambient temperature of 27° C.±3. Mung beans roots do dehydrate fast after 1 hr. of severance from water (Wilson, P. J et al, 1994). After three hrs., the seedlings were individually weighted using the Veritas precision balance.

The root diameter was collected using the grid intersect technique. After the soil was removed and the seedlings were air dried for 3 hrs., the roots were placed over a grid pattern paper and the diameter of the root structure was measured. The same technique was also used to calculate root length. The stem height, initial open leaves, leaves color and size were recorded as additional observation. The data collected was organized and analyzed using Microsoft Excel.

FIG. 23 illustrates application of the duckweed treatments.

### 4.0 Results

### 4.1 Plant Growth

The plant growth was recorded after 15 days of experiment. The rooting development was evaluated based on plant weights, root length and root structure diameter. Additional information such a leaves size and color and initial open leaves were also obtained. The summary of the results is as follow:

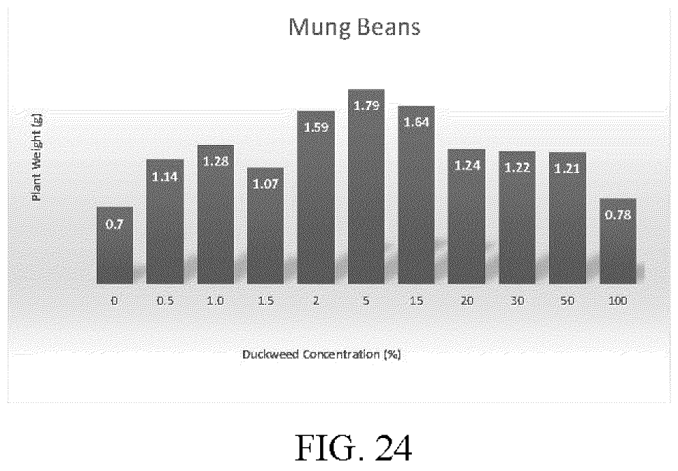

The higher plant weight was observed in 5% dilution with 1.79 g (FIG. 24).

FIG. 24 illustrates plant biomass (Fresh Weight)

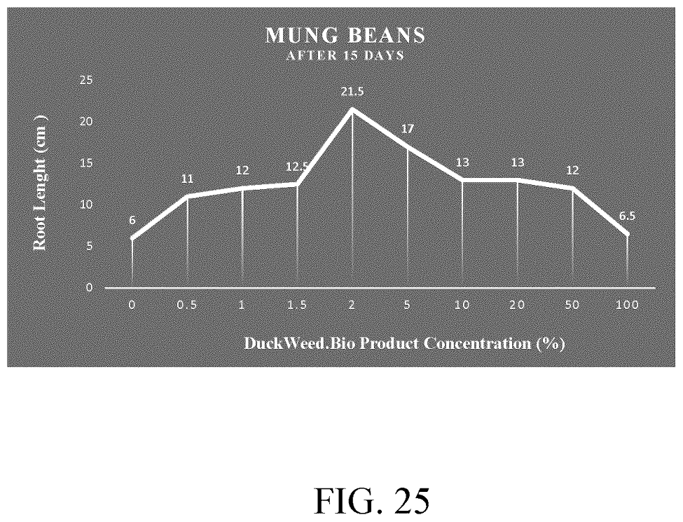

The plant with the higher root length was found at 2% dilution with 21.5 cm (FIG. 25).

FIG. 25 illustrates roots length.

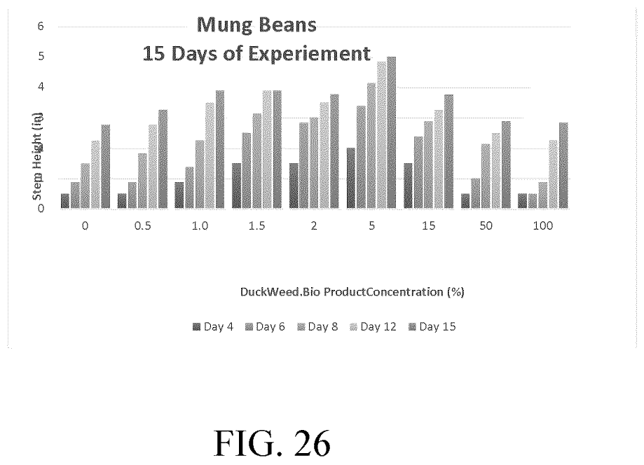

The plant with 5% dilution reached stem height of 4.83 in (FIG. 26)

FIG. 26 which shows stem height (shoot).

The plants with first open leaves were at 2% and 15% dilution.

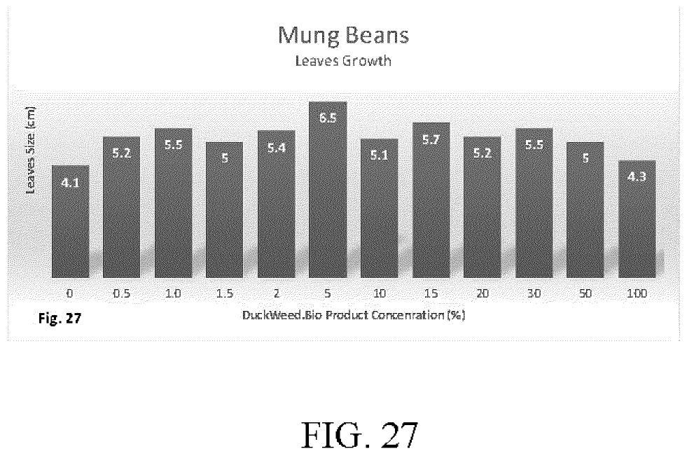

The plants remained healthy throughout the experiment with green leaves. The plant with bigger leaves was found at 5% dilution with 6.5 cm long (FIG. 27).

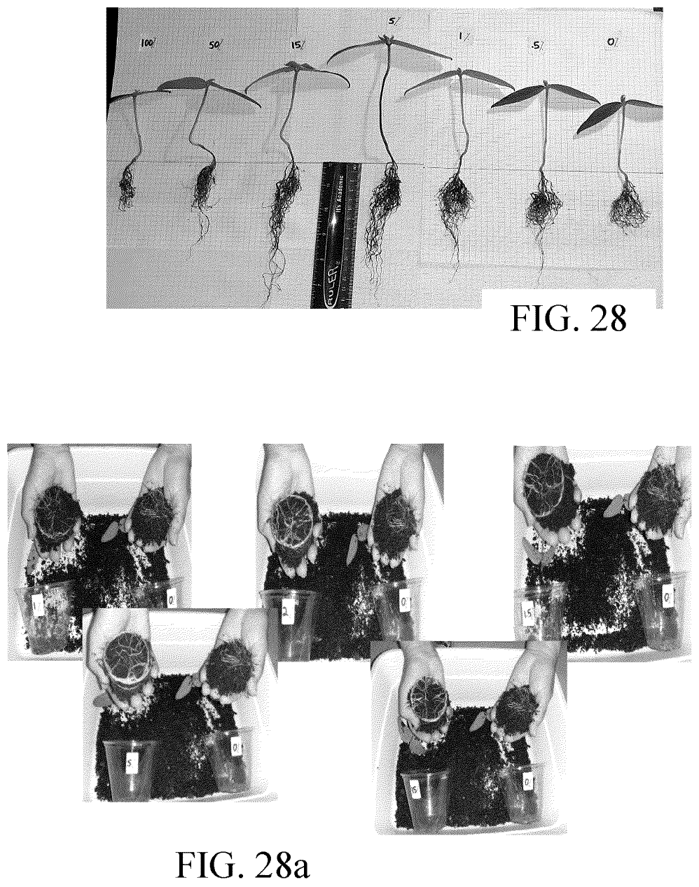

FIG. 27 discusses sizes of leaves. The plant with higher root diameter were observed at 5% dilution with 4 cm, as shown in FIG. 28.

FIG. 28 also provides a comparison view of plant growth.

### 5.0 Conclusion

The mung bean bioassay has been used intensively to evaluate the rooting promoting activity of plant extracts (Crouch I J et al. 1991). This bioassay was used to evaluate Duckweed.Bio Concentrated Product and the treatment solution at 5% dilution enhanced more plant growth and rooting development. Overall, the rooting stimulation at lower concentration range of 0.5 to 5% increased rooting activities effectively in this study.

### Example 5

Quantification of Biochemical Concentration UPLC (Ultra Performance Liquid Chromatography) of Total Auxins and Cytokinins in Duckweed Biotech Liquid Concentrated Organic Vitamin-Hormone Fertilizer plant growth Bio-Stimulant enhancer Product.

### Project Information

For the quantification analysis of the Auxins and Cytokinins for one Duckweed Biotech product sample using electrospray ionization-high-performance liquid chromatography tandem mass spectrometry (ESI-HPLC-MS/MS). 26 kinds of auxins and 36 kinds of Cytokinins as following were analyzed.

TABLE 15
List of Auxins and Cytokinins

| NO. | Phytohormone | Abbreviation | Class |
|---|---|---|---|
| 1 | Indole-3-acetic acid | IAA | Auxin |
| 2 | Methyl indole-3-acetate | ME-IAA | Auxin |
| 3 | Indole-3-butyric acid | IBA | Auxin |
| 4 | Indole-3-carboxaldehyde | ICAId | Auxin |
| 5 | Indole-3-carboxylic acid | ICA | Auxin |
| 6 | 3-Indolepropionic acid | IPA | Auxin |
| 7 | 1-O-Indol-3-ylacetylglucose | IAA-Glc | Auxin |
| 8 | Indoleacetyl glutamic acid | IAA-Glu | Auxin |
| 9 | 3-Indoleacetonitrile | IAN | Auxin |
| 10 | Indole-3-acetyl-Lglutamic acid Dimethyl ester | IAA-Glu-diMe | Auxin |
| 11 | Indole-3-acetyl-L-Leucine Methyl ester | IAA-Leu-Me | Auxin |
| 12 | INDOLE-3-ACETYL-L-VALINE METHYL ESTER | IAA-Val-Me | Auxin |
| 13 | Indole-3-acetyl glycine | IAA-Gly | Auxin |
| 14 | 2-oxindole-3-acetic acid | OxIAA | Auxin |
| 15 | Indole-3-acetyl-L-aspartic acid | IAA-Asp | Auxin |
| 16 | N-(3-Indolylacetyl)-L-leucine | IAA-Leu | Auxin |
| 17 | N-(3-Indolylacetyl)-L-valine | IAA-Val | Auxin |
| 18 | Indole-3-acetyl-L-phenylalanne methyle ester | IAA-Phe -Me | Auxin |
| 19 | Indole-3-acetyl-L-Tryptophan | IAA-Trp | Auxin |
| 20 | 3-Indoleacetamide | IAM | Auxin |
| 21 | Tryptamine | TRA | Auxin |
| 22 | Indole-3-lactic acid | ILA | Auxin |
| 23 | 3-Indoleacrylic acid | IA | Auxin |
| 24 | N-(3-Indolylacetyl)-L-alanine | IAA-Ala | Auxin |
| 25 | L-Tryptophan | TRP | Auxin |
| 26 | N-(3-Indolylacetyl)-L-phenylalanine | IAA-Phe | Auxin |
| 27 | N⁶-Isopentenyladenine | IP | CK |
| 28 | trans-Zeatin | tZ | CK |
| 29 | cis-Zeatin | cZ | CK |
| 30 | Dihydrozeatin | DZ | CK |
| 31 | Isopentenyladenosine | IPR | CK |
| 32 | trans-Zeatin riboside | tZR | CK |
| 33 | Dihydrozeatin-7-Glucoside | DHZ7G | CK |
| 34 | Dihydrozeatin ribonucleoside | DHZR | CK |
| 35 | cis-Zeatin riboside | cZR | CK |
| 36 | 4-[[(9-beta-D-Glucopyranosyl-9H-purin-6-yl) | pT9G | CK |
| | amino]methyl] phenol | | |
| 37 | 2-CHLORO-trans-ZEATIN | 2CltZ | CK |
| 38 | para-topolin | pT | CK |
| 39 | meta-topolin | mT | CK |
| 40 | meta-Topolin riboside | mTR | CK |
| 41 | ortho-topolin | oT | CK |
| 42 | 6-Benzyladenine | BAP | CK |
| 43 | 6-Benzyladenosine | BAPR | CK |
| 44 | Kinetin | K | CK |
| 45 | Kinetin riboside | KR | CK |
| 46 | para-Topolin riboside | pTR | CK |
| 47 | ortho-Topolin riboside | oTR | CK |
| 48 | cis-ZEATIN-9-GLUCOSIDE | cZ9G | CK |
| 49 | N6-Isopentenyl-Adenine-9-glucoside | iP9G | CK |
| 50 | N6-Isopentenyl-Adenine-7-glucoside | iP7G | CK |
| 51 | trans-Zeatin-O-glucoside | tZOG | CK |
| 52 | DIHYDROZEATIN-O-GLUCOSIDE RIBOSIDE | DHZROG | CK |
| 53 | cis-ZEATIN-O-GLUCOSIDE RIBOSIDE | cZROG | CK |
| 54 | meta-TOPOLIN-9-GLUCOSIDE (mT9G) | mT9G | CK |
| 55 | ortho-TOPOLIN-9-GLUCOSIDE | oT9G | CK |
| 56 | N6-BENZYLADENINE-9-GLUCOSIDE | BAP9G | CK |
| 57 | N6-BENZYLADENINE-7-GLUCOSIDE | BAP7G | CK |
| 58 | KINETIN-9-GLUCOSIDE | K9G | CK |
| 59 | 2-METHYLTHIO-N6-ISOPENTENYLADENINE | 2MeSiP | CK |
| 60 | 2-METHYLTHIO-cis-ZEATIN | 2MeScZ | CK |
| 61 | 2-METHYLTHIO-cis-ZEATIN RIBOSIDE | 2MeScZR | CK |
| 62 | 2-methylthio-N6-isopentenyladenosine | 2MeSiPR | CK |

### Methods and Materials

### Samples

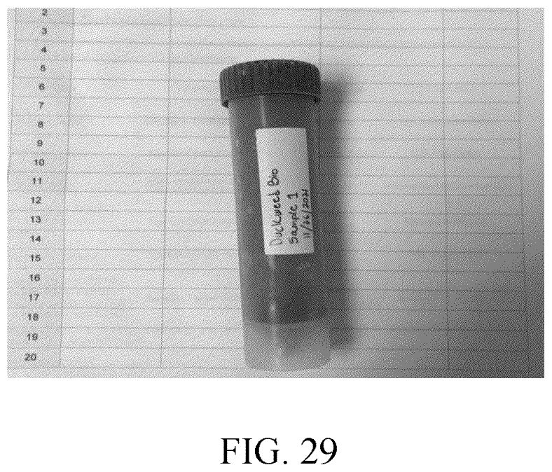

1 sample of Duckweed Biotech product was provided.

| FIG. 29 | Sample NO. | Sample Concentration |
|---|---|---|
| DuckWeed.Bio | A21263216b | 50 ml product sample |
| Product Sample 1 | | |

FIG. 29 is an image of a sample cryogenic stage prior to analysis.

### Reagents and Consumables

Chromatographic methanol (Merck)
Analytical acetonitrile (Merck)
Chromatographic formic acid (Sigma-aldrich)
Chromatographic acetic acid (Sigma-aldrich)
Standards (purity ≥99%, Olchemim/isoReag)

### Equipment

Ultra-performance liquid chromatography system (SCIEX)
AB SCIEX-6500 Qtrap MS/MS (Applied Biosystems)
Centrifuge-5424R (Eppendorf)
Balance-AS 60/220.R2 (RADWAG)
Ball milling-MM400 (Retsch)
CentriVap (LABCONCO)

### Methods

### Preparation of Standard Solution of Auxins and Cytokinins

The stock solutions of standards were prepared at the concentration of 1 mg/mL in MeOH. All stock solutions were stored at −20° C. The stock solutions were diluted with MeOH to working solutions before analysis.

### Sample Preparation and Extraction

Thaw the sample on ice.

Mix well and take out 2 ml for ultrasonic treatment (60 KHZ, 5 min, ultrasonic 1 second, interval 1 second).

Use microscope to verify samples is completely lysed.

Pipette 50 μL of sample, add 10 μL of 100 ng/ml internal standard mixed solution, 1 mL of methanol/water/formic acid (15:4:1, v/v/v) extractant, and mix well

Vortex for 10 minutes, centrifuge for 5 minutes at 4° C., 12,000 r/min, and transfer the supernatant to a new centrifuge tube for concentration;

After concentration, it was reconstituted with 100 μL of 80% methanol/water solution, passed through a 0.22 μm filter membrane, and placed in a sample bottle for LC-MS/MS analysis.

### HPLC-MS/MS Program

### UPLC Conditions for Auxins and Cytokinins

The sample extracts were analyzed using an UPLC-ESI-MS/MS system (UPLC, ExionLC™ AD, https://sciex.com.cn/; MS, Applied Biosystems 6500 Triple Quadrupole, https://sciex.com.cn/).

The analytical conditions were as follows.
LC column: Waters ACQUITY UPLC HSS T3 C18 (100 mm×2.1 mm i.d., 1.8 μm); Solvent system: water with 004% acetic acid (A), acetonitrile with 0.04% acetic acid (B); Gradient program, started at 5% B (0-1 min), increased to 95% B (1-8 min), 95% B (8-9 min), finally ramped back to 5% B (9.1-12 min); Flow rate, 0.35 mL/min; Temperature, 40° C.; Injection volume: 2 μL.

### Mass Spectrometry Parameter for Auxins and Cytokinins

AB 6500+QTRAP® LC-MS/MS System, equipped with an ESI Turbo Ion-Spray interface, operating in both positive and negative ion modes and controlled by Analyst 1.6 software (AB Sciex). The ESI source operation parameters were as follows: ion source, turbo spray; source temperature 550° C.; ion spray voltage (IS) 5500 V (Positive), −4500 V (Negative); curtain gas (CUR) was set at 35.0 psi; DP and CE for individual MRM transitions was done with further DP and CE optimization. A specific set of MRM transitions were monitored for each period according to the plant hormones eluted within this period.

### Results

### Qualitative and Quantitative Analysis of Auxins and Cytokinins

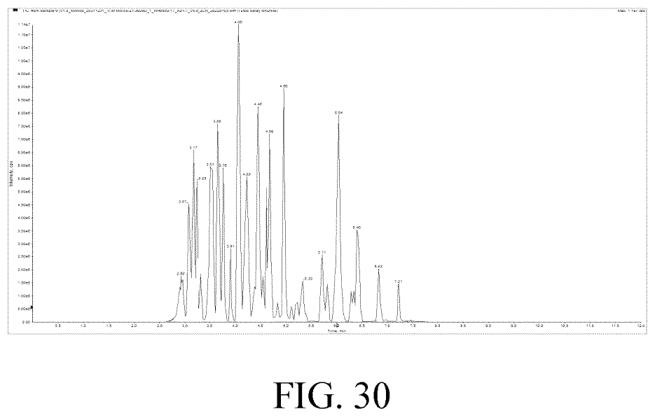

Using the software Analyst 1.6.3 to process the mass spectrum data. The figure below shows the total ion current (Total ions current, TIC, that is, the spectrum obtained by continuously depicting the sum of the intensities of all ions in the mass spectrum at each time point) of the mixed quality control (QC) sample and the detection of MRM metabolites Peak diagram (the ion current spectrum of multi-material extraction, XIC), the abscissa is the retention time (Rt) of metabolite detection, and the ordinate is the ion current intensity of ion detection (intensity unit is cps, count per second). The result is as shown below in (FIG. 30)

FIG. 30 which depicts total ion chromatogram of mixed QC sample mass spectrometry analysis.
Output files: Project Report/data/QC/*QC_MS_TIC.png

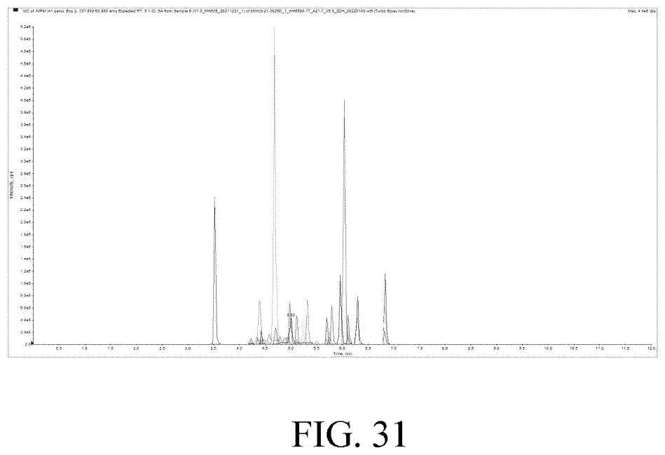

FIG. 31 illustrates MRM metabolite detection multimodal graph (negative ion mode)

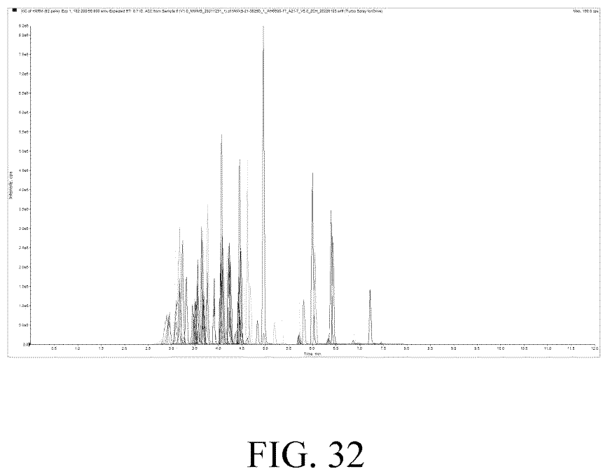

FIG. 32 is the MRM metabolite detection multimodal graph (positive ion mode)
Output files: data/QC/*MRM_detection_of_multimodal_maps*

Based on the local metabolic database, qualitative and quantitative analysis of the metabolites of the sample was carried out by mass spectrometry. In the figure, the multi-peak graph of MRM metabolite detection in the multi-reaction monitoring mode shows the substances that can be detected in the sample. Each mass spectrum peak with a different color represents a detected metabolite. The characteristic ions of each substance are screened out by the triple quadrupole, the signal intensity (CPS) of the characteristic ions is obtained in the detector, and the sample off-machine mass spectrum file is opened with MultiaQuant software, and the chromatographic peaks are integrated and corrected. The peak area (Area) of the peak represents the relative content of the corresponding substance, and finally all chromatographic peak area integral data are exported and saved.

In order to compare the substance content of each metabolite in different samples of all detected metabolites, based on the information of the retention time and peak type of the metabolite, we calibrate the mass spectrum peaks detected by each metabolite in different samples, to ensure the accuracy of qualitative and quantitative. The figure below shows the results of quantitative analysis integration calibration of randomly selected metabolites in different samples. The abscissa is the retention time (min) of metabolite detection, and the ordinate is the ion current intensity (cps) of a metabolite ion detection.

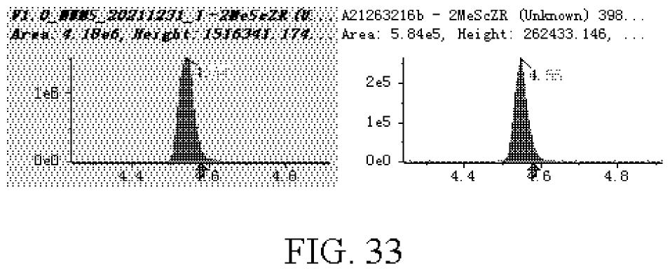

FIG. 33 is a metabolite quantitative analysis integration calibration chart
Output files: data/QC/*Integral_correction.png.

### Sample Quality Control Analysis

Quality control samples (QC) are prepared by mixing standard solutions to analyze the repeatability of samples under the same processing method. In the process of instrumental analysis, a quality control sample is inserted into every 10 test analysis samples to monitor the repeatability of the analysis process

By overlaying and displaying the total ion current diagrams (TIC diagrams) of mass spectrometry analysis of different quality control QC samples, the repeatability of metabolite extraction and detection can be judged, that is, technical repetition. The high stability of the instrument provides an important guarantee for the repeatability and reliability of the data.

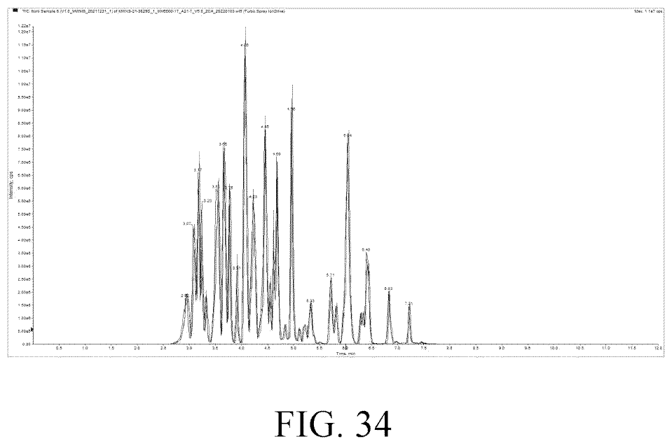

FIG. 34 depicts overlapping of total ion chromatogram of mass spectrometry analysis of different quality control QC samples
Output files: data/QC/*QC_MS_tic_overlap.png

### Standard Curves

ng/ml, 0.05 ng/ml, 0.1 ng/ml, 0.5 ng/ml, 1 ng/ml, 5 ng/ml, 10 ng/mL, 50 ng/mL, 100 ng/ml, 200 ng/ml, and 500 ng/ml standard solution was prepared. The mass spectrum peak intensity data of the corresponding quantitative signal of each concentration standard was collected. The concentration ratio of external standard and internal standard was as the abscissa, and the peak area ratio of external standard and internal standard was as the ordinate. The standard curves of different substances are shown as follow.

TABLE 16
Standard Curves of 26 Auxin and 36 Cytokinin Standards

| Index | Class | RT | Equation | r | Weighting | LLOQ | ULOQ |
|---|---|---|---|---|---|---|---|
| TRP | Auxin | 3.26 | y = 4117.86764 x 2317.64870 | −0.99937 | 1/x | 1 | 10000 |
| TRA | Auxin | 3.56 | y = 1.12596e5 x 14768.07949 | +0.99691 | 1/x | 0.1 | 500 |
| OxIAA | Auxin | 4.16 | y = 0.00833 x −3.72481e−4 | 0.99771 | 1/x | 1 | 500 |
| IAA-Asp | Auxin | 4.23 | y = 0.02602 x −0.00829 | 0.99577 | 1/x | 0.1 | 500 |
| IAA-Glc | Auxin | 4.23 | y = 7.13153e−5 x −2.28911e−4 | 0.99840 | 1/x | 1 | 500 |
| IAM | Auxin | 4.26 | y = 0.02153 x +4.89785e−4 | 0.99787 | 1/x | 0.1 | 500 |
| IAA-Glu | Auxin | 4.34 | y = 0.03464 x −1.00434e−4 | 0.99892 | 1/x | 0.1 | 500 |
| IAA-Gly | Auxin | 4.35 | y = 0.07873 x −0.00323 | 0.99835 | 1/x | 1 | 500 |
| ILA | Auxin | 4.57 | y = 0.00542 x −0.01038 | 0.99414 | 1/x | 2 | 500 |
| IAA-Ala | Auxin | 4.66 | y = 0.13972 x −0.00944 | 0.99854 | 1/x | 0.1 | 500 |
| ICA | Auxin | 4.70 | y = 0.01185 x −5.55641e−4 | 0.99629 | 1/x | 0.5 | 500 |
| ICAld | Auxin | 4.83 | y = 0.02404 x +0.00197 | 0.99576 | 1/x | 0.1 | 500 |
| IAA | Auxin | 4.97 | y = 0.01258 x +2.06193e−4 | 0.99608 | 1/x | 0.2 | 500 |
| IA | Auxin | 5.19 | y = 0.01559 x +9.49013e−5 | 0.99716 | 1/x | 0.2 | 500 |
| IAA-Val | Auxin | 5.34 | y = 0.23764 x −0.00926 | 0.99765 | 1/x | 0.1 | 500 |
| IPA | Auxin | 5.39 | y = 0.33980 x +0.00354 | 0.99613 | 1/x | 0.1 | 500 |
| IAA-Glu-diMe | Auxin | 5.51 | y = 0.01786 x −2.05920e−4 | 0.99810 | 1/x | 0.5 | 500 |
| IAA-Trp | Auxin | 5.68 | y = 0.10936 x −9.58908e−4 | 0.99650 | 1/x | 0.1 | 500 |
| IAA-Leu | Auxin | 5.71 | y = 0.31255 x −1.73192e−4 | 0.99513 | 1/x | 0.1 | 500 |
| IBA | Auxin | 5.71 | y = 0.22832 x +0.07578 | 0.99988 | 1/x | 0.2 | 500 |
| IAN | Auxin | 5.73 | y = 0.08161 x +0.00488 | 0.99980 | 1/x | 0.5 | 500 |
| IAA-Phe | Auxin | 5.79 | y = 0.18083 x −4.05275e−4 | 0.99839 | 1/x | 0.5 | 500 |
| MEIAA | Auxin | 6.02 | y = 0.02919 x +1.79129e−4 | 0.99731 | 1/x | 0.2 | 500 |
| IAA-Val-Me | Auxin | 6.05 | y = 0.82145 x +0.03216 | 0.99721 | 1/x | 0.1 | 500 |
| IAA-Leu-Me | Auxin | 6.40 | y = 0.73190 x +0.00753 | 0.99864 | 1/x | 0.1 | 500 |
| IAA-Phe-Me | Auxin | 6.44 | y = 0.54624 x +0.00205 | 0.99905 | 1/x | 0.1 | 500 |
| tZOG | CK | 2.78 | y = 0.06746 x −0.02916 | 0.99390 | 1/x | 0.2 | 500 |
| tZ | CK | 2.95 | y = 0.18728 x −0.01580 | 0.99399 | 1/x | 0.1 | 500 |
| DZ | CK | 3.09 | y = 0.07920 x −0.00501 | 0.99598 | 1/x | 0.1 | 500 |
| DHZ7G | CK | 3.12 | y = 0.40196 x +0.00151 | 0.99070 | 1/x | 0.1 | 500 |
| cZ | CK | 3.17 | y = 0.10013 x −6.70212e−4 | 0.99917 | 1/x | 0.1 | 500 |
| cZ9G | CK | 3.23 | y = 0.32807 x −0.00418 | 0.99884 | 1/x | 0.1 | 500 |
| DHZROG | CK | 3.45 | y = 0.22689 x −0.00468 | 0.99398 | 1/x | 0.1 | 500 |
| cZROG | CK | 3.48 | y = 0.07575 x −0.02870 | 0.99757 | 1/x | 0.1 | 500 |
| pT | CK | 3.50 | y = 0.06718 x −0.00218 | 0.99666 | 1/x | 0.2 | 500 |
| pT9G | CK | 3.52 | y = 0.14527 x −0.00481 | 0.99784 | 1/x | 0.1 | 500 |
| tZR | CK | 3.55 | y = 0.25169 x −0.00187 | 0.99884 | 1/x | 0.1 | 500 |
| DHZR | CK | 3.56 | y = 0.14668 x −3.62817e−4 | 0.99345 | 1/x | 0.1 | 500 |
| cZR | CK | 3.64 | y = 0.16355 x −3.07400e−4 | 0.99978 | 1/x | 0.1 | 500 |
| iP7G | CK | 3.66 | y = 0.25780 x −0.00529 | 0.99787 | 1/x | 0.1 | 500 |
| mT | CK | 3.67 | y = 0.08769 x +1.27892e−4 | 0.99625 | 1/x | 2 | 500 |
| mT9G | CK | 3.68 | y = 0.16216 x −0.00145 | 0.99843 | 1/x | 0.1 | 500 |
| K | CK | 3.74 | y = 0.06757 x +7.17829e−4 | 0.99759 | 1/x | 0.1 | 500 |
| K9G | CK | 3.76 | y = 0.17069 x +0.00170 | 0.99976 | 1/x | 0.1 | 500 |
| BAP7G | CK | 3.77 | y = 0.37440 x +0.00680 | 0.99428 | 1/x | 0.1 | 500 |
| pTR | CK | 3.90 | y = 0.12117 x −0.00269 | 0.99671 | 1/x | 0.1 | 500 |
| mTR | CK | 4.05 | y = 0.19550 x +0.00432 | 0.99890 | 1/x | 0.1 | 500 |
| iP9G | CK | 4.05 | y = 0.19709 x +0.00127 | 0.99843 | 1/x | 0.1 | 500 |
| oT9G | CK | 4.06 | y = 0.12679 x +4.73120e−5 | 0.99821 | 1/x | 0.1 | 500 |
| IP | CK | 4.08 | y = 0.08821 x +0.00249 | 0.99323 | 1/x | 0.1 | 500 |
| oT | CK | 4.09 | y = 0.13606 x +0.00406 | 0.99284 | 1/x | 0.1 | 500 |
| KR | CK | 4.18 | y = 0.17387 x +5.53545e−4 | 0.99826 | 1/x | 0.1 | 500 |
| BAP9G | CK | 4.22 | y = 0.29818 x +0.00256 | 0.99612 | 1/x | 0.1 | 500 |
| BAP | CK | 4.25 | y = 0.14567 x +0.00383 | 0.99296 | 1/x | 0.1 | 500 |
| 2CltZ | CK | 4.38 | y = 0.05825 x −1.36239e−4 | 0.99901 | 1/x | 0.1 | 500 |
| oTR | CK | 4.43 | y = 0.17955 x +1.82936e−5 | 0.99711 | 1/x | 0.1 | 500 |
| 2MeScZ | CK | 4.47 | y = 0.03999 x +0.00114 | 0.99836 | 1/x | 0.1 | 500 |
| IPR | CK | 4.47 | y = 0.08624 x +0.00243 | 0.99510 | 1/x | 0.1 | 500 |
| 2MeScZR | CK | 4.54 | y = 0.14785 x +4.57904e−4 | 0.99659 | 1/x | 0.1 | 500 |
| BAPR | CK | 4.61 | y = 0.32657 x +0.00660 | 0.99322 | 1/x | 0.1 | 500 |
| 2MeSiPR | CK | 5.72 | y = 0.02455 x +1.13003e−4 | 0.99903 | 1/x | 0.1 | 500 |
| 2MeSiP | CK | 5.82 | y = 0.03166 x +2.82085e−4 | 0.99639 | 1/x | 0.1 | 500 |

Output files: data/equation.xlsx

### Auxin and Cytokinin Content

Substituting the integral peak area ratio of all samples detected into the standard curve linear equation and the formula for calculation.

The auxin content in the sample (ng/g)=C*V/1000/m
C: The concentration value obtained by substituting the integral peak area ratio into the standard curve (ng/ml); V: Volume of solution used in for redissolving (μL);
M: The weight of the sample weighed (g).
Output files: data/hormone.levels.xlsx

TABLE 7
Auxin and Cytokinin Quantitative Results

| | Duckweed | |
|---|---|---|
| Index | (ng/g) | Sample1 |
| IAA-Phe-Me | | |
| IAA-Val-Me | | |
| IAA-Glu | | |
| IAA-Ala | | |
| IAA-Glc | | |
| IAA-Glu-diMe | | |
| IAA-Gly | | |
| IAA-Leu | | |
| IAA-Leu-Me | | |
| IAA-Phe | | |
| IAA-Trp | | |
| IAA-Val | | |
| IAM | | |
| IPA | | |
| IBA | | |
| TRP | | |
| TRA | | |
| MEIAA | | |
| ILA | | |
| ICAId | | |
| ICA | | |
| IAN | | |
| IAA-Asp | | |
| IAA | | |
| OxIAA | | |
| IA | | |
| Total Auxins | 4032.49 | |
| DZ | | |
| BAPR | | |
| BAP | | |
| 2MeSiP | | |
| 2MeScZR | | |
| KR | | |
| mT | | |
| oT9G | | |
| oTR | | |
| 2CltZ | | |
| tZR | | |
| K9G | | |
| pT9G | | |
| DHZROG | | |
| IP | | |
| IPR | | |
| cZ | | |
| cZ9G | | |
| cZR | | |
| cZROG | | |
| iP7G | | |
| iP9G | | |
| tZOG | | |
| 2MeScZ | | |
| 2MeSiPR | | |
| BAP7G | | |
| BAP9G | | |
| DHZ7G | | |
| DHZR | | |
| K | | |
| pT | | |
| mT9G | | |
| mTR | | |
| oT | | |
| tZ | | |
| pTR | | |
| Total CKs | 121.97 | |

Note: The content unit is ng/g. N/A indicates that the substance was not detected in this project. The reason may be that the content of the substance in the sample is lower than the detection limit of the instrument or the substance is not contained in the sample.* represents data for reference only because the sample concentration is less than LLOQ or greater than ULOQ or SNR <10 or is not currently methodologically validated.

### Conclusions and Discussions

Here we successfully performed ESI-HPLC-MS/MS analysis for auxin and cytokinin of one duckweed sample provided by customer. Of which, the content of TRP (3899.68 ng/g) is the highest.

### Example 6

1^{St}. Mugbeen Bioassay of Organic Vitamin-Phytohormone Comparative Bioactivity Concertation of Duckweed Biotech Product Made of a Concentrated Extract of Various Selected Proprietary Species of Duckweed and Aquatic Plants Against Two Leading Market Leading Products Made Out of Giant Brown Kelp Seaweed Product (1) Made Out of Eckolina Maxima and Product (2) Made Out of Ascofilum Nodosum by Comparing the Rooting Response Effect of Stem Cuttings and Plant Growth and Using as Well Standard Indole-3-Butyric Acid (IBA) and Indole-3-Acetic Acid (IAA) as Reference to Calculate the Comparative Activity Concentration for Further Application Dossification System Development Standards.

### Introduction

A mung bean bioassay was performed to evaluate the effects of Duckweed Biotech and two world leading commercial products made of giant kelp seaweed products namely Product (1) made of Ecklonioa maxima the southern hemisphere giant brown kelp, and Product (2) made of Ascophyllum nodosum the northern giant brown kelp on rooting response of stem cuttings and plant growth. Also, the rooting response of stem cuttings in relation to auxins supplied was performed using indole-3-butyric acid (IBA) and indole-3-acetic acid (IAA). The duckweed, seaweeds, and auxins were applied on stem cuttings for 8 hr·hr. at different concentrations and the rooting response was evaluated after 8 days. The mung bean seedlings were placed in a controlled environment for all study treatments under the same light, water, soil, humidity, and temperature. For many years, plant extracts have been studied and evaluated to determine its performances in different applications such as fertilizers, soil amendments and animal feedings. Reports from the scientific community has proven the beneficial effects of plant extracts to agricultural soils and the considerable option of replacing commercial fertilizers. As a result, the evaluation of the effectiveness of DuckWeed.Bio Concentrated Product comparison with commercial brown kelp seaweed extract products is a good opportunity to explore the utilization of duckweed as a nutrient source for crops and soil amendment. This study can be used to validate the effectiveness of DuckWeed.Bio Concentrated Product as a better option than the commercial seaweed products.

### 2.0 Materials and Methods

TABLE 18
List of Materials and Equipment

| | |
|---|---|
| Materials | 100 ml graduated cylinder |
| Organic mung beans | Test tube rack & microgreen |
| | plastic containers |
| Duckweed Biotech Product marked | |
| as “D”; Made of a proprietary mix of | |
| several species of commonly knows | |
| Duckweed or water Lentin or | |
| watermeal as other hydrophyte | |
| macrophyte aquatic plants blend. | |
| Commercial Product (1) marked a | |
| “K”; Made of Ecklonia maxima | |
| extract | |
| Commercial Product (2) marked a | Equipment |
| “M”; Made of Ascophyllum nodosum | |
| extract | |
| Auxins Standards (IAA, IBA) | Precision balance (Max 600 g) |
| netting bag | Cryogenic Tank |
| 5 gal. bucket | Digital Thermometer |
| Plant labels and a ruler | Light meter- Lightscout |
| | (μmol photons m⁻² s⁻) |
| Plastic vials (70 ml) | pH meter |
| Plastic vials (50 ml) | CO2/humidity/Temperature meter |
| A clean container | A magnetic Mixer |
| Distilled water (DI) | |
| Hydroponic finger micro snips | |
| Camera and a cooler | |
| 1- & 5-ml micropipette | |
| 250 ml graduated cylinder | |

### 2.1 Preparation of Product Dilutions

Two commercial giant brown kelp seaweed products, Product (1) “K” made of Ecklonia maxima and Product (2) “M” made of Ascophyllum nodosum were compared with the Duckweed Biotech Product “D” made of a combination of Duckweed aquatic plants of the Araceae family of plants formally known as Lemnaceae family of plants. For the test, a series of dilutions from 0% to 50% were made from the concentrated commercial products. The dilutions and volumes of each product are shown in Table 19.

TABLE 19
Duckweed Biotech Product “DuckWeed.Bio “D”, Product (1)
“K”, and Product (2) “M” Dilutions

| Vials | | Product | DI Water | Replicate per |
|---|---|---|---|---|
| (20 ml) | % Dilution | (ml) | (ml) | treatment |
| 1 | 50% | 10 | 10 | 3 |
| 2 | 20% | 4 | 16 | 3 |
| 3 | 10% | 2 | 18 | 3 |
| 4 | 5% | 1 | 19 | 3 |
| 5 | 2% | 0.4 | 19.6 | 3 |
| 6 | 1% | 0.2 | 19.8 | 3 |
| 7 | 0.5% | 0.1 | 19.1 | 3 |
| 8 | 0% | 0 | 20 | 3 |
| Total: | | 17.7 | 141.5 | |

### 2.3 Preparation of Standards and Dilutions

The preparation of standards was performed using a concentration range of 0, 1, 2, 5, 10, 15, 20 and 30 mg/L of indole-3-butyric acid (IBA) and indole-3-acetic acid (IAA) as shown in Table 20. A dose growth response curve for rooting ability was produced using these auxins.

TABLE 20
IBA and IAA Standards

| | | Volume of | Volume of | | |
|---|---|---|---|---|---|
| | IBA & IAA | Stock | Stock | DI | |
| Vials | Concentration | Solution | Solution | water | |
| (20 ml) | (mg/l) | (ml) | (μl) | (ml) | Replicate |
| 1 | 30 | 0.6 | 600 | 19.4 | 4 |
| 2 | 20 | 0.4 | 400 | 19.6 | 4 |
| 3 | 15 | 0.3 | 300 | 19.7 | 4 |
| 4 | 10 | 0.2 | 200 | 19.8 | 4 |
| 5 | 5 | 0.1 | 100 | 19.9 | 4 |
| 6 | 2 | 0.04 | 40 | 19.96 | 4 |
| 7 | 1 | 0.02 | 20 | 19.98 | 4 |
| 8 | 0 | 0 | 0 | 20 | 4 |
| Total: | | 1.66 | 1660 | 158.34 | |

### 3.0 Bioassay

The mung bean bioassay was used to evaluate plant growth and rooting stimulation response of three products: Duckweed Biotech Product “D”, Product (1) “K” and Product (2) “M”.

The bioassay was performed as follows:

The seeds of mung bean seeds were rinse thoroughly with water and soak for 7 hr·hr. in DI water. 2. The seeds were planted in microgreen trays for germination process at 26° C. After 8 days, uniform hypocotyl cuttings with 8 cm length with 2 primary leaves and without cotyledon were transferred to the treatment vials. The cuttings are rinsed with DI water and then soak in 20 mL treatment test solutions for 8 hr. The treatment solutions include Duckweed Biotech Product “D”, Product (1) “K”, Product (2) “M”, indole-3-acetic acid (IAA), and indole-3-butyric acid (IBA). The treatments are follows:
IBA & IAA concentrations: 0, 1, 2, 5, 10, 15, 20 and 30 mg/L
Duckweed Biotech Product “D” Conc.: 0, 0.5, 1, 2, 5, 10, 20 and 50%
Product (1) “K” Conc.: 0, 0.5, 1, 2, 5, 10, 20 and 50%
Product (2) “M” Conc.: 0, 0.5, 1, 2, 5, 10, 20 and 50%

3 After the treatments, the seedling base cuttings were rinsed with DI water and transferred to clean vials with glass beads containing 60 mL of DI water for 8 days. Two cuttings were placed in each vial and two vials were used for each treatment. The vials are left at 28±3° C. ambient air temperature and under lighting at 135 μmol photons m⁻² s⁻¹ in a 16-h day/8-h night cycle. The humidity is maintained over 60%.

4. After 8 days, the number of roots per hypocotyl was recorded. The plant quality and stem length were also evaluated. The data collected was organized and analyzed using Microsoft Excel

### 4.0 Results

### 4.1 Plant Growth

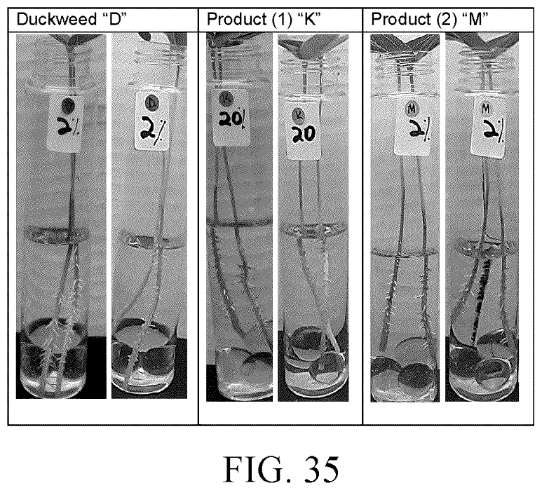

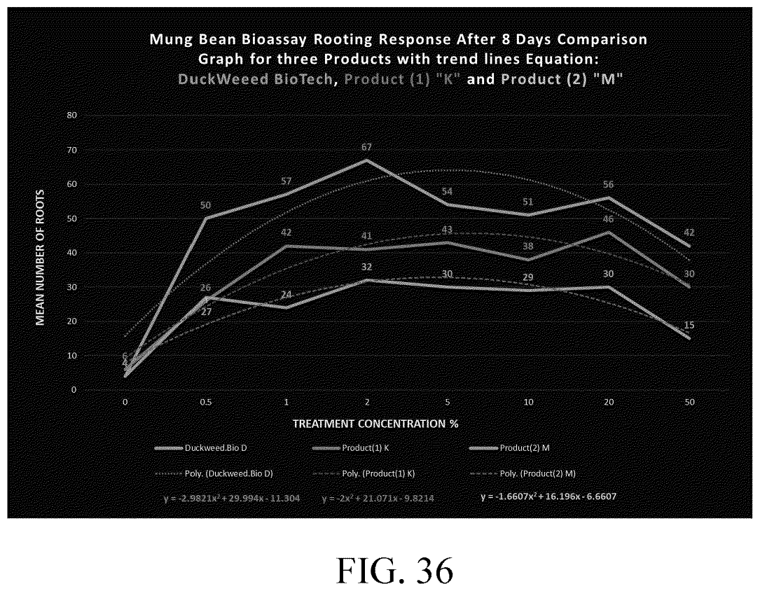

The plant growth and rooting response of each treatment were recorded after 8 days. The rooting response was evaluated based on number of roots developed per cutting. The average number of roots of three cuttings per treatment was used to determine the effectiveness of the treatments. Plant quality and stem length were also recorded. The summary of the results is as follow: The results of this study showed that Duckweed Biotech Product stimulated root growth more efficiently than Product (1) “K” and Product (2) “M” in all treatments. The plants with higher rooting response were found at 2% with duckweed treatment with 67 roots. Whereas Product (1) “K” at 20% dilution stimulated root production with 46 roots and Product (2) “M” at 2% dilution with 32 roots. A decline of rooting stimulation was found at 50% dilution for all evaluated products (FIG. 35 & FIG. 36) that coincides with previous research literature for brown kelp extract products. The control plants showed an average of 4 to 6 roots at the end of the experiment.

FIG. 35 illustrates best rooting response concentrations of the two liquid seaweed products: Product (1) “K” and Maxicop; and the Duckweed Biotech.

Plants treated with Duckweed Biotech treatments had longer roots than Product (1) “K” and Product (2) “M” in all concentrations. (FIG. 35 & FIG. 36)

FIG. 36 illustrates rooting response of stem cuttings in relation to DuckWeed Biotech product “D”, Product (1) “K”, and Product (2) “M” treatments applied after 8 days.

The plants treated with 2% and 5% Duckweed Biotech had a higher stem length of 15 cm, whereas plants treated with 10% Product (1) “K” and 20% Product (2) “M” showed similar stem growth with 14 cm length at the end of the experiment. The stem of the control plants did not show a significant growth.

The plants treated with IAA and IBA had similar stem growth at 1% dilution with 15 cm in length.

### 4.2 IAA and IBA

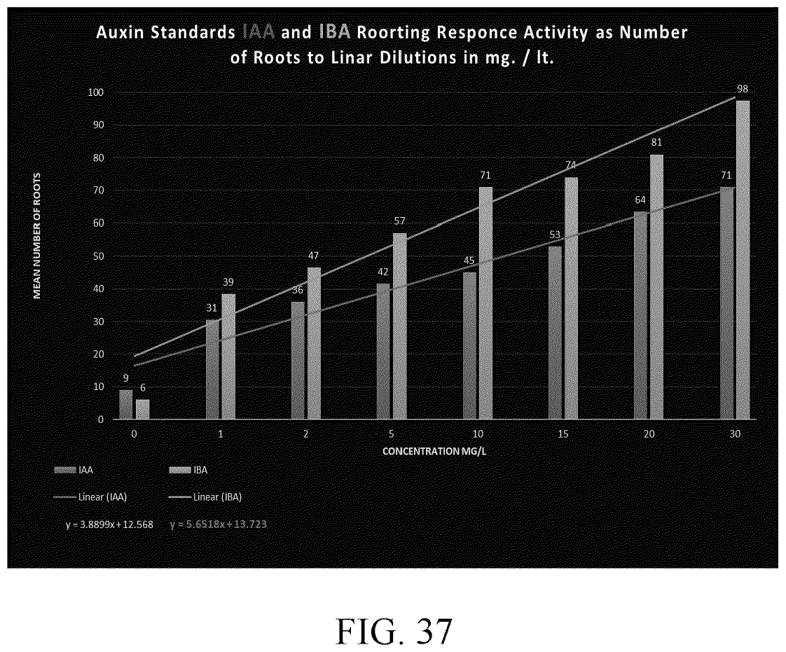

The rooting ability of indole-3-acetic acid (IAA) and indole-3-butyric acid (IBA) was incorporated into the bioassay to establish the rooting response of stem cuttings in relation to these auxins. The results suggest that root formation was a function of the amount of auxin supplied. The higher number of roots developed was found at 30 mg/l of IBA and IAA it showed a linear tendency (FIG. 37). Although IBA stimulated more roots in all concentrated treatments than IAA. The pH of IBA and IAA at 30 mg/L was 6.53 and 6.92 respectively.

FIG. 37 illustrates relationship between root formation and supplied of IAA and IBA accumulated in the hypocotyl cuttings of mung beans.

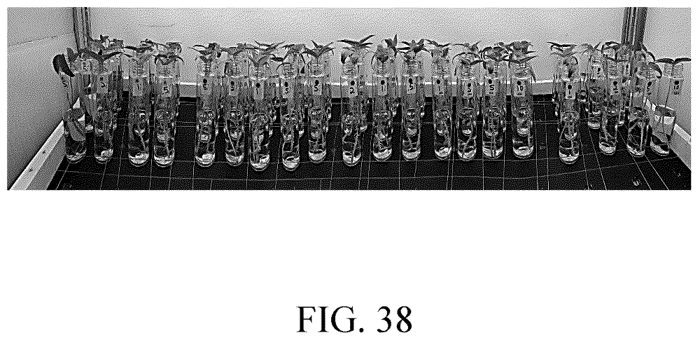

FIG. 38 provides a view of the Mung Bean Bioassay.

### 5.0 Conclusion

A mung bean bioassay was performed to evaluate the effects of Duckweed Biotech, and seaweed products namely Product (1) “K”, and Product (2) “M” on plant growth and rooting response of stem cuttings. The results of this experiment suggest that Duckweed Biotech Product “D” stimulated root growth more than Product (1) “K” and Product (2) “M”. Duckweed Biotech Product “D” showed its maximum rooting response at 2% concentration with 67 roots. Whereas Product (1) “K” revealed an optimum rooting response at 20% concentration with 46 roots which coincides with the literature. In contrast, Product (2) “M” maximum rooting response was observed at 2% concentration with 32 roots.

Duckweed Biotech Product “D” is a combination of three aquatic plants of the Aracea family, which is compared with commercial seaweed products: Product (1) “K” and Product (2) “M”. The dilutions were made from the liquid concentrated products and the Duckweed Biotech Product “D” from a natural concentrate extraction of three duckweed species.

The equivalent phytohormone activity of IAA and IBA was established by the number of roots to the corresponding treatment dilution and interpolating the number of roots to the corresponding hormone concentration to obtain the total activity in mg/L of the commercial product. The comparative results are shown in (Table 4). Duckweed Biotech Product “D” shows comparative activity levels over 1,200 mg/L of IAA and 428 mg/L of IBA demonstrating a 22 times higher effect than Product (1) “K” on IAA and over 45 times higher in IBA when compared to Product (2) “M”. The Duckweed Biotech Product shows 20 times higher activity in IAA and 10 times higher in IBA.

Product (1) “K” shows activity levels of 9.38 mg/L of IBA which is slightly lower than the product information content of 11 mg/L of auxin equivalent activity as used in other literature where IBA was utilized as standard for evaluation of Product (1) “K” and Kelp auxin comparable activity effect on rooting.

TABLE 21
Comparative results and equivalence to root response and its effect over standards of IAA and IBA
then converted into activity in original product reverting the % of dilution in the equation.

| | | Activity | Activity | | | |
|---|---|---|---|---|---|---|
| | | Equivalente to | Equivalente to | | | |
| | Total | Standard Rooting | Standard Rooting | % Dilution of Product | Activity | Activity |
| | Root/Bud Max | effect of IAAmg./ | effect of IBA mg./ | for Max Root | IAA mg./lt. | IBA mg./lt. |
| | Number | lt. | lt. | development response | of Product | of Product |
| Duckweed.Bio “D” | 0 | 24.29 | 8.57 | 2% | 1,214.29 | 428.57 |
| Product (1) “K” | 0 | 10.63 | 1.88 | 20% | 53.13 | 9.38 |
| Product (2) “M” | 0 | 1.20 | 0.79 | 2% | 60.00 | 39.39 |
| | | | Difference in | Duckweed.Bio “D”/Product (2) “K” | 22.86 | 45.71 |
| | | | Activity in Fold | Duckweed.Bio “D”/Product (2) “M” | 20.24 | 10.88 |

This bioassay also suggested that indol-3-butyric acid (IBA) is more effective than indol-3-acetic acid (IAA) in root development. IBA induced the formation of a greater number of roots per cutting than IAA.

### Example 7

1^{st}. Plant Growth and Fruit Set of Sweet Peppers with Different Applications of Vitamin-Hormone or Organic Phytohormone with Natural Biostimulant Activity Concentrated Fertilizer Comparatively the: Duckweed Biotech Product “D” Made of a Blend of Duckweeds Macrophytes of the Araceae Family of Plants Formally Known as Lemnaceae Commonly Known as Duckweed, Water Lentin and Water Meal as Other Hydrophyte Macrophyte Aquatic Plants Blend, and Compared to Two Leading Commercial Natural Extract Bio-Stimulant Products Made Out of Two Different Species Giant Brown Kelp Product (1) “K” Made of Ecklonia Maxima the Southern Hemisphere Giant Brown Kelp Seaweed and Product (2) “M” Made of Ascophyllum Nodosum the Northern Hemisphere Giant Brown Kelp Seaweed; were Used to Evaluate their Effects on Plant Growth and Fruit Set of One Variety of Bell Peppers as Well as their Impact on Potential Permanent Carbon Retention in Crop Plants.

Table of Content

| | |
|---|---|
| Introduction | 78 |
| 2.0 Materials and Methods | 79 |
| 2.1 Product Source and Preparation of Dilutions | 80 |
| 2.2 Study Design | 80 |
| 3.0 Results and Discussion | 83 |
| 3.1 Effects on Plant Growth | 84 |
| 3.2 Plant Biomass | 85 |
| 3.3 Root to Shoot Ratio and Carbon Sequestration | 86 |
| 3.4 Plant Photos | 88 |
| 3.5 Flower and Fruit set | 92 |
| 4.0 Summary and Conclusion | 94 |

### Introduction

Bell peppers is considered a tremendous industry in United States. Florida is a big supplier of vegetables in the USA. Bell peppers, tomatoes, strawberries, and sweet corn are Florida top four ranked vegetables produced in the state. The Florida cultivation and production of bell peppers occurred in both greenhouses and crop fields. There is a heavy demand for growers to provide peppers all year long. As a result, there is a need to look for alternatives in crop productivity even in abiotic stress, high temperatures, and humidity environments.

Bio stimulants are organic compounds with nutrients and vitamins that modify the physiological process of plants. It plays an essential role in many aspects of plant growth and development, root mass, stem elongation, and flower development (Ouzounidou et al., 2008). There are also good intentions to resolve major problems with Peppers flower dropping, poor fruit set and susceptibilities to viral diseases. Researchers have found that bio stimulants and natural growth regulators can be effective in the overall growth performance of plants and help reduce dropping of flowers and peppers counteracting abiotic stress. Another fact to consider is farmers around the world with the necessity to grow more nutritious foods, while using less fuel, less irrigation, and fewer fertilizers. Today, frequent, and longer lasting droughts are the biggest concern of the Agricultural Industry. As a result, some research from universities have been studying and evaluating the effects of bio stimulants on vegetables crops. They had found the beneficial effects on plant growth and development (Wiley et al., 2018). Only few studies on the application of natural organic bio stimulants to pepper plants have been published. Considering the above circumstances, the present study was undertaken to initiate trials with the application of Duckweed Biotech Product “D” that is made of a blend of extracts of Duckweed species that are aquatic plants not algae of the macrophytes or hydrophytes members of the Araceae family of plants formally known as Lemnaceae commonly known as Duckweed, water Lentin and Water Meal as other Hydrophyte Macrophyte Aquatic plants blended extracts, as a organic natural vitamin-biostimulant to evaluate plant performance, growth, fruit set and yield. Also, the performance of commercial leading bio stimulants made out of algae products made out of two different species Giant Brown kelp being Product (1) “K” made of Ecklonia maxima the southern hemisphere giant brown kelp seaweed and Product (2) “M” made of Ascophyllum nodosum the northern hemisphere giant brown kelp seaweed was evaluated in this study. The effectiveness of all three organic natural vitamin bio-stimulants are included in this report as a comparison view of their effects in pepper plants growing in Florida summer under environmental limiting conditions such as high temperatures and moisture which create a challenge for farmers.

### 2.0 Materials and Methods

The trial was carried out during the period from March to August 2022. A total of 84 plants were used for this study. The initial phase of this trial was conducted indoors in a mini greenhouse with a controlled environment with portable shelves and LED lights. When the plants were taller (more than 6 in), the plants were moved to a screened porch and then outdoors during phase two. The materials and equipment used are shown in Table 1.

TABLE 22
List of Materials and Equipment

| Materials | Equipment |
|---|---|
| Bell Pepper seeds: Blitz, (Medium- | Veritas Precision |
| fruited c.) | balance (Max 600 g) |
| Duckweed Biotech Product “D” | Digital Thermometer |
| Product (1) “K” made of | Quantum Light meter- |
| Ecklonia maxima giant | Lightscout |
| Brown Kelp of the | (μmol photons m⁻² s⁻) |
| southern hemisphere | |
| Product (2) “M” made of | pH meter (Hanna |
| Ascophyllum nodosum | pH Combo) |
| giant brown | |
| kelp of the northern | |
| Hemisphere | |
| 9 oz cups | CO2/humidity/Temperature |
| | meter -IAQ50 (Supco) |
| Plant labels and a ruler | Soil pH and Temp meter |
| Plastic Pots | Camera |
| Fertilizer 24-8-16 | Portable shelves |
| Spray bottles | LED lights |
| Distilled water (DI) | Plastic covers |
| Tap water | Computer |
| 10, 50, 100 and 250 ml | |
| graduated cups | |
| Organic soil, vermiculite, | |
| and peat moss | |
| 12 × 16 trays | |
| Clippers | |
| CRF (Osmocote) | |

### 2.1 Products Source and Preparation of Dilutions

The liquid concentrate solution of the three products were diluted with DI water in concentrations of 0, 0.4%, 1%, 2% and 5%. The duckweed dilutions were made from a stock solution (100%-Model Reactor) of Lemna spp. concentrate. The seaweed concentrates Ecklonia maxima Product (1) “K” and Ascophyllum nodosum Product (2) “M” were obtained from commercial products that contains both marine macro algae, more commonly known as Giant Brown Kelp.

### 2.2 Study Design

Seed Germination: Seeds of. sweet bell pepper, Capsicum annuum L were sown in 9 oz plastic clear cups containing 32 g of moist vermiculite. Six seeds were planted per cups and at a planting depth of ¼ inch. Twenty ml of DI water were added to the cups every two days. The seeds were grown under a controlled environment under the same light, water, soil, humidity, and temperature. The temperature recorded was from 77° to 79° F., and the lighting was measured at 135 μmol photons m² s⁻¹ for 12 hr. day. The humidity was around 50 to 56%.

Seedling Growth: Six weeks old seedlings were transplanted into 1.5 L pots. The seedlings substrate was a mixture of 65% organic soil, 25% peat, and 10% vermiculite. The organic soil was obtained from Vigoro Garden soil. The substrate was amended with. ½ tbsp of 15N-9P-12K CRF per pot. The soluble fertilizer was hand applied once a week with 100 mL of 24N-8P-16K. The fertilizer solution was prepared at 2.5 ml/gal. Each pot received approximately 200 mL of tap water every other day. The properties of the substrate were suitable for the growth of pepper seedlings (pH 6.5 to 6.8; and total porosity 75.8%). During the month of June, the plants were growing in a screen enclosure and the temperature fluctuations were found from 84 to 91° F. The plants were maintained in shelves and under lighting at 135 μmol photons m⁻² s⁻¹ for 10 hrs. day. The humidity was recorded from 65 to 87%. During the month of July and August, the plants were moved outdoors where they received irrigation water 3 times a week and 250 ml of tap water when needed. The outdoor temperatures were recorded from 87 to 93° F. The plants received 7 hours of full sun and the humidity was recorded up to 88%.

The following four treatment applications of Duckweed Biotech Product “D”, Product (1) “K” and Product (2) “M” were used in this study. Two replicates per treatment were selected due to the space limitation. The treatment applications were applied every seven days for 4 weeks and thereafter every 14 days for two more weeks. The treatment applications and solutions are shown in Table 2. The four treatments were applied as follows:
Treatment 1—Seedlings received treatment solutions of 1%, 2%, and 5% through soil drench (SD) application method after they were watered with a fertilizer solution. Fifty ml of treatment solution was used per seedling.
Treatment 2—Seedlings received treatment solutions as treatment 1. They also received foliar spray application of 0.4% and 1% of Duckweed biotech, Product (1) “K” and Product (2) “M”. The foliar application was applied to all leaves.
Treatment 3—Seedlings received foliar spray application treatments only of 0.4%, 1%, 2%, and 5% of Duckweed Biotech, Product (1) “K” and Product (2) “M”.
Treatment 4—Controls where only 100 mL of soluble fertilizer was applied to each pot every week.

TABLE 23
Treatment Applications and Solutions.

Four Treatment Applications
Soil Drench (SD)
Soil Drench and Foliar Spray (SD + FS)
Foliar Spray (FS)
Control (fertilizer only)
Description of Treatment Solutions of Duckweed
Biotech (D), Product (1) “K”(K)
and Product (2) “M” (M)
1. 1%, 2%, and 5% SD
1% SD + 0.4% FS
1% SD + 1% FS
2% SD + 0.4% FS
2% SD + 1% FS
5% SD + 0.4% FS
5% SD + 1% FS
Foliar spray only (0.4%, 1%, 2%, and 5%)
Control (0%) (fertilizer only)

After 6 application events of treatments 1, 2, 3, and 4, the fruits were harvested every 7 to 14 days from June 16 to August 15. Fruit weight was determined at harvest. The number of markable fruits was determined as those peppers weighting more than 50 g. The nonmarketable fruits were considered physically damaged or weighted less than 50 g. The plants were harvested, and roots were washed for final measurements. The plant growth evaluation includes plant height, root to shoot ratio, fruit set, plant fresh weights (biomass) and carbon retention estimations. An electronic balance was used for fresh weight (FW) measurements and a ruler was used to measure plant heights. The percentage fruit set was determined as the number of fruits divided by the number of flowers times 100. To be able to evaluate fruit sets, the data was collected over the period in which all fruits and flowers were present.

### 3.0 Results and Discussion

### 3.1 Effects on Plant Growth

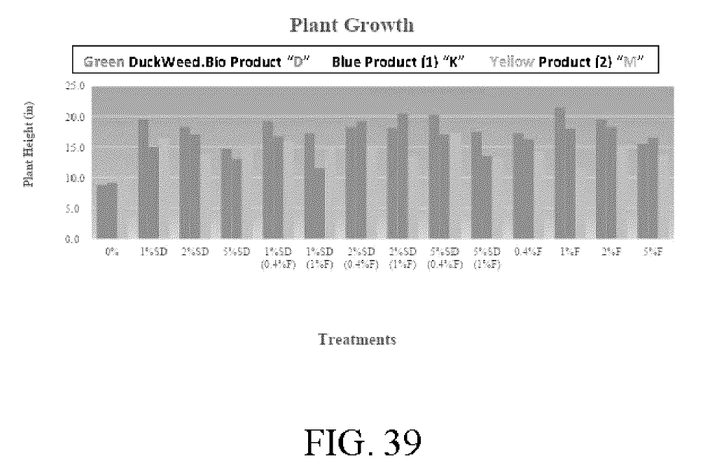

FIG. 39 Illustrates the effect of treatment concentrations in plant height.

The effect of all treatment concentrations on plants height. (FIG. 39) shows effect of treatment concentrations in plant height. The average of two replicates per treatment is included in the graph. All treatments enhanced more vegetative growth as compared with the control treatment. Plant growth was mostly influenced by foliar spray (F) application of 1% concentration of Duckweed Biotech with 21.5 in height. Product (1) “K” applied as 2% SD in combination with 1% foliar spray increased plant shoot length with 20.5 inches. Whereas Product (2) “M” applied as 5% soil drench in combination with 0.4% foliar spray stimulated plant shoot with 17.25 height.

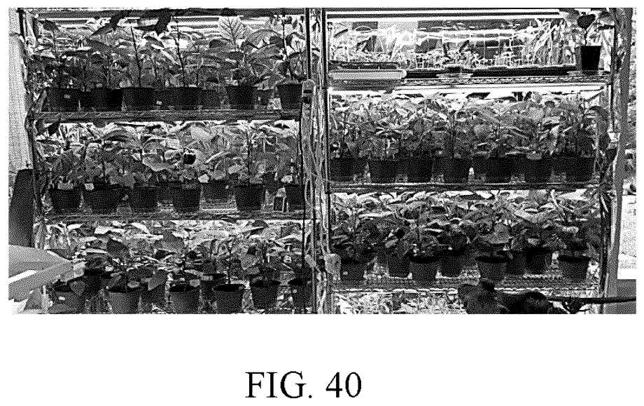

FIG. 40 illustrates bell pepper plants at 4 months.

### 3.2. Plant Biomass

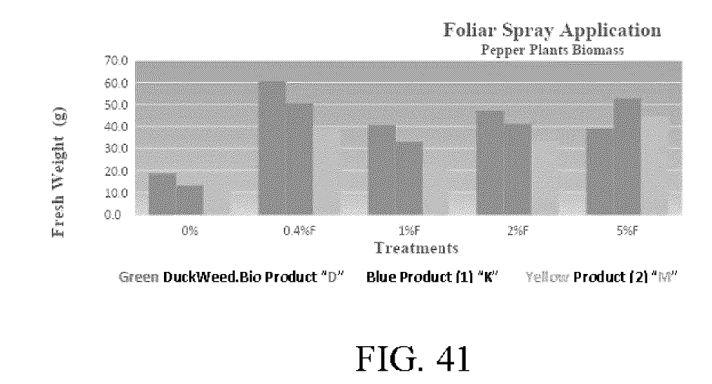

FIG. 41 provides a comparison of products applied as foliar spay on total plant biomass (FW).

Foliar application of Duckweed Biotech greatly increased plant biomass as compared with the other treatments. Plants treated with 0.4% foliar spray (F) of Duckweed Biotech had a higher plant biomass of 60.5 g. Whereas Product (1) “K” and Product (2) “M” enhanced biomass growth at 5% foliar spray with 52.7 g and 44.6 g respectively. The control plants exhibited smaller plant biomass overall.

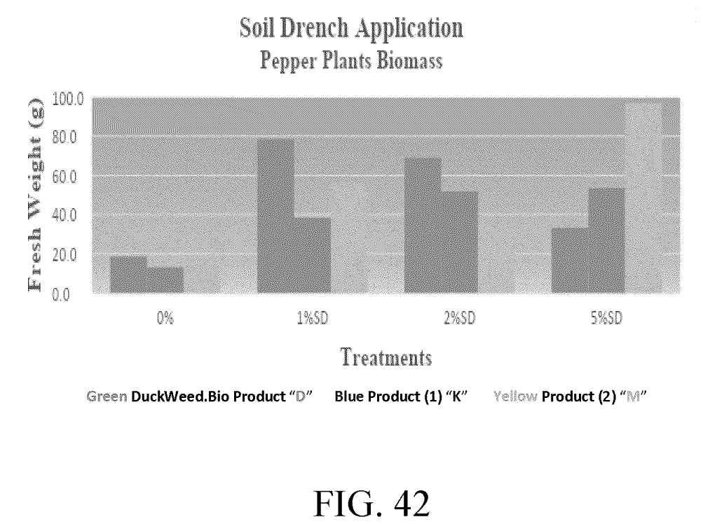

FIG. 42 is a comparison of products applied as soil drench (SD) on plant biomass

All treated plants have a higher plant biomass than the control plants. Product (2) “M” treatment applied as 5% Soil Drench (SD) significantly enhanced total plant biomass as compared to the other treatments. Plants treated with 5% SD Product (2) “M” showed the highest plant fresh weight with 96.9 g. Whereas, Duckweed Biotech applied as a 1% SD increased plant biomass with 78.5 g. Product (1) “K” applied as 5% SD showed a higher biomass with 53.5 g. The reason for this result might be that Product (2) “M” contains a thick gelatinous solution that might infuse longer retention in soil.

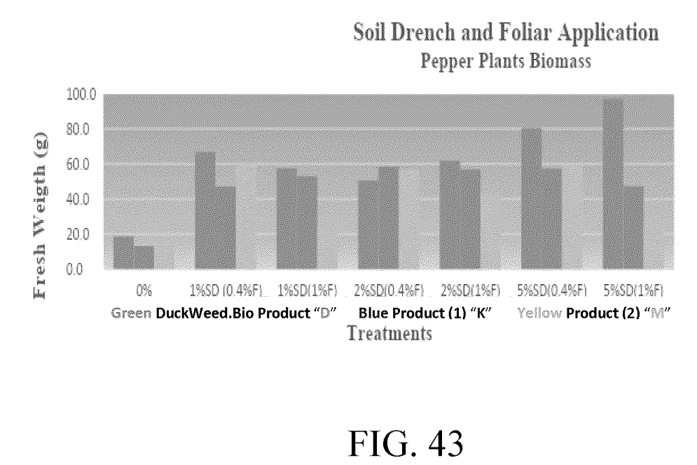

FIG. 43 illustrates effects of various concentrations of the combined treatments: soil drench (SD) and foliar spray on total plant biomass.

The Duckweed Biotech combined treatments of 5% SD plus (1% F) and 5% SD (0.4%) greatly increased plant biomass with a fresh weight of 97 g and 80.5 g respectively. Product (1) “K” applied as 2% SD (0.4% F) enhanced plant mass with a fresh weight of 58.4 g. Whereas Product (2) “M” applied as 1% SD (0.4% F) and as 5% SD (0.4% F) enhanced plant mass with fresh weights of 59.6 g and 59.4 g respectively. Control plants exhibit less fresh weigh as compared to the other treatments. Control plants had the lower plant biomass as compared to the other treatments.

3.3 Root analysis and Carbon Sequestration

The evaluation of root to shoot ratio is important in plant production. The root system has a fundamental role in plant nutrients and water absorption, and stress tolerance. The root to shoot ratio is a very significant plant performance indicator in stress environment conditions, especially at drought conditions. The larger root mass, the more stable performance in plants. In this study, the total plant and root fresh weights were recorded, and the root system was evaluated based on the ratio number per treatment. The higher the root to shoot ratio, the higher treatment performance found on the root system. The average of two replicates per treatment was used for the calculations. The root to shoot ratios are illustrated in Tables 3, 4 and 5.

The estimation of carbon retention was based on 40% carbon content of plant root weights and the ratio of CO2 to C which equals 3.67. Carbon (C) content can range from 35% to 45% in plant dry matter. In this trial, the lower value of 40% was used for the calculations. The following equations were used for the estimation of the carbon retention in roots:

### Determination of Carbon Retention in Root Dry Weight:

Plant roots FW (g)×dry matter residue (10%)×carbon content (40%)

### Determination of CO₂ Retention in Root Dry Weight:

Plant root FW (g)×dry matter Residue® (10%)×carbon content (40%)×3.67

®The calculation of root dry weight was based on the average content of 10% dry plant residue and 90% moisture content. The estimation of carbon retention in plant roots is illustrated in tables 3, 4 and 5.

TABLE 25
Product (1) K made of Ecklonia Maxima data to calculate CO2 capture.

| | Plant Height (in) | Plant FW (g) | Root FW (g) | Shoot FW (g) | Root:Shoot | Carbon Retention | CO2 Retention |
|---|---|---|---|---|---|---|---|
| | Avg. | Avg. | Avg. | Avg. | Ratio | (g) Roots DW | (g) Roots DW |
| Table 3 | | | | | | | |
| Treatments | | | | | | | |
| DuckWeed.Bio D | | | | | | | |
| 0% | 8.75 | 18.65 | 3.8 | 14.85 | 0.256 | 0.15 | 0.56 |
| 1% SD | 19.5 | 78.45 | 37.5 | 40.95 | 0.916 | 1.5 | 5.51 |
| 2% SD | 18.25 | 69 | 35.7 | 33.3 | 1.072 | 1.43 | 5.24 |
| 5% SD | 14.75 | 33.15 | 15 | 18.15 | 0.826 | 0.6 | 2.2 |
| 1% SD (0.4% F) | 19.25 | 66.75 | 31.15 | 35.6 | 0.875 | 1.25 | 4.57 |
| 1% SD(1% F) | 17.25 | 57.6 | 26.85 | 30.75 | 0.873 | 1.07 | 3.94 |
| 2% SD(0.4% F) | 18.25 | 50.5 | 26.55 | 23.95 | 1.109 | 1.06 | 3.9 |
| 2% SD(1% F) | 18.13 | 61.85 | 38.2 | 23.65 | 1.615 | 1.53 | 5.61 |
| 5% SD(0.4% F) | 20.25 | 80.5 | 41.7 | 38.8 | 1.075 | 1.67 | 6.12 |
| 5% SD(1% F) | 17.5 | 97 | 56.5 | 40.5 | 1.395 | 2.26 | 8.29 |
| 0.4% F | 17.25 | 60.5 | 23.5 | 37 | 0.64 | 0.94 | 3.45 |
| 1% F | 21.5 | 40.7 | 12.3 | 16.3 | 0.755 | 0.49 | 1.81 |
| 2% F | 19.5 | 47.2 | 13.8 | 33.4 | 0.413 | 0.55 | 2.03 |
| 5% F | 15.5 | 39.1 | 12.9 | 26.2 | 0.492 | 0.52 | 1.89 |
| Average | 18.22 | 60.18 | 28.59 | 30.66 | 0.93 | 1.14 | 4.20 |
| Table 4 | | | | | | | |
| Treatments | | | | | | | |
| Product(1) K | | | | | | | |
| 0% | 9.1 | 13.15 | 1.8 | 11.35 | 0.159 | 0.07 | 0.26 |
| 1% SD | 15 | 38.3 | 11.8 | 26.5 | 0.445 | 0.47 | 1.73 |
| 2% SD | 17 | 51.8 | 18 | 33.8 | 0.53 | 0.72 | 2.64 |
| 5% SD | 13 | 53.5 | 14.9 | 38.6 | 0.39 | 0.6 | 2.19 |
| 1% SD (0.4% F) | 16.75 | 47.15 | 15.15 | 32 | 0.473 | 0.61 | 2.22 |
| 1% SD(1% F) | 11.5 | 52.85 | 21.15 | 31.7 | 0.667 | 0.85 | 3.1 |
| 2% SD(0.4% F) | 19.25 | 58.4 | 33.05 | 25.35 | 1.304 | 1.32 | 4.85 |
| 2% SD(1% F) | 20.5 | 56.95 | 21.15 | 35.8 | 0.591 | 0.85 | 3.1 |
| 5% SD(0.4% F) | 17 | 57.25 | 27.8 | 29.45 | 0.944 | 1.11 | 4.08 |
| 5% SD(1% F) | 13.5 | 47.4 | 17.1 | 30.3 | 0.564 | 0.68 | 2.51 |
| 0.4% F | 16.25 | 40.3 | 18.05 | 22.25 | 0.811 | 0.72 | 2.65 |
| 1% F | 18 | 33.05 | 8.8 | 24.25 | 0.363 | 0.35 | 1.29 |
| 2% F | 18.25 | 41.2 | 10.65 | 30.55 | 0.349 | 0.43 | 1.56 |
| 5% F | 16.5 | 52.65 | 18.6 | 34.05 | 0.546 | 0.74 | 2.73 |
| Average | 16.35 | 48.52 | 18.17 | 30.35 | 0.61 | 0.73 | 2.67 |

TABLE 26
Product (2) made of Ascophyllum Nodosum data to calculate CO2 capture.

| Table 5 | | | | | | | |
|---|---|---|---|---|---|---|---|
| Treatments | Plant Height (in) | Plant FW (g) | Root FW (g) | Shoot FW (g) | Root: Shoot | Carbon Retention | CO2 Retention |
| Product(2) M | Avg. | Avg. | Avg. | Avg. | Ratio | (g) Roots (DW) | (g) Root DW |
| 0% | 10.05 | 14.3 | 2.5 | 11.8 | 0.212 | 0.1 | 0.37 |
| 1% SD | 16.5 | 56.3 | 24.65 | 31.65 | 0.779 | 0.99 | 3.62 |
| 2% SD | 13.75 | 35.3 | 7.2 | 28.1 | 0.256 | 0.29 | 1.06 |
| 5% SD | 15.25 | 96.9 | 53.5 | 43.4 | 1.233 | 2.14 | 7.85 |
| 1% SD (0.4% F) | 16 | 59.6 | 27.65 | 31.95 | 0.865 | 1.11 | 4.06 |
| 1% SD(1% F) | 14.75 | 23.6 | 4.8 | 18.8 | 0.255 | 0.19 | 0.7 |
| 2% SD(0.4% F) | 14.75 | 56.6 | 28.6 | 28 | 1.021 | 1.14 | 4.2 |
| 2% SD(1% F) | 13.5 | 43.25 | 18.55 | 24.7 | 0.751 | 0.74 | 2.72 |
| 5% SD(0.4% F) | 17.25 | 59.4 | 29.3 | 30.1 | 0.973 | 1.17 | 4.3 |
| 5% SD (1% F) | 13.25 | 22.5 | 9.2 | 13.3 | 0.692 | 0.37 | 1.35 |
| 0.4% F | 14.25 | 38.95 | 11.75 | 27.2 | 0.432 | 0.47 | 1.72 |
| 1% F | 11.5 | 21.75 | 9.05 | 11.8 | 0.713 | 0.36 | 1.33 |
| 2% F | 14.75 | 25.2 | 6.7 | 18.5 | 0.362 | 0.27 | 0.98 |
| 5% F | 13.75 | 44.55 | 13.8 | 21.6 | 0.639 | 0.55 | 2.03 |
| Average | 14.56 | 44.92 | 18.83 | 25.32 | 0.69 | 0.75 | 2.76 |
| | | | | | | Control Average: | 0.40 |

### 3.4. Plant Biomass Photos

Photos were taken right after plant harvest. The soil media was removed and then plant roots were washed with tap water.

### Foliar Spray Applications

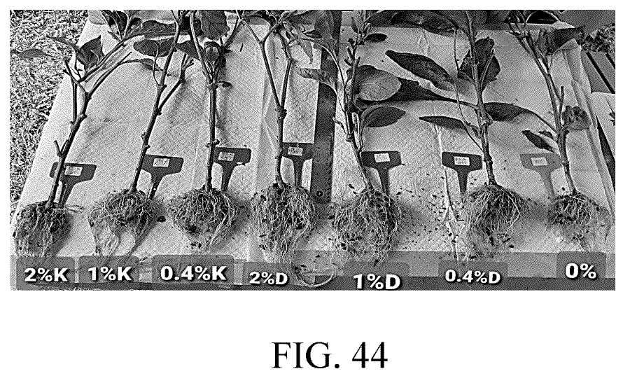

FIG. 44 illustrates Foliar Spray of Duckweed Biotech Product “D” and Product (1) “K”. at different concentrations. The control plants received only tap water. The photo shows only one sample per treatment.

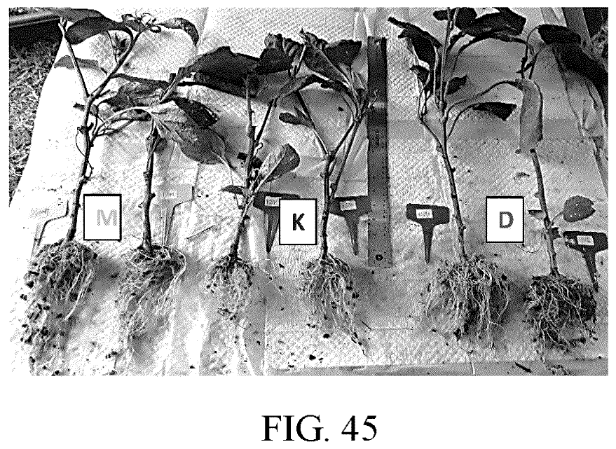

FIG. 45 illustrates FS 5%: D-Duckweed Biotech Product “D”, K-Product (1) “K”, M-Product (2) “M”.

### Soil Drench Applications

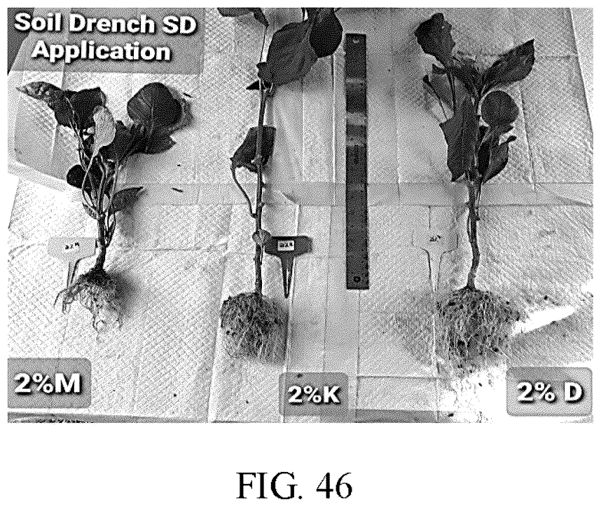

FIG. 46 illustrates SD-1% Application. This photo shows two replicates per treatment.

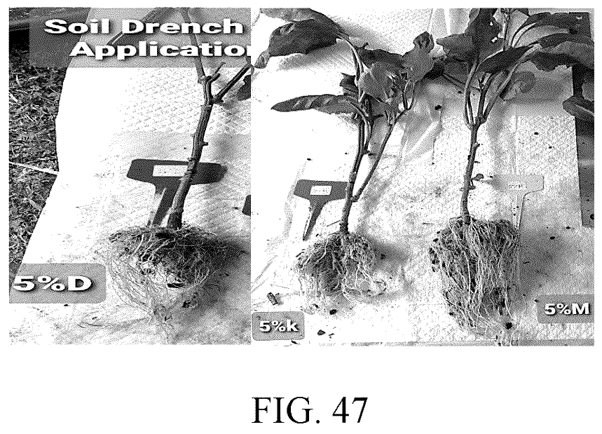

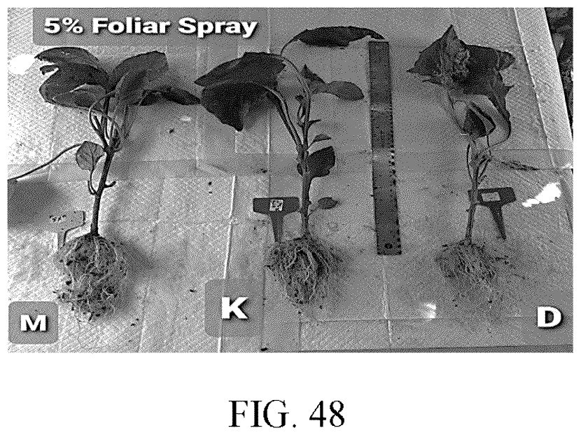

FIG. 47 illustrates soil drench (SD)-2% Application. FIG. 48 illustrates soil drench (SD)-5%.

### Combined Treatments of Soil Drench and Foliar Spray

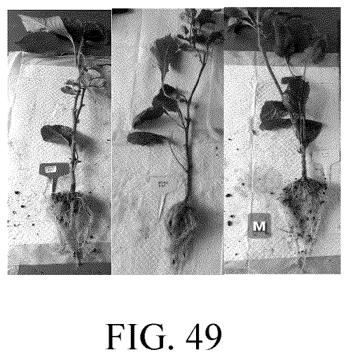

FIG. 49 illustrates SD-1% plus 0.4% FS and

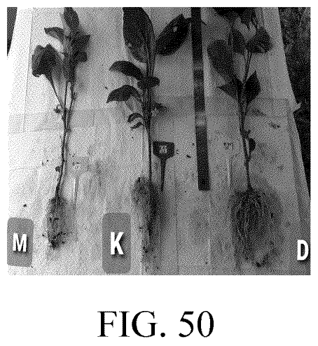

FIG. 50 SD-1% plus 1% FS

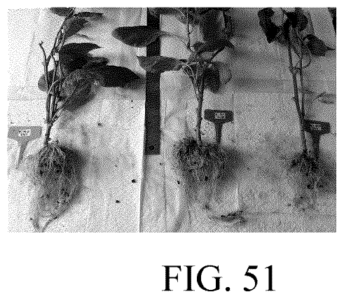

FIG. 51 illustrates SD-2% plus 0.4% FS and

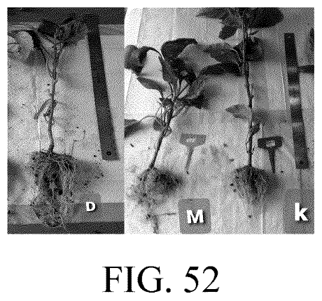

FIG. 52 illustrates SD-2% plus 1% FS

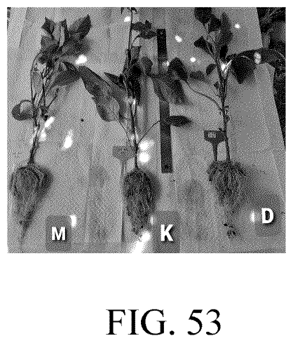

FIG. 53. Illustrates SD-5% plus 0.4% FS and

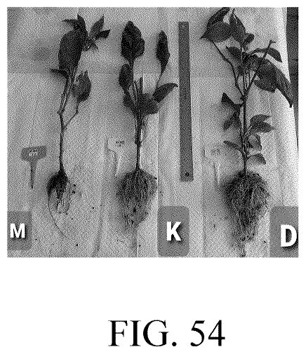

FIG. 54. SD-5% plus 1% FS

### 3.5 Flower and Fruit Set

In this study, fruit set characterization was evaluated, and the percentage of fruit set was determined when the flowers and young fruits were present. The percentage fruit set was determined as the number of fruits divided by the number of flowers times 100. The average of two replicates was used for the fruit set calculations. The Table 4 includes the fruit set yield estimations.

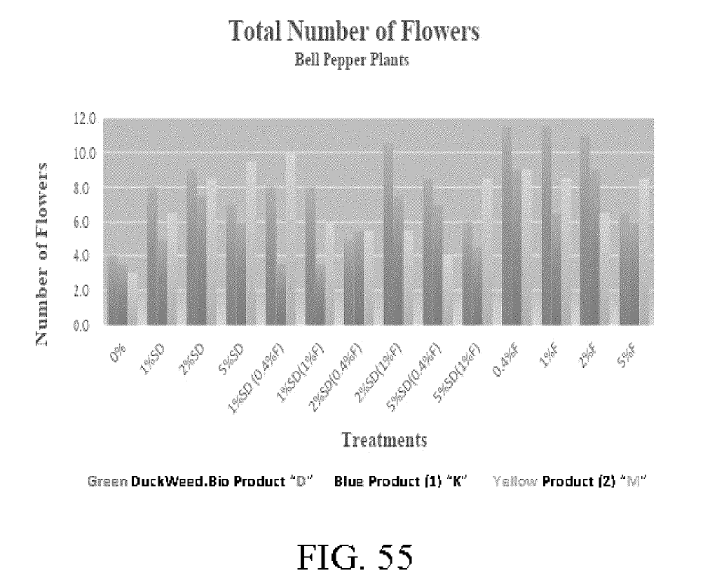

FIG. 55 illustrates number of flowers produced in Bell peppers.

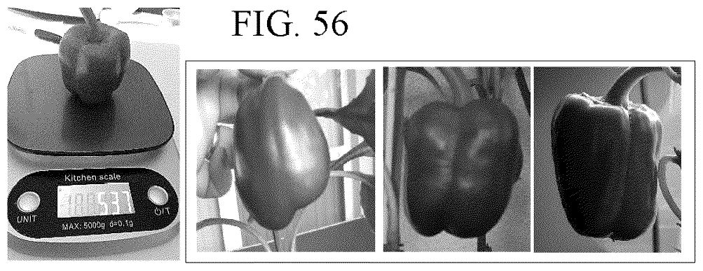

FIG. 56 illustrates harvested peppers and weight.

Duckweed Biotech Product “D” exhibited a higher flower production as compared to Product (1) “K” and Product (2) “M”. The Application of Duckweed Biotech Product “D” increased the number of flowers with foliar spray applications of 0.4%, 1%, and 2% solution and with the combined treatment of 2% SD (1% F). Whereas Product (1) “K” increased flower production but not significantly at 0.4% and 2% foliar spray applications and Product (2) “M” enhanced flower numbers from the combined treatment of 1% SD (0.4% F) (FIG. 56).

TABLE 27
Fruit set estimations

| | Treatments | | | | | | | | |
|---|---|---|---|---|---|---|---|---|---|
| Treatment | Duckweed Biotech “D” | | | Product (1) “K” | | | Product (2) “M” | | |
| type/ | Fruit # | Flower # | Fruit | Fruit # | Flower # | Fruit | Fruit # | Flower # | Fruit |
| concentration | (Avg.) | (Avg.) | Set | (Avg.) | (Avg.) | Set | (Avg.) | (Avg.) | Set |
| 0% | 1 | 4 | 25.00 | 1 | 3.5 | 28.57 | 1 | 3 | 33.33 |
| 1% SD | 5 | 8 | 62.50 | 2 | 5 | 40.00 | 2.5 | 6.5 | 38.46 |
| 2% SD | 3 | 9 | 33.33 | 4.4 | 7.5 | 58.67 | 3.5 | 8.5 | 41.18 |
| 5% SD | 4 | 7 | 57.14 | 1 | 6 | 16.67 | 6 | 9.5 | 63.16 |
| 1% SD | 4.5 | 8 | 56.25 | 1.5 | 3.5 | 42.86 | 4.5 | 10 | 45.00 |
| (0.4% F) | | | | | | | | | |
| 1% SD(1% F) | 3 | 8 | 37.50 | 0.5 | 3.5 | 14.29 | 3 | 6 | 50.00 |
| 2% SD | 3 | 5 | 60.00 | 3.5 | 5.5 | 63.64 | 2 | 5.5 | 36.36 |
| (0.4% F) | | | | | | | | | |
| 2% SD(1% F) | 5 | 10.5 | 47.62 | 2.5 | 7.5 | 33.33 | 2.5 | 5.5 | 45.45 |
| 5% SD | 4 | 8.5 | 47.06 | 1.5 | 7 | 21.43 | 1.5 | 4 | 37.50 |
| (0.4% F) | | | | | | | | | |
| 5% SD(1% F) | 3.5 | 6 | 58.33 | 1.5 | 4.5 | 33.33 | 5.5 | 8.5 | 64.71 |
| 0.4% F | 6 | 11.5 | 52.17 | 3.5 | 9 | 38.89 | 4 | 9 | 44.44 |
| 1% F | 8 | 11.5 | 69.57 | 3.5 | 6.5 | 53.85 | 5 | 8.5 | 58.82 |
| 2% F | 4.5 | 11 | 40.91 | 6 | 9 | 66.67 | 3.5 | 6.5 | 53.85 |
| 5% F | 3.5 | 6.5 | 53.85 | 3 | 6 | 50.00 | 4 | 8.5 | 47.06 |

Fruit set percentages differed between the products (Table 27). The highest Fruit sets obtained from of Duckweed Biotech Product “D” applications were from 1% foliar spray, 1% soil drench, and 2% SD (0.4% F) with 69.57%, 62.5% and 60% respectively. The application of Product (1) “K” applied as 2% foliar sprays had the higher fruit set of 66.67% followed by the combined treatment of 2% SD (0.4% F) with 63.64%, and 2% soil drench with 58.67%. Product (2) “M” application of the combined treatment of 5% SD (1% F) had the higher fruit set with 64.71%, follow by 5% SD with 63.16% and 1% foliar spray with 58.82%.

### Fruit Yield

The number of harvested fruits differed between the treatments. The plants treated with Duckweed.Biotech Product “D” performed better than the other plants treated with Product (1) “K” and Product (2) “M”. The markable fruits were considered more than 50 g. The average marketable fruit weight of 53.5 g was obtained from the Duckweed Biotech treated plants as compared to Product (1) “K” and Product (2) “M” treated plants with an average unmarketable fruit weight of 42.5 g and 40 g respectively. FIG. 56 illustrates peppers harvested, pictures taken in plant and weighing fruit.

### 4. Summary and Conclusions

The present trial was planned to examine the effects of Duckweed.Biotech Product “D” on plant growth, fruit set and yield in Blitz sweet peppers. Four concentrations of 0.4%, 1%, 2% and 5% were applied in three different types of applications: as soil drench, as a combined treatment of SD plus foliar spray and as a foliar spray only. Two commercial products (Product (1) “K” and Product (2) “M”) were included to evaluate their effects and compare results with our product.

### Duckweed Biotech Product “D”

Duckweed Biotech Product “D” performed better to plant growth because it had less fruit drops and more retention of flowers as compared to the plants treated with the other products. Yield attributes were also enhanced due to the increase in fruit set percent. Fruit set is strongly correlated to fruit yield in Blitz sweet peppers. Blitz peppers are considered a medium-fruited-cultivar. The plants with the higher fruit set were found in Duckweed Biotech treated plants overall.

The Duckweed Biotech Product “D” at 1% foliar spray applications proved to be the most effective on plant shoot growth and fruit set. Duckweed Biotech Product “D” applied as a combined treatment of 5% SD (1% F) increased total biomass (97 g—FW) over all treatments. Also, foliar applications of 0.4%, 1% and 2% of Duckweed Biotech increased more biomass as compared to foliar applications of Product (1) “K” and Product (2) “M” treated plants. Plants treated with 2% SD plus 0.4% F had the first flowers.

### Product (1) “K” and Product (2) “M”

Product (1) “K” applied as a combined treatments of 2% SD (1%) and 2% SD (0.4%) enhanced more plant growth and biomass (58.4 g—FW) and when applied as foliar spray at 2% increased fruit set percent. Whereas Product (2) “M” applied as soil drench at 5% enhanced greatly plant biomass (96.9 g FW) and when combined treatments were used at 5% SD (0.4%) and 5% SD (1% F), both increased plant growth and fruit set respectively.

Overall, all treated plants had higher plant height, greater biomass and fruit set as compared to control plants.

### Root and Shoot Ratio

The higher the root to shoot (R:S) ratio, the higher treatment performance is found on the root system. Duckweed Biotech Product “D” provided a higher R:S ratio with 1.615 from the combined treatment of 2% SD (1% F). Whereas Product (1) “K” provided a high R:S ratio of 1.304 when applied as 2% SD (0.4% F) and Product (2) “M” exhibited a high R:S ratio of 1.233 with the 5% SD treatment. The control plants exhibited a lower R:S ratio overall.

### Carbon Sequestration

The optimum carbon sequestration varied between products. Duckweed Biotech Product “D” retained the highest average carbon and CO2 content as compared to Product (1) “K”, Product (2) “M” and the control, comparatively with the other Duckweed Biotech Product. Duckweed Biotech exhibited a carbon amount of 2.26 g and CO2 retention of 8.29 g in dry weights with the treatment of 5% SD (1% F). The Product (1) “K” treatment of 2% SD (0.4%) exhibited a carbon content of 1.32 g and a CO2 retention of 4.85 g in dry weights. Whereas Product (2) “M” showed a carbon content of 2.14 g and a CO2 retention of 7.85 dry weights at 5% SD treatment. The results indicate that plants treated with Duckweed Biotech Product “D” enhanced more carbon storage in plant tissues as compared to the other products and the control; the total CO2 greenhouse gas permanent retention was 4.2 g/DM roots and impossibly 10-fold (1,000%) time the amount retained by the average control groups of 0.40 gr./DW root retention. The average retention of CO2 in Product (2) “M” retained was 2.72 g./DM root and Product (1) “K” retained 2.67 g./DM root giving a comparison to the Duckweed Biotech Product “D” that retained CO2 at 4.2 g./DM root giving a substantial retention improvement over the other 2 products of 50% in average. The application of Duckweed Biotech Product “D” also increased plant biomass, nutrient, and water holding capacity of the soil media. As a result, crops might have a better response during drought and high temperature environments with Duckweed Biotech Product “D” applications.

Recommendations. The number of fertilizer applications commonly applied in vegetable production can be minimized if bio stimulants are used at the right time, and concentration rate. The ideal nutrient soil management is to decrease nutrient leachates and meet crop requirements. It is recommended to do more research with Duckweed Biotech Product and the results of this trial can be used for future trials.

In an embodiment, a method is provided for Biologically Stimulating the growth of and/or regulate enhancing performance plant for agricultural and non-agricultural purposes crop plants and non-crop plants like ornamental plants, industrial material plants, energy biomass production plants, pharmaceutical interest plants, spices, algae, kelp, etc. And beneficial productivity use in aquaculture as hydroponic systems, etc. comprising applying to the plants a DuckWeed.Bio Concentrated Products depending on the target crop customized formulation product and products having an a Auxin IAA or IBA or a combination comprised of Auxins to Cytokinins by biological activity measurement approximate concentration ratio of at least 10:1 to 30:1 and up to 100:1 to 500:1 but not limited to as synergistically can reach much higher levels of ration beyond 1000:1 depending on the compounding formulation mixes of Aquatic Plants and or its extracts based on the desired composition of the products and target plants or crops require comprising also other phytohormone groups or classes of plant hormones that can act in combination as synergically with Auxins and Cytokinins

The Auxins to Cytokinins ratio of the seaweed extract is at least 10:1 to 30:1.

The Auxins to Cytokinins ratio of the seaweed extract is approximately 30:1.

The Auxins to Cytokinins concentration activity ratio of the DuckWeed.Bio Concentrated Products is approximately 100:1 and up to 500:1 and can be higher depending on the compounding formulation extraction concentration of aquatic plants including ratio level above than 1000:1 but not limited.

The DuckWeed.Bio Concentrated natural organic biostimulant products with a composition comprised of highly bioavailable extracts or formulated aquatic plant extracts comprised of valuable plant components, nutrients, natural biochemicals, phytochemicals extracts, micronutrients, phytochemicals, phytohormones, polyphenols, terpenoids, phenols, tocopherols, terpinols, astaxanthins, xanthophylls carotenoid-astaxantines, carotenoids, vitamins, proteins, peptides, amino acids, nucleic acids, natural pigments, chlorophyl carbohydrates, starches, waxes, gums, lipids, fibers, and other valuable natural plant components as bioactive Phytohormones these natural plant hormones are grouped into several classes by its biochemistry as activity and natural composition comprised but not limited to: Auxins (IAA/IBA), Cytokinins (CKs), Abscisic Acid (ABA), Gibberellins (GAS), Ethylene, Jasmonic Acid (JA), Aalicylic Acid (SA), Brassinosteroids (BRs), and Strigolactones (SLs) but not limited to this classes or groups; each class contains multiple individual phytohormones or its bioactive precursors that continue to be discovered, can be obtained on a method comprised of compounded formulated selection based on its composition on single or combination of aquatic plants comprised mainly of Araceae Family (formally known as Lemanaceae family of plants) composed of 5 genera Lemna sp., Spirodella sp., Landoltia sp., Wolffia sp. Wolffiella sp. That contains over 38 species and natural variant clones or varieties with the additional compounding formulation of one or more species of the best available non-GMO hydrophytes or vascular macrophytes aquatic plants; the vascular macrophytes (Pteridophyte and Spermatophyte), which are represented by 33 orders and 88 families with about 2,614 species includes 412 genera; these includes 2,614 aquatic species of Pteridophyta and Spermatophyta that evolved from land plants and represent only a small fraction (*1%) of the total number of vascular plants but not limited as it can also include algae of different species micro or macro algae or kelp as well then all the selection customized formula is compounded and formulated into the product to improve composition and positive biological natural stimulation of growth and yield of crop plants, ornamental plants, etc.

The method further comprises a controlled hydroponic photobioreactor raceway system producing sustainable low-cost aquatic plants raw materials material for the extraction process; the system produces large volumes of standardized material of high quality and high content composition then the aquatic plant raw material is processed by continuous flow inline organic mechanical hi-sheering ultrasound cavitation cold process that cell burst efficiently the aquatic plants and extracts the valuable plant components, nutrients, phytochemicals, phytohormones, polyphenols, terpenoids, vitamins, proteins, amino acids, carbohydrates, and other valuable natural plant components; The process is non-chemical, non-hydrolysis, and does not use fermentation, chemical or enzymatic or caustic extraction methods that damage the quality and activity of the valuable composition components as it does not use extreme cold, extreme heat, microwave, or any other method that damages the molecule structure of the plant phytochemicals or renders them not absorbable or bioavailable with high Biological Activity.

A mechanical extraction system is further provided wherein aquatic plant raw material of one or multiple aquatic plants may be processed to maximize cell rupture and reduce damage to key natural phytochemicals and nutrients compound that may maximize bioavailability and its activity; This process may takes place in an organic enhanced oxygen O3 ozone sterilization cold mediated sheering ultrasound cavitation continuous high flow system that monitored inline to ensure its compliant with regulatory microbiological standards for such organic products and that is within desired standards for such content, then blended and stabilized with organic approved products to ensure shelf-life and colloidal suspension stability and effectiveness over time; It is then packed in an enclosed air/oxygen displacement by nitrogen packing system; this may prevent oxygen-mediated reduction of shelf life and any contamination of the product or products, it is then stored at room temperature.

The Aquatic Plant extract or extracts combined with Duckweed Bio product extract is applied at a rate from about 0.01 lt./ha (liters per hectare) to about 2.5 L/ha depending on the plant species or crop the dossing or concentration range can be adjusted, depending on the customizable formulation the application guide can be adjusted and due to the environmental conditions, climate, soil condition, management, crop system and fertilization systems, etc.; In addition to the desired performance regulation and bio-stimulation management practices to obtain the desired results.

The crop plants exhibit improved plant stand and root length as number of roots, total root biomass and surface.

The crop plants exhibit an improved nitrogen balance index as well for the other nutrients and carbon retention that can go from 0.5 to 5.0 fold times but not limited.

Systems and methods provided herein utilize a new composition comprising a synergistically activity effective amount of a family of aquatic plants Duckweed (Araceae Family of Plants previously known as Lemnaceae composed of several species and natural non-GMO Clones or varieties) and other aquatic plants concentrated extracts having an approximate Auxins to Cytokinins ration of at least 10:1 and up to 500:1 and higher as beneficial content comprising of other phytohormones interacting in a positive synergistic effect; for regulating and enhancing synergically the growth of and/or increasing, health, tolerance to stress and crop yields plus improving by reduction the usage or need of traditional fertilizers by crop-plants and non-crop plants helping improving environmental conditions like global warming by reducing contamination and also reducing Greenhouse Gases like CO2 by fixating it to the aquatic plants like Duckweeds that contain 40 to 45% of carbon and the domino effect of increasing the root mass of the target plants of interest that can be crop and non-crop plants that contain 35% to 45% carbon content on dry matter of roots by means of fixating it permanently to the soil thus helping prevent greenhouse gases.

Systems and methods further provide for production of concentrated organic bio-stimulant fertilizer is based on a highly efficient organic physical direct cold sheering cavitation process without residues or byproducts that extracts controllable quantity and quality of specialty natural plant phytochemicals, phytohormones, amino acids and other beneficial natural plant components without damaging its natural biological activity maximizing its positive effect on plants; these substances promote chlorophyll content improving photosynthesis, plant growth, root size, root biomass root surface and number of roots resulting on increases nutrient absorption capacity and potentially minimizes the overall impact of traditional fertilizers resulting in a reduction of environmental contamination of the soil and water; it will also address food security and safety challenges by increasing agriculture yield, without increasing the need of more arable land and water resources.

Systems and methods provided herein further comprise of application based on all the previous claims 1-12 comprised of farmers may use the non-GMO concentrated organic bio-stimulant fertilizer provided as either liquid foliar application, dipping seedling application, dry pelleted soil mending application, seed coating, wet or dry formulations and combinations with other agricultural chemicals or fertilizers organic or inorganic. The utilization or application dossing will be based on the concentration activity of the natural vitamin-phytohormones ratios of auxins and cytokines customization levels on Duckweed.Bio products to adapt them to plants as other agricultural applications; Farmers will use a base application guide with recommended dilution and amount to be used by acre or hectare; the Farmers will use 0.1% to 1% to 5% to 10% increments variation to determine the best performance results range so Farmers will customize the application adapting the application to specific growth systems, farm management systems, specific plant varieties, seasonality, location, soil type and characteristics microclimate, variable environmental condition, base plant nutrition system and water quality as composition and watering systems; the product and its use will be customized to each individual farm crop and particular conditions and farming methods resulting in improve yields and reduce unnecessary waste and environmental contamination.

The method based on all previous claims to utilize the present invention for other uses or application comprised of systems and methods provided wherein may include aquaculture of fin fish, crustaceans, and mollusks; further, systems and methods may be used in plankton, algae and microalgae production such as kelp that may be used to organically fertilize the ponds, growth systems, open reactors, closed reactors, vertical farms, produce vertical farms, micropropagation, and plant tissue culture; also into the future, in space travel food production may rely on systems and methods provided herein for crop based on aquaculture in a no gravity environment; also, and not limited to application and utility in the nutrition as ingredients for feeding of insect farms for production animal and human food and feed proteins and other nutrients like oils and fivers and components for pharmaceuticals, cosmetics; this can also include but not limited to ingredients and nutrients in animal feeds and human foods ingredients and nutrients.

Systems and methods may be used to produce comprised of but not limited to bio-agriculture phytochemicals concentrated based on the composition of the aquatic plants, the systems and methods provided herein may be used to selectively separate and concentrate the phytochemicals based on their molecular weight to create other fertilizer specialties like Amino acid fertilizer, organic natural phytohormones, natural plant pigments (for natural coloring in food, beverage, and pharma), carotenoids, chlorophylls, xanthine's, as taxanthins of derived terpenoids, and beneficial natural occurring polyphenols that may potentially be beneficial to animals and humans; Products yielded based on systems and methods provided herein may also be potentially used as sources of natural biodegradable polymers for industrial purposes and sources of energy and can be use in production of pharmaceuticals, natural medicine, homeopathic medicine, and cosmetics.

The method described in this invention based on all its previous claims and forth coming claims for the ‘improvement in plant vigor’ strength improvements comprised that certain traits are improved qualitatively or quantitatively when compared with the same trait in a control plant which has been grown under the same conditions in the absence of the method of the invention; such traits include, but are not limited to, early and/or improved germination, improved emergence, the ability to use less seeds, increased root growth in number and in length that sums as a significant increase in absorption surface area and a more developed root system, increased root nodulation, increased shoot growth, increased tillering, stronger tillers, more productive tillers, increased or improved plant stand, less plant verse (lodging), an increase and/or improvement in plant height, an increase in plant weight (fresh or dry), bigger leaf blades, greener leaf color, increased pigment content, increased chlorophyll content, increased photo synthetic activity, earlier flowering, increased flower number, longer panicles, early grain maturity, increased seed, fruit or pod size, increased pod or ear number, increased seed number per pod or ear, increased seed mass, enhanced seed filling, less dead basal leaves, delay of senescence, improved vitality of the plant, increased levels in plant tissue beneficial of nutrients for food and feed value and molecular composition that includes but is not limited to lipids, fatty acids, carbohydrates, vitamins, amino acids, etc.; in storage tissues; and/or less inputs needed (e.g. less fertilizer, less water, less use of additives organic or chemical and/or less labor needed resulting in less costs); a plant with improved vigor may have an increase in any of the aforementioned traits or any combination or two or more of the aforementioned traits.

The method further provides an ‘improvement in plant quality’ comprises that certain traits are improved qualitatively or quantitatively when compared with the same trait in a control plant which has been grown under the same conditions in the absence of the method of the invention; such traits comprised but are not limited to, improved visual appearance of the plant, reduced ethylene (reduced production and/or inhibition of reception), improved quality of harvested material, e.g. seeds, fruits, leaves, vegetables (such improved quality may manifest as improved visual appearance of the harvested material), improved nutritional composition and improved value as food for human and feed for animals and as an ingredient in other applications like pharma and beauty products or industrial applications; also improve composition of carbohydrate content (e.g. increased quantities of sugar and/or starch, improved sugar acid ratio, reduction of reducing sugars, increased rate of development of sugar), improved protein content, improved oil content and composition, improved nutritional value, reduction in anti-nutritional compounds, improved organoleptic properties (e.g. improved taste, smell/aroma an visual appeal) and/or improved consumer health benefits (e.g. increased levels of vitamins and anti-oxidants)), improved post-harvest characteristics (e.g. enhanced shelf-life and/or storage stability, easier processability, easier extraction of compounds), more homogenous crop development (e.g. synchronized germination, flowering and/or fruiting of plants), and/or improved seed quality (e.g. for use in following seasons); therefore a plant with improved quality may have an increase in any of the traits or any combination or two or more of the aforementioned traits.

A method according to the present invention previous claims, an ‘improved tolerance to stress factors’ comprises certain traits are improved qualitatively or quantitatively when compared with the same trait in a control plant which has been grown under the same conditions in the absence of the method of the invention. Such traits include, but are not limited to, an increased tolerance and/or resistance to abiotic stress factors which cause sub-optimal growing conditions such as drought (e.g. any stress which leads to a lack of water content in plants, a lack of water uptake potential or a reduction in the water supply to plants), cold exposure, heat exposure, osmotic stress, UV stress, flooding, increased salinity (e.g. in the soil), increased mineral exposure, ozone exposure, high light exposure and/or limited availability of nutrients or it's imbalance (e.g. nitrogen and/or phosphorus nutrients and/or potassium nutrients and/or micro-nutrients); a plant with improved tolerance to stress factors may have an increase in any of the aforementioned traits or any combination or two or more of the aforementioned traits; like in the case of drought and nutrient stress, such improved tolerances may be due to, for example, more efficient uptake, use or retention of water and nutrients. This possibly increases the strength or vigor of the plants and/or crops also potentially reducing the impact of secondary Biotic Stress (e.g., pathogens examples as virus, bacteria, fungi, yeasts, etc., and parasites insects, arachnids, slugs, worms, etc.); so, a plant with improved quality may have an increase in any of the aforementioned traits or any combination or two or more of the aforementioned traits.

A method according to the present invention previous claims, an ‘improved input use efficiency’ means that the plants are able to grow more effectively using given levels of inputs compared to the grown of control plants which are grown under the same conditions in the absence of the method of the invention; in particular, the inputs include, but are not limited to fertilizer (such as nitrogen, phosphorous, potassium, micronutrients, etc., organic or inorganic or specialty), light and water; so a plant with improved input use efficiency may have an improved use of any of the aforementioned inputs or any combination of two or more of the aforementioned inputs resulting in significant reduction of contamination of the environment by reduction of fertilizer usage, reduction of nutrient lixiviation, reduction of surface water runoffs, reduction of waterbed contamination, reduction of the air and atmosphere as improved soil by reduction of salinification or accumulation of excessive imbalance of fertilizer nutrients in solid or substrates.

Patent Citations

| Number | Priority | Publication |
|---|---|---|
| US20150011392A1 | 2012 Feb. 13 | 2015 Jan. 8 |
| CN1198509C | 1999 Apr. 1 | 2005 Apr. 27 |
| US9314031B2 | 2012 Feb. 13 | 2016 Apr. 19 |
| WO2011101434A1 | 2010 Feb. 19 | 2011 Aug. 25 |
| JP7111436B2 | 2017 Jul. 15 | 2022 Aug. 2 |
| EP3202907A1 | 2014 Aug. 6 | 2017 Aug. 9 |
| BRPI1107211A2 | 2011 Dec. 26 | 2018 Mar. 13 |
| US9894856B2 | 2009 Apr. 20 | 2012 May 17 |
| US9765112B2 | 2010 Mar. 17 | 2014 Aug. 7 |
| AU2015255285B2 | 2010 Mar. 17 | 2015 Dec. 3 |
| US11229171B2 | 2009 Apr. 20 | 2020 Jan. 2 |

What is claimed is:

1. A method for biologically stimulating growth of and/or regulate enhancing performance plant for agricultural and non-agricultural purposes crop plants and non-crop plants like ornamental plants, industrial material plants, energy biomass production plants, pharmaceutical interest plants, spices, algae, kelp, etc. And beneficial productivity use in aquaculture as hydroponic systems, etc. comprising applying to the plants a DuckWeed.Bio Concentrated Products depending on the target crop customized formulation product and products having an a Auxin IAA or IBA or a combination comprised of Auxins to Cytokinins by biological activity measurement approximate concentration ratio of at least 10:1 to 30:1 and up to 100:1 to 500:1 but not limited to as synergistically can reach much higher levels of ration beyond 1000:1 depending on the compounding formulation mixes of Aquatic Plants and or its extracts based on the desired composition of the products and target plants or crops require comprising also other phytohormone groups or classes of plant hormones that can act in combination as synergically with Auxins and Cytokinins

2. A method according to claim 1, wherein the Auxins to Cytokinins ratio of the seaweed extract is at least 10:1 to 30:1.

3. A method according to claim 2, wherein the Auxins to Cytokinins ratio of the seaweed extract is approximately 30:1.

4. A method according to claim 3, wherein the Auxins to Cytokinins concentration activity ratio of the DuckWeed.Bio Concentrated Products is approximately 100:1 and up to 500:1 and can be higher depending on the compounding formulation extraction concentration of aquatic plants including ratio level above than 1000:1 but not limited.

5. A method according to previous claims 1 to 4, wherein the DuckWeed.Bio Concentrated natural organic biostimulant products with a composition comprised of highly bioavailable extracts or formulated aquatic plant extracts comprised of valuable plant components, nutrients, natural biochemicals, phytochemicals extracts, micronutrients, phytochemicals, phytohormones, polyphenols, terpenoids, phenols, tocopherols, terpinols, astaxanthins, xanthophylls carotenoid-astaxantines, carotenoids, vitamins, proteins, peptides, amino acids, nucleic acids, natural pigments, chlorophyl carbohydrates, starches, waxes, gums, lipids, fibers, and other valuable natural plant components as bioactive Phytohormones these natural plant hormones are grouped into several classes by its biochemistry as activity and natural composition comprised but not limited to: Auxins (IAA/IBA), Cytokinins (CKs), Abscisic Acid (ABA), Gibberellins (GAS), Ethylene, Jasmonic Acid (JA), Aalicylic Acid (SA), Brassinosteroids (BRs), and Strigolactones (SLs) but not limited to this classes or groups; each class contains multiple individual phytohormones or its bioactive precursors that continue to be discovered, can be obtained on a method comprised of compounded formulated selection based on its composition on single or combination of aquatic plants comprised mainly of Araceae Family (formally known as Lemanaceae family of plants) composed of 5 genera Lemna sp., Spirodella sp., Landoltia sp., Wolffia sp. Wolffiella sp. That contains over 38 species and natural variant clones or varieties with the additional compounding formulation of one or more species of the best available non-GMO hydrophytes or vascular macrophytes aquatic plants; the vascular macrophytes (Pteridophyte and Spermatophyte), which are represented by 33 orders and 88 families with about 2,614 species includes 412 genera; these includes 2,614 aquatic species of Pteridophyta and Spermatophyta that evolved from land plants and represent only a small fraction (*1%) of the total number of vascular plants but not limited as it can also include algae of different species micro or macro algae or kelp as well then all the selection customized formula is compounded and formulated into the product to improve composition and positive biological natural stimulation of growth and yield of crop plants, ornamental plants, etc.

6. The invention method or according to the previous claims 1 to 5 and forthcoming claims comprises of a controlled hydroponic photobioreactor raceway system that produces sustainable low-cost aquatic plants raw materials material for the extraction process; the system produces large volumes of standardized material of high quality and high content composition then the aquatic plant raw material is processed by continuous flow inline organic mechanical hi-sheering ultrasound cavitation cold process that cell burst efficiently the aquatic plants and extracts the valuable plant components, nutrients, phytochemicals, phytohormones, polyphenols, terpenoids, vitamins, proteins, amino acids, carbohydrates, and other valuable natural plant components; The process is non-chemical, non-hydrolysis, and does not use fermentation, chemical or enzymatic or caustic extraction methods that damage the quality and activity of the valuable composition components as it does not use extreme cold, extreme heat, microwave, or any other method that damages the molecule structure of the plant phytochemicals or renders them not absorbable or bioavailable with high Biological Activity.

7. A method according to claims 1 to 6 comprised of a mechanical extraction system were aquatic plant raw material of one or multiple aquatic plants may be processed to maximize cell rupture and reduce damage to key natural phytochemicals and nutrients compound that may maximize bioavailability and its activity; This process may takes place in an organic enhanced oxygen O3 ozone sterilization cold mediated sheering ultrasound cavitation continuous high flow system that monitored inline to ensure its compliant with regulatory microbiological standards for such organic products and that is within desired standards for such content, then blended and stabilized with organic approved products to ensure shelf-life and colloidal suspension stability and effectiveness over time; It is then packed in an enclosed air/oxygen displacement by nitrogen packing system; this may prevent oxygen-mediated reduction of shelf life and any contamination of the product or products, it is then stored at room temperature.

8. A method according to claims 1 to 7, wherein the Aquatic Plant extract or extracts combined with Duckweed Bio product extract is applied at a rate from about 0.01 lt./ha (liters per hectare) to about 2.5 L/ha depending on the plant species or crop the dossing or concentration range can be adjusted, depending on the customizable formulation the application guide can be adjusted and due to the environmental conditions, climate, soil condition, management, crop system and fertilization systems, etc.; In addition to the desired performance regulation and bio-stimulation management practices to obtain the desired results

9. A method according to any of the preceding claims, wherein the crop plants exhibit improved plant stand and root length as number of roots, total root biomass and surface.

10. A method according to any of claims 1 to 9, wherein the crop plants exhibit an improved nitrogen balance index as well for the other nutrients and carbon retention that can go from 0.5 to 5.0 fold times but not limited.

11. The present invention method according to the preceding previous claims as further stated claims to utilize a new composition comprising a synergistically activity effective amount of a family of aquatic plants Duckweed (Araceae Family of Plants previously known as Lemnaceae composed of several species and natural non-GMO Clones or varieties) and other aquatic plants concentrated extracts having an approximate Auxins to Cytokinins ration of at least 10:1 and up to 500:1 and higher as beneficial content comprising of other phytohormones interacting in a positive synergistic effect; for regulating and enhancing synergically the growth of and/or increasing, health, tolerance to stress and crop yields plus improving by reduction the usage or need of traditional fertilizers by crop-plants and non-crop plants helping improving environmental conditions like global warming by reducing contamination and also reducing Greenhouse Gases like CO2 by fixating it to the aquatic plants like Duckweeds that contain 40 to 45% of carbon and the domino effect of increasing the root mass of the target plants of interest that can be crop and non-crop plants that contain 35% to 45% carbon content on dry matter of roots by means of fixating it permanently to the soil thus helping prevent greenhouse gases.

12. The present invention method based on all previous claims 1 to 11 comprised of production of concentrated organic bio-stimulant fertilizer is based on a highly efficient organic physical direct cold sheering cavitation process without residues or byproducts that extracts controllable quantity and quality of specialty natural plant phytochemicals, phytohormones, amino acids and other beneficial natural plant components without damaging its natural biological activity maximizing its positive effect on plants; these substances promote chlorophyll content improving photosynthesis, plant growth, root size, root biomass root surface and number of roots resulting on increases nutrient absorption capacity and potentially minimizes the overall impact of traditional fertilizers resulting in a reduction of environmental contamination of the soil and water; it will also address food security and safety challenges by increasing agriculture yield, without increasing the need of more arable land and water resources.

13. A method of utilization comprises of application based on all the previous claims 1-12 comprised of farmers may use the non-GMO concentrated organic bio-stimulant fertilizer provided as either liquid foliar application, dipping seedling application, dry pelleted soil mending application, seed coating, wet or dry formulations and combinations with other agricultural chemicals or fertilizers organic or inorganic. The utilization or application dossing will be based on the concentration activity of the natural vitamin-phytohormones ratios of auxins and cytokines customization levels on Duckweed.Bio products to adapt them to plants as other agricultural applications; Farmers will use a base application guide with recommended dilution and amount to be used by acre or hectare; the Farmers will use 0.1% to 1% to 5% to 10% increments variation to determine the best performance results range so Farmers will customize the application adapting the application to specific growth systems, farm management systems, specific plant varieties, seasonality, location, soil type and characteristics microclimate, variable environmental condition, base plant nutrition system and water quality as composition and watering systems; the product and its use will be customized to each individual farm crop and particular conditions and farming methods resulting in improve yields and reduce unnecessary waste and environmental contamination.

14. The method based on all previous claims to utilize the present invention for other uses or application comprised of systems and methods provided wherein may include aquaculture of fin fish, crustaceans, and mollusks; further, systems and methods may be used in plankton, algae and microalgae production such as kelp that may be used to organically fertilize the ponds, growth systems, open reactors, closed reactors, vertical farms, produce vertical farms, micropropagation, and plant tissue culture; also into the future, in space travel food production may rely on systems and methods provided herein for crop based on aquaculture in a no gravity environment; also, and not limited to application and utility in the nutrition as ingredients for feeding of insect farms for production animal and human food and feed proteins and other nutrients like oils and fivers and components for pharmaceuticals, cosmetics; this can also include but not limited to ingredients and nutrients in animal feeds and human foods ingredients and nutrients.

15. Systems and methods based on the previous claims 1 to 14 provided herein may be used to produce comprised of but not limited to bio-agriculture phytochemicals concentrated based on the composition of the aquatic plants, the systems and methods provided herein may be used to selectively separate and concentrate the phytochemicals based on their molecular weight to create other fertilizer specialties like Amino acid fertilizer, organic natural phytohormones, natural plant pigments (for natural coloring in food, beverage, and pharma), carotenoids, chlorophylls, xanthine's, as taxanthins of derived terpenoids, and beneficial natural occurring polyphenols that may potentially be beneficial to animals and humans; Products yielded based on systems and methods provided herein may also be potentially used as sources of natural biodegradable polymers for industrial purposes and sources of energy and can be use in production of pharmaceuticals, natural medicine, homeopathic medicine, and cosmetics.

16. The method described in this invention based on all its previous claims and forth coming claims for the ‘improvement in plant vigor’ strength improvements comprised that certain traits are improved qualitatively or quantitatively when compared with the same trait in a control plant which has been grown under the same conditions in the absence of the method of the invention; such traits include, but are not limited to, early and/or improved germination, improved emergence, the ability to use less seeds, increased root growth in number and in length that sums as a significant increase in absorption surface area and a more developed root system, increased root nodulation, increased shoot growth, increased tillering, stronger tillers, more productive tillers, increased or improved plant stand, less plant verse (lodging), an increase and/or improvement in plant height, an increase in plant weight (fresh or dry), bigger leaf blades, greener leaf color, increased pigment content, increased chlorophyll content, increased photo synthetic activity, earlier flowering, increased flower number, longer panicles, early grain maturity, increased seed, fruit or pod size, increased pod or ear number, increased seed number per pod or ear, increased seed mass, enhanced seed filling, less dead basal leaves, delay of senescence, improved vitality of the plant, increased levels in plant tissue beneficial of nutrients for food and feed value and molecular composition that includes but is not limited to lipids, fatty acids, carbohydrates, vitamins, amino acids, etc.; in storage tissues; and/or less inputs needed (e.g. less fertilizer, less water, less use of additives organic or chemical and/or less labor needed resulting in less costs); a plant with improved vigor may have an increase in any of the aforementioned traits or any combination or two or more of the aforementioned traits.

17. A method according to the present invention previous claims, an ‘improvement in plant quality’ comprises that certain traits are improved qualitatively or quantitatively when compared with the same trait in a control plant which has been grown under the same conditions in the absence of the method of the invention; such traits comprised but are not limited to, improved visual appearance of the plant, reduced ethylene (reduced production and/or inhibition of reception), improved quality of harvested material, e.g. seeds, fruits, leaves, vegetables (such improved quality may manifest as improved visual appearance of the harvested material), improved nutritional composition and improved value as food for human and feed for animals and as an ingredient in other applications like pharma and beauty products or industrial applications; also improve composition of carbohydrate content (e.g. increased quantities of sugar and/or starch, improved sugar acid ratio, reduction of reducing sugars, increased rate of development of sugar), improved protein content, improved oil content and composition, improved nutritional value, reduction in anti-nutritional compounds, improved organoleptic properties (e.g. improved taste, smell/aroma an visual appeal) and/or improved consumer health benefits (e.g. increased levels of vitamins and anti-oxidants)), improved post-harvest characteristics (e.g. enhanced shelf-life and/or storage stability, easier processability, easier extraction of compounds), more homogenous crop development (e.g. synchronized germination, flowering and/or fruiting of plants), and/or improved seed quality (e.g. for use in following seasons); therefore a plant with improved quality may have an increase in any of the traits or any combination or two or more of the aforementioned traits.

18. A method according to the present invention previous claims, an ‘improved tolerance to stress factors’ comprises certain traits are improved qualitatively or quantitatively when compared with the same trait in a control plant which has been grown under the same conditions in the absence of the method of the invention. Such traits include, but are not limited to, an increased tolerance and/or resistance to abiotic stress factors which cause sub-optimal growing conditions such as drought (e.g. any stress which leads to a lack of water content in plants, a lack of water uptake potential or a reduction in the water supply to plants), cold exposure, heat exposure, osmotic stress, UV stress, flooding, increased salinity (e.g. in the soil), increased mineral exposure, ozone exposure, high light exposure and/or limited availability of nutrients or it's imbalance (e.g. nitrogen and/or phosphorus nutrients and/or potassium nutrients and/or micro-nutrients); a plant with improved tolerance to stress factors may have an increase in any of the aforementioned traits or any combination or two or more of the aforementioned traits; like in the case of drought and nutrient stress, such improved tolerances may be due to, for example, more efficient uptake, use or retention of water and nutrients. This possibly increases the strength or vigor of the plants and/or crops also potentially reducing the impact of secondary Biotic Stress (e.g., pathogens examples as virus, bacteria, fungi, yeasts, etc., and parasites insects, arachnids, slugs, worms, etc.); so, a plant with improved quality may have an increase in any of the aforementioned traits or any combination or two or more of the aforementioned traits.

19. A method according to the present invention previous claims, an ‘improved input use efficiency’ means that the plants are able to grow more effectively using given levels of inputs compared to the grown of control plants which are grown under the same conditions in the absence of the method of the invention; in particular, the inputs include, but are not limited to fertilizer (such as nitrogen, phosphorous, potassium, micronutrients, etc., organic or inorganic or specialty), light and water; so a plant with improved input use efficiency may have an improved use of any of the aforementioned inputs or any combination of two or more of the aforementioned inputs resulting in significant reduction of contamination of the environment by reduction of fertilizer usage, reduction of nutrient lixiviation, reduction of surface water runoffs, reduction of waterbed contamination, reduction of the air and atmosphere as improved soil by reduction of salinification or accumulation of excessive imbalance of fertilizer nutrients in solid or substrates.
